(19) United States
(12) Patent Application Publication
(10) Pub. No.: US 2022/0300721 A1
(43) Pub. Date: Sep. 22, 2022

(54) RADIO FREQUENCY SIGNAL REPEATER SYSTEM

(71) Applicant: Les Systemes Fonex Data Inc., St-Laurent (CA)

(72) Inventor: Gordon Harney, Ottawa (CA)

(21) Appl. No.: 17/636,560

(22) PCT Filed: Aug. 29, 2019
(86) PCT No.: PCT/CA2019/051201

§ 371 Date: Feb. 18, 2022

(51) Int. Cl. G06K 7/10; G06K 7/00; G06K 19/077

(52) U.S. Cl. CPC G06K 7/10188; G06K 7/10356; G06K 7/10386; G06K 7/0082; G06K 19/0779; G06K 19/07771

(57) ABSTRACT

A RFID signal repeater system includes a RFID repeater circuit and a housing body. The repeater circuit has a first RFID antenna and a second RFID antenna being connected by an electrical path. A RFID signal captured at one of the antennas is repeated at the other antenna. The housing body includes a first housing portion housing the first antenna and supporting a RFID reader device, whereby the RFID device is in RFID communication with the first antenna when supported by the first housing portion. The body also includes a second housing portion mechanically connected to the first housing portion and configured to support the second antenna and a programmable RFID device, whereby the programmable RFID device is in RFID communication with the second antenna when supported by the second housing portion. The housing body can have various form factors. A power repeater enabling wireless charging can also be provided.

### CROSS-REFERENCE TO RELATED APPLICATION

This application is a national stage application of PCT/CA2019/051201, which has an international filing date of Aug. 29, 2019, the entirety of which is hereby incorporated by reference.

### TECHNICAL FIELD

The technical field generally relates to systems that include a radio frequency signal repeater, and more particularly to systems that permit the programming, provisioning or configuring a pluggable transceiver using Radio Frequency Identification and Near Field Communications (hereinafter referred to collectively as “RFID”).

### BACKGROUND OF THE INVENTION

Communications and data service providers are deploying large numbers of pluggable transceivers across their networks to support the increasing demand for connectivity and bandwidth. They are quick and easy to install enabling rapid service delivery and network capacity upgrades. Pluggable transceivers include a broad range of standard device types, for example multi-source agreement (MSA) pluggable transceivers; small form-factor pluggable (SFP), enhanced SFP (SFP+), XFP, SFP, Quad SFP+ (QSFP+), SFP28, QSFP28, C form-factor pluggable types (CFP), etc., and proprietary “smart” SFP types. In addition, pluggable transceivers include other standard and proprietary device types, for example; RJ45 Power over Ethernet (PoE) devices and dongles, USB devices and dongles, Internet of Things (IoT) telematics devices and sensors, communications, computer and storage system plugin cards such as optical transponders, muxponders, and switch network interface cards, packet switch and router interface cards, computer server cards, wireless transceiver and transponder cards, data acquisition and control equipment cards, audio/video encoder and decoder cards, etc., and mobile devices, having various configurations, form factors, network and or host interfaces, functions, and management interfaces.

In general, a pluggable transceiver is configured with an optical, electrical (wired), or wireless network interface specified by an MSA and or other standards, for example IEEE 802.3 Working Group, ITU Telecommunication Standardization Sector, the Internet Engineering Task Force, the Metro Ethernet Forum, International Standards Organization (ISO), European Telecommunications Standards Institute (ETSI), RFID Forum, Society of Cable Telecommunications Engineers, Society of Motion Picture and Television Engineers, etc. Consequently, pluggable transceivers support a plurality of network interface protocols, such as Gigabit Ethernet, OTN, CWDM, DWDM, Fiber Channel, SONET/SDH, GPON, CPRI, RFoG, etc. optical protocols, and Ethernet, xDSL, Gfast, T1/E1/T3/E3, etc. electrical protocols, or wireless protocols such as LTE, Wi-Fi, Bluetooth, RFID, NFC, or Serial Digital Interface protocols, etc. In addition, pluggable transceivers support a plurality of network interface transmission formats, rates and wavelengths/frequencies. The network interface is typically configured with the appropriate connector type to interface with the physical transmission medium, for example, a fiber optic, RJ45, etc. connector interface, or an antenna air interface. Many pluggable transceivers, for example an Ethernet switch line card, provide one or more pluggable network interfaces each configured with a pluggable transceiver interface port that can accept a plurality of MSA pluggable transceiver types (e.g an SFP+) to be installed and provide the desired network interface.

In general, a pluggable transceiver is configured with a host interface or adapter as specified in an MSA and or other standards and or other proprietary specification. Consequently, pluggable transceivers support a plurality of host interfaces, such as Ethernet MSA, USB, PoE, SCTE RF MSA, SMP SDI MSA, PCI, PICMG, SGPIO, VMEBus, ATCA, IDE, SCSI, Ultra ATA, Ultra DMA, etc. and similar host interfaces. The host interface typically includes at least one of the following; communications, management, power and mechanical interfaces, and enable a pluggable transceiver to be installed in or connected to a host (i.e. via a physical connector interface to attach the transceiver to the host), and/or to operate when installed in or connected to a host (i.e. by allowing the transceiver to send and receive signals to and from the host and a network, and for managing the transmission of such signals). The management interface enables a host to identify, program, configure and manage a pluggable transceiver, for example, the host is configured to read or write an MSA host interface management memory map, data fields and values. Management information is usually programmed into the pluggable transceiver non-volatile memory during the manufacturing process, etc. This type of memory is commonly an EEPROM, FRAM, NOR Flash or NAND Flash. Manufacturers may also program the pluggable transceiver memory with proprietary information, for example using proprietary MSA map extensions, data fields and values to configure and manage a “smart” SFP. The management interface is typically implemented using a management protocol and communications interface, for example a host interface providing an MSA memory mapped management protocol defining a set of memory address, data fields and values that are read and or written to memory using an I2C EEPROM communications interface. In some pluggable transceivers, programming, configuration and management of the pluggable transceiver is performed by a remote management system connected to a network, the pluggable transceiver configured to connect to such network via the network interface and or host interface communications interface, and such network and or host interfaces providing an in-band management interface (e.g. an Ethernet/IP communications interface and SNMP, CLI, and or Web GUI management interfaces). In addition, the host management interface may include other hardware control/status signals to operate the pluggable transceiver.

Manufacturers combine various integrated circuits, processors, programmable logic devices, memory, programs and data to configure a pluggable transceiver to provide functions and interfaces for specific applications and or operational configurations. Typically, a manufacturer will program and or configure a pluggable transceiver memory using proprietary methods to a desired operating configuration using predetermined programs and or data defining said desired operating configuration. Typically, a pluggable transceiver operator will configure a pluggable transceiver memory in the field via the host interface or network interface according to a desired operating configuration with data defining such desired operating configuration.

In general, pluggable transceivers are equipped with a controller, wherein the controller programs, configures and operates the pluggable transceiver. For such pluggable transceivers, a manufacturer will program the memory with programs and or data used by the controller. In addition, the memory may also be programmed with other programmable device programs and or data, for example storing the configuration of a Field Programmable Gate Array (FPGA), and IC configuration register data. For example, the programs and or data are stored in the SFP controller memory, and the logic gates in an FGPA are configured by the controller according to a desired operating configuration to provide a Gigabit Ethernet service and network interface device (NID) functions. The pluggable transceiver operating configuration is typically identified by a pluggable transceiver identification code, for example a product equipment code, model number, serial number, etc.

In general, pluggable transceivers provide the capability to at least partially change or modify the pluggable transceiver host interface management data stored in memory. For example, a pluggable transceiver can be configured in the field to support operations and maintenance activities such as setting host interface alarm and warning threshold parameters, laser output power output, receiver input, etc. Some pluggable transceivers provide the capability to change or modify all the pluggable transceiver programs and or data stored in memory in the field to support operations and maintenance using proprietary file download and upgrade methods or using proprietary field programming systems, for example such upgrades used for fixing program defects or enabling new functionality, etc.

Some networking equipment manufacturers (NEMs) recommend that the operators of their equipment, for example service providers, use standard MSA pluggable transceivers wherein one or more host interface memory map data fields and values stored in memory must match the corresponding host interface memory map identification data fields and values provided by their proprietary pluggable transceivers. Consequently, some MSA compliant transceivers can not be used in particular NEM equipment unless their host interface memory map identification data fields are programmed exactly according to the NEM host interface requirements.

Some service providers require that pluggable transceivers be pre-programmed and or pre-configured prior to deployment to meet their operational requirements. Consequently, the pluggable transceiver memory must be programmed with specific host interface management data, such as for example thresholds for digital diagnostic interface voltage and temperature monitoring, and product equipment code identification. In addition, proprietary pluggable transceivers configured to provide network functions, for example an SFP configured as a network interface device, or a service assurance device, or a protocol gateway device, or an optical network terminal device, etc., must have their memories programmed with specific, and sometimes proprietary, host interface management data.

Therefore, as a matter of practice, a pluggable transceiver may support a plurality of operational configurations based on standards, proprietary, and service provider requirements that are programmed in the pluggable transceiver memory during the manufacturing process, wherein each operational configuration may be specific to a manufacturers product equipment code. For example, a manufacturer may receive an MSA compliant pluggable transceiver as raw material, perform quality control inspection and testing, and program its memory for a desired operating configuration as specified by one of many possible finished good product equipment codes for that raw material, the finished goods is labeled with the product equipment code information and shipped to a service provider. While this approach enables simple and traceable material management systems, it can lead to large and varied inventories of purpose-built (e.g. programmed) products, causing high supply chain overhead costs and potentially slowing service delivery operations when service or maintenance events are un-forecasted and the required parts are not available.

Other service providers have opted for an alternate approach to implementing their supply chain and configure each pluggable transceiver of a given product equipment code according one or more operating configurations. This approach has lead manufacturers and third parties to develop proprietary pluggable transceiver host interface programming devices that typically include a computer configured with a pluggable transceiver interface and proprietary software, some of which have been adapted for field use.

When not installed, the programmed operating configuration of a pluggable transceiver can be determined using the product equipment code as described above which usually entails scanning or reading the device product equipment code or bar code label, and if equipped cross referencing that information to find the product specification in a local database or through a network database. However, when the pluggable transceiver is configured without changing the product equipment code as described above, the actual device programming and or configuration can only be determined by reading the host interface memory map data field values electronically.

Based on current practice, a service provider can incur significant capital and operational expenses acquiring, configuring, managing and maintaining pluggable transceivers throughout their lifecycle. Likewise, pluggable transceiver manufacturers incur significant costs in producing and supplying a very broad portfolio of like pluggable transceivers. Therefore, there exists a need to quickly program or configure pluggable transceivers in the field with minimal equipment, and to minimize the size of the pluggable transceiver inventory, and to minimize the time to deploy a pluggable transceiver, and to minimize the time required to identify a pluggable transceiver and its programmed operating configuration in the supply chain or during installation and maintenance activities, and to minimize programming, configuration and identification errors introduced by operators during the manufacturing process and the service lifecycle.

### SUMMARY

According to one aspect, there is provided a radio frequency signal repeater system having a RFID repeater circuit and a housing body. The RFID repeater circuit includes a first RFID antenna, a second RFID antenna, and an electrical path providing an electrical connection between the first RFID antenna and the second RFID antenna, a RFID signal captured at one of the first and second RFID antennas being repeated at the other of the first and second RFID antennas. The housing body includes a first housing portion configured to house the first RFID antenna and to support a RFID reader device, whereby the RFID reader device is in RFID communication with the first RFID antenna when supported by the first housing portion and a second housing portion mechanically connected to the first housing portion and configured to support the second RFID antenna and to support a programmable RFID device, whereby the programmable RFID device is in RFID communication with the second RFID antenna when supported by the second housing portion.

According to another aspect, there is provided a radio frequency programming system that includes a housing body, a communications module operable for data communication with an external computing device, an integrated RFID reader housed within the housing body and configured to transmit RFID signals containing configuration data, and a RFID antenna housed within the housing body and operable to emit wireless RFID signals based on the RFID signals transmitted from the integrated RFID reader.

Although the inventive disclosure is illustrated and described herein as embodied in a radio frequency signal repeater system, it is, nevertheless, not intended to be limited to the details shown because various modifications and structural changes may be made therein without departing from the spirit of the inventive disclosure and within the scope and range of equivalents of the claims. Additionally, well-known elements of exemplary embodiments of the inventive disclosure will not be described in detail or will be omitted so as not to obscure the relevant details of the inventive disclosure.

Other features that are considered as characteristic for the inventive disclosure are set forth in the appended claims. As required, detailed embodiments of the present inventive disclosure are disclosed herein; however, it is to be understood that the disclosed embodiments are merely exemplary of the inventive disclosure, which can be embodied in various forms. Therefore, specific structural and functional details disclosed herein are not to be interpreted as limiting, but merely as a basis for the claims and as a representative basis for teaching one of ordinary skill in the art to variously employ the present inventive disclosure in virtually any appropriately detailed structure. Further, the terms and phrases used herein are not intended to be limiting; but rather, to provide an understandable description of the inventive disclosure. While the specification concludes with claims defining the features of the inventive disclosure that are regarded as novel, it is believed that the inventive disclosure will be better understood from a consideration of the following description in conjunction with the drawing figures, in which like reference numerals are carried forward. The figures of the drawings are not drawn to scale.

Before the present inventive disclosure is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present inventive disclosure, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present inventive disclosure and simplify the description, but not to indicate or imply that the devices or components must have a specific azimuth, or be constructed or operated in the specific azimuth, which thus cannot be understood as a limitation to the embodiments of the present inventive disclosure. Furthermore, terms such as “first”, “second”, “third” and so on are only used for descriptive purposes, and cannot be construed as indicating or implying relative importance.

In the description of the embodiments of the present inventive disclosure, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal,” if an where used, should be understood to mean in a direction corresponding to an elongated direction of the article being referenced. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system. Those skilled in the art can understand the specific meanings of the above-mentioned terms in the embodiments of the present inventive disclosure according to the specific circumstances.

### BRIEF DESCRIPTION OF THE DRAWINGS

In the accompanying figures like reference numerals refer to identical or functionally similar elements throughout the separate views, together with the detailed description below, and are incorporated in and form part of the specification to further illustrate embodiments of concepts that include the claimed inventive disclosure and explain various principles and advantages of those embodiments.

FIG. 1 illustrates a block diagram of a pluggable transceiver according to an example embodiment;

FIG. 2 illustrates a block diagram of a pluggable transceiver according to an alternative example embodiment;

FIG. 3A illustrates an isometric view of a pluggable transceiver according to an example embodiment;

FIG. 3B illustrates a top view of a pluggable transceiver according to an example embodiment having a smart label apposed thereon, according to an example embodiment;

FIG. 3C illustrates an exploded view of a smart label according to an example embodiment for adhering to a pluggable transceiver;

FIG. 3D illustrates a bottom layer of an external/internal repeater 200 according to an example embodiment;

FIG. 3E illustrates the bottom layer of the external/internal repeater of FIG. 3D having a conductive adhesive layer disposed thereon;

FIG. 4A illustrates a plan view of an external RFID device showing various internal components according to an example embodiment;

FIG. 4B illustrates a side cross-section view of the external RFID device in operation with a pluggable transceiver according to an example embodiment;

FIG. 5 illustrates a cross section view of an external RFID device in operation with a pluggable transceiver via an internal/external repeater according to an example embodiment;

FIG. 6 illustrates a circuit diagram of a RFID repeater circuit according to one example embodiment;

FIG. 7A illustrates an isometric view of a radio frequency signal repeater system according to an example embodiment;

FIG. 7B illustrates an exploded view of the radio frequency signal repeater system according to the example embodiment of FIG. 7A;

FIG. 7C illustrates an isometric view of a radio frequency signal repeater system according to an alternative example embodiment;

FIG. 8A illustrates an embodiment of the radio frequency signal repeater system having a top surface configured for receiving a pluggable transceiver having a MSA SFP+ form factor;

FIG. 8B illustrates an embodiment of the radio frequency signal repeater system having a top surface configured for receiving a pluggable transceiver having a MSA QSFP form factor;

FIG. 8C illustrates an embodiment of the radio frequency signal repeater system having a top surface configured for receiving a pluggable transceiver having a MSA CFP2 form factor;

FIG. 8D illustrates a cutaway of the embodiment of the radio frequency signal repeater system of FIG. 8A having a pluggable transceiver supported on a top surface thereof;

FIG. 8E illustrates a cutaway of the embodiment of the radio frequency signal repeater system of FIG. 8B having a pluggable transceiver supported a top surface thereof;

FIG. 8F illustrates a cutaway of the embodiment of the radio frequency signal repeater system of FIG. 8C having a pluggable transceiver supported on a top surface thereof;

FIG. 9A illustrates an isometric view of a radio frequency signal repeater system according to an example embodiment having a flexible housing body;

FIG. 9B illustrates an isometric view of the radio frequency signal repeater system of FIG. 9A showing rolling of a second portion of the flexible housing body;

FIG. 9C illustrates a cutaway of the radio frequency signal system of FIG. 9A at the cut-out of the flexible housing body according to an example embodiment;

FIG. 10A illustrates an isometric view of a housing of a radio frequency signal repeater system having a portfolio case form factor;

FIG. 10B illustrates an isometric view of the radio frequency signal repeater system of FIG. 10A, wherein a first discrete substrate having a first antenna embedded thereon and a second discrete substrate having a second antenna embedded thereon is being positioned within the housing;

FIG. 10C illustrates an isometric view of the radio frequency repeater system of FIG. 10A, wherein the second discrete substrate having the second antenna embedded thereon has been housed within a second housing portion of the housing;

FIG. 10D illustrates an isometric view of the radio frequency repeater system of FIG. 10A, wherein the first discrete substrate having the first antenna embedded thereon has been housed within a first housing portion of the housing;

FIG. 10E illustrates an isometric view of the radio frequency repeater system of FIG. 10A showing the electrical connection path being shielded by a flexible shielding member;

FIG. 10F illustrates an isometric view of the radio frequency repeater system of FIG. 10A wherein an RFID reader is being positioned to be supported in the first housing portion;

FIG. 10G illustrates an isometric view of the radio frequency repeater system of FIG. 10A wherein a pluggable transceiver is being positioned to be supported in the second housing portion;

FIG. 10H illustrates an isometric view of the radio frequency repeater system of FIG. 10H wherein both the external RFID reader and the pluggable transceiver are properly positioned for signal communication therebetween via the repeater of the radio frequency repeater system;

FIG. 11A illustrates plan views of a top side and of a bottom side of a first discrete substrate of the external RFID repeater according to one example embodiment;

FIG. 11B illustrates plan views of top side and of a bottom side of a second discrete substrate of the external RFID repeater according to one example embodiment;

FIGS. 11C and 11D illustrates schematics of circuits of tuning elements for connection with RFID antennas of the RFID repeater according to one example embodiment;

FIG. 12 illustrates an exploded view of a radio frequency repeater system having a handheld cover and scanner cover configuration according to one example embodiment;

FIG. 13A illustrates an exploded view of a radio frequency system having a foldable case form factor according to an example embodiment;

FIG. 13B illustrates an isometric view of the radio frequency system having the foldable case form factor placed in a planar configuration according to an example embodiment;

FIG. 13C illustrates an isometric view of the radio frequency system having the foldable case form factor in a partly folded configuration according to an example embodiment;

FIG. 13D illustrates an isometric view of the radio frequency system having the foldable case form factor in a fully folded configuration according to an example embodiment;

FIG. 14A illustrates an isometric view of the radio frequency system having a hinge mechanism and being enabled for wireless charging according to an example embodiment;

FIG. 14B illustrates an isometric view of the radio frequency system of FIG. 14A in a closed position and with top surface facing upwards;

FIG. 14C illustrates an isometric view of the radio frequency system of FIG. 14A in a closed position and with bottom surface facing upwards;

FIG. 15 illustrates components of a RFID repeater and a RF power repeater according to one example embodiment;

FIG. 16 illustrates an isometric (partially exploded view) of a RFID programming system in operation according to an example embodiment; and

FIG. 17 illustrates a schematic diagram of the components of the RFID programming system according to an example embodiment.

### DETAILED DESCRIPTION

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated.

PCT application no. PCT/CA2018/050021, which is hereby incorporated by reference, describes systems and methods for programming network transceivers, such as pluggable transceivers. A system for programming a pluggable transceiver includes memory that is adapted to store pluggable transceiver programming information or data which can be transmitted or received via RFID, and is thus referred to herein as “RFID memory”. Different types of RFID memory are described therein, and the RFID memory is configured to interface with a pluggable transceiver in different ways. The RFID memory may be embedded in an RFID or Radio Frequency Identification (RFID) tag (“tag RFID memory”) and the RFID tag is bonded to the body of a label (e.g. a bar code label) to form a “smart label”. In such embodiments, a pluggable transceiver can be configured with a housing adapted with a designated area having an RF interface, and this area can be used to attach or install the smart label. The pluggable transceiver can be adapted with an RFID reader/writer (i.e. hardware which can transmit and/or receive data via RFID, hereinafter referred to as an “RFID reader” for simplicity) in communication with a controller. In another embodiment for programming network transceivers, the pluggable transceiver is configured with a dual-access RFID memory configured with an RF interface and an electrical interface, the RFID memory configured as a surface mounted integrated circuit and installed on the pluggable transceiver printed circuit board assembly. In such embodiments for programming network transceivers, the pluggable transceiver can be configured with a housing adapted with a designated area having an RF interface and used to position an external RFID reader, said RFID memory being in communication with a controller and the external RFID reader.

Preferably, the RFID memory is programmed with RFID data which can include programming information or data which define a desired operating configuration of the pluggable transceiver, using an external RFID reader. In such configurations, the pluggable transceiver controller can read the RFID data from the RFID memory, and program the pluggable transceiver according to the desired operating configuration using the RFID data read from the RFID memory. The programming information defined by said RFID data can be used by the controller to program the pluggable transceiver non-volatile memory and/or to operate the pluggable transceiver. For example, programming information or data defined in the RFID data can consist of at least one of the following:
MSA and or other standard and or proprietary host interface data fields and values, for example manufacturer, part number (e.g. product equipment code), serial number, wavelength, alarm thresholds, etc. used to configure and or manage the transceiver, host interface, and or network interface;
configuration data used to program an ASIC, FPGA, or other IC configuration registers;
controller, processor or programmable logic device programs, for example initialization, boot, programming, operating or application programs;
network address;
memory address pointers that point to memory address locations within the pluggable transceiver non-volatile memory where the actual programming information or programmed information is stored;
configuration and installation data used to install programs such as operating system programs, programmable logic device programs, application programs, etc.;
compatibility data;
RFID memory configuration data;
programming information version data;
digital media data;
licensing data;
encryption key data; or
password data.

A pluggable transceiver having its memory programmed using such programming information or data can be said to be in a programmed configuration.

It should be noted that the pluggable transceiver non-volatile memory may be implemented using at least one memory integrated circuit device or memory within a programmable integrated circuit device, for example a microcontroller, microprocessor, FPGA, etc., or as a memory within an application specific integrated circuit device, or a system on a chip (SoC) device, or a combination thereof. It should be also noted that the pluggable transceiver controller may be implemented using at least one programmable integrated circuit device, for example a microcontroller, microprocessor, FPGA, SoC, etc., or as a controller within an application specific integrated circuit device, for example a Laser Driver and Limiting Post Amplifier with Digital Diagnostics, or a combination thereof.

When a pluggable transceiver is installed in a host, it is powered up and the pluggable transceiver controller begins an initialization process, wherein a program invokes the controller to read RFID data stored in the RFID memory containing programming information, verify the compatibility of the pluggable transceiver with such programming information, automatically program the pluggable transceiver memory using the programming information when first initialized with such programming information, and completes the initialization process rendering the pluggable transceiver in a desired programmed configuration. For example, once programmed, the pluggable transceiver can be fully operational and ready for service, and can provide an MSA SFP+ transceiver host interface memory map containing data fields programmed with data defining a specific operating configuration. The pluggable transceiver controller can be further configured to read the RFID memory periodically after said first initialization and to maintain, change, or remove its current programmed configuration based on comparing the data read from the RFID memory and its current programmed configuration. For example, when such a pluggable transceiver is first installed in a host, its memory can be programmed using the programming information during the initialization process. Once the initialization is completed, the memory can contain a programmed configuration and the pluggable transceiver can operate according to the programmed configuration. However, in most pluggable transceivers, the programmed configuration stored in the memory can be at least partially modified or changed by an operator via the host and or network interface, wherein the controller is configured to not change the programmed configuration upon subsequent controller initializations and thereby maintaining said host operator changes to the programmed configuration. In this sense, the pluggable transceiver described herein can be referred to as “self-programming” pluggable transceivers.

In the present disclosure, the term “pluggable transceiver” can refer to any device, equipment or system having at least a configurable transmitter and/or receiver and at least one interface for transmitting and/or receiving signals to and from a network. A configuration of the network transmitter and/or receiver can be stored in a non-volatile memory and the transmitter and/or receiver is configured using an embedded controller. Preferably, the pluggable transceiver provides an interface to connect to at least one host device, equipment or system (hereafter referred to as a “host”). It is appreciated that a pluggable transceiver can connect to a host device via various types of interfaces, including a physical interface for physically securing the transceiver in the host and/or a communications interface for transmitting and/or receiving signals to and from the host, etc. As can be appreciated, a pluggable transceiver is “pluggable” in the sense that it is replaceable and/or is detachably couplable to a host, for example an MSA SFP+ transceiver can be installed in a host communications system SFP+ transceiver interface port. By means of non-limiting examples, pluggable transceivers can include (among others):
MSA and MSA compatible transceivers;
RJ45 PoE dongles;
USB dongles;
communications or computer or storage equipment, for example plug in cards, line cards, equipment and system cases or chassis or cabinets configured to provide communications or computer or storage functions such as optical transponders, muxponders, switches, line amplifiers, etc., and packet routers, switches, firewalls, gateways, network interface devices, customer premise equipment, etc., and modems, media converters, multiplexers, etc., personal computers, mobile wireless devices, computer server cards, hard disk drives, solid state disks, etc.;
Internet of Things (IoT) or telematics or remote terminal unit (RTU) or supervisory and control data acquisition (SCADA) devices and plugin cards and equipment and systems and cabinets, for example analog I/O controllers, digital I/O controllers, sensors, etc.; and
integrated transceiver technology embedded in a device, equipment or system and interfaces a printed circuit card assembly to a fiber optic cable or copper cable or wireless connection.

A pluggable transceiver and system architecture which includes a level of intelligence to be downloaded from an RFID memory into a pluggable transceiver is disclosed hereafter.

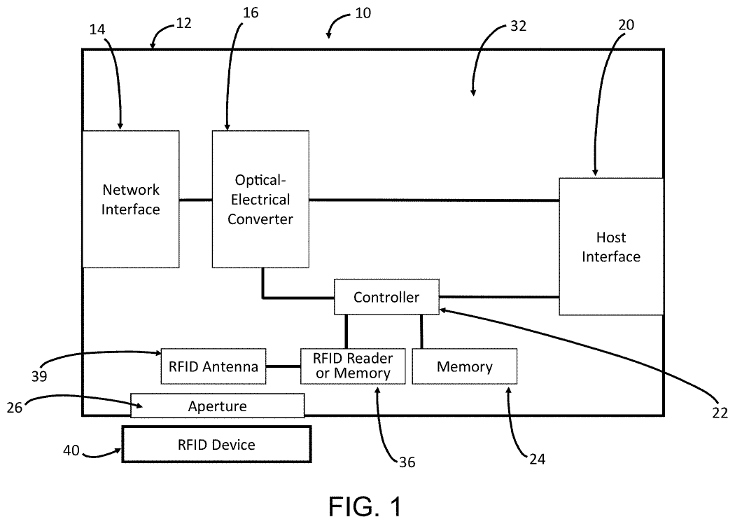

FIG. 1 illustrates a block diagram of a pluggable transceiver 10 according to several embodiments. The pluggable transceiver 10 can be configured with either an RFID memory 36 or an internal RFID reader 36, representing two IC configurations. The pluggable transceiver 10 can be an optical pluggable transceiver, but it can be appreciated that similar structures can apply to other types of transceivers as well, such as, plug-in line interface cards and rack-mounted enclosures used in telecommunications and data communications switching and transmission equipment. The pluggable transceiver 10 can include a housing 12 housing a printed circuit board assembly 32 (PCBA) on which components of the pluggable transceiver 10 are connected and supported. The housing 12 can be an assembly of parts preferably configured according to a standard and/or proprietary mechanical specification, for example the metal housing of an MSA compliant SFP+. In the illustrated embodiment, the PCBA 32 at least partially protrudes from the housing 12 to connect to a host. It should be noted that as used in this specification, the term “housing” is not necessarily limited to a single part or a plurality of parts that contains all the components on the PCBA 32, and may refer to one or more parts of the PCBA 32 that define an exterior profile of the pluggable transceiver 10. In other embodiments, the housing can include metal, plastic, glass, or epoxy, etc., or parts or combinations thereof. In some embodiments, the PCBA 32 forms the housing 12. In other embodiments, the PCBA 32 forms a part of the housing 12, for example the housing 12 configured as an assembly of a PCBA 32 and a metal faceplate attached to the PCBA 32. In an embodiment, the housing 12 is configured according to an MSA standard, for example a small form-factor pluggable (SFP) transceiver, or enhanced small form-factor pluggable (SFP+) transceiver, or SFP28, or XFP, or QSFP+, or QSFP28, or CFP, including proprietary “smart SFP” transceivers, etc. In other embodiments, the housing 12 can be a standard or proprietary electronics enclosure, for example a printed circuit card assembly, or a shelf, cage, case, cabinet, rackmount assembly, etc. In an embodiment, the network interface 14 and host interface 20 connectors are connected to or form part of the PCBA 32. In general, the pluggable transceiver housing 12 preferably provides a mechanical structure for the pluggable transceiver 10 and can include one or more of the following features:
support and physical protection for the components that it contains;
parts and mechanisms to install it in a host such as connectors, guides, clips, pins, ejectors, handles, fasteners, etc.;
thermal control features such as a heat sink;
protect users from safety hazards;
shielding to attenuate electro-magnetic emissions radiating from the pluggable transceiver 10;
one or more connectors to connect to a host and or a network;
one or more apertures used for example for interface connectors, accessing test, calibration or fastening points, viewing visual indicators (e.g. LEDs), thermal control and ventilation, etc.;
areas on the housing 12 and or PCBA 32 used to attach bar code and or other labels to identify the pluggable transceiver 10;
barcode label.

As shown in FIG. 1, the pluggable transceiver 10 can include a network interface 14, an optical-electrical converter 16 connected to the network interface 14, and a host interface 20 connected to the optical-electrical converter 16. The network interface 14 can be configured to connect to an optical device, such as a fiber optic cable. In the present embodiment, the network interface 14 can be configured to detachably couple to the optical device, thereby allowing the pluggable transceiver 10 to be detachably connected to such optical device. The optical-electrical converter 16 is configured to convert an optical communication signal received from the network interface 14 into one or more electrical communication signals. The optical-electrical converter 16 can be configured to transmit and receive the electrical communication signals from the host interface 20. The optical-electrical converter can include one or more components such as, for example, a transmitter optical sub-assembly (TOSA) and a receiver optical sub-assembly (ROSA), or a bidirectional optical sub-assembly (BOSA) and optical wavelength multiplexer, a laser driver, a receiver amplifier, or a coherent optical transmitter and receiver sub-system, etc. In some embodiments, the optical-electrical converter 16 can be configured with a controller and or a digital signal processor. In some embodiments, the optical-electrical converter 16 can be configured to transmit status signals to, and receive control signals from, the host interface 20. In other embodiments, the pluggable transceiver 10 can be an electrical transceiver, wherein the optical-electrical converter 16 is replaced by an electrical transceiver, for example an Ethernet transceiver, a T1 transceiver, etc., and the network interface 14 can be configured to detachably connect to an electrical device, such as for example an RJ45 cable connected to a network. In other embodiments, the pluggable transceiver 10 can be a wireless transceiver, wherein the optical-electrical converter 16 is replaced by a wireless transmitter, or transponder or modem and the network interface 14 configured with a wireless network antenna.

The network interface 14 may be configured according to at least one standard and/or proprietary specification, for example MSA INF-8074i SFP standard specification or MSA SFF-8472 SFP+ and IEEE 802.3z Gigabit Ethernet standard specifications. Consequently, pluggable transceivers 10 can support a plurality of network interface 14 transmission protocols, formats, wavelengths, frequencies, rates, distances and media types. In an embodiment, the optical-electrical converter 16 can be configured according to a desired network interface 14 using a controller 22. In another embodiment, the pluggable transceiver 10 network interface 14 can be configured with at least one pluggable transceiver interface port (e.g. an MSA SFP cage assembly and host interface connector on a proprietary Ethernet switch line card), wherein each such port can be configured to receive a pluggable transceiver 10 (e.g. an MSA SFP+ host transceiver port or cage).

The host interface 20 can be configured to connect to a host pluggable transceiver interface. During normal operation, the host interface 20 is connected to the host and can be configured to receive and transmit signals from said host. However, in other embodiments, the host interface 20 can simply support and/or physically engage the transceiver in a host system or device without necessarily allowing for the communication of signals with the host. Preferably, the host interface 20 can be configured to detachably connect to a host system or device pluggable transceiver interface, thereby allowing the pluggable transceiver 10 to be detachably connected to said host. The host interface 20 can include a plurality of interfaces used to operate the pluggable transceiver such as for example for communications, management, power and mechanical interfaces. Preferably, the host interface 20 can be configured to transmit and receive signals from a host according to at least one standard specification, for example the host interface 20 of a Gigabit Ethernet 1000Base-LX MSA SFP transceiver can be configured to connect to a 1000BASE-X SFP port (e.g. specified for a group of Ethernet physical layer standards within the IEEE 802.3.z standard) on an Ethernet switch. In other embodiments, the host interface 20 can be a proprietary interface.

In the illustrated embodiment, the management interface is configured with an I2C EEPROM communications interface, for example used to configure and manage the pluggable transceiver memory 24. In other embodiments, the management interface can be configured with a Management Data Input/Output (MDIO), or Serial Management Interface (SMI), or Media Independent Interface Management (MIIM) communications interface, etc. In an embodiment, the management interface can be configured with an Ethernet communications interface, and or an IP communications interface, used to configure and manage the pluggable transceiver 10 remotely through a network.

Preferably, the management interface management information is defined by a standard or specification, such as an MSA standard. In the present embodiment, the identification and configuration data provided by the host interface 20 can be at least partially stored in the memory 24. For example, the MSA SFP pluggable transceiver management interface management information can be specified in INF-8074i. In another example, the MSA SFP+ pluggable transceiver information can be specified in SFF-8472, wherein the MSA defines the management interface including the readable and writable digital diagnostic monitoring interface (DDMI) fields provided by the host interface 20. In another example, a host can read the pluggable transceiver 10 identification and configuration information such as the manufacturer, part number, serial number, wavelength, type, range, etc. including diagnostic and status information such as the transmit and receiver power, internal voltages and temperatures alarm and warning conditions, etc. via the host interface 20, and write pluggable transceiver configuration information such as alarm and warning threshold settings, enabling/disabling the optical transmitter, passwords for programming the memory 24, etc. via the host interface 20. Other detachable host interface 20 examples can include PoE, USB, SCTE XFP-RF, SMPTE SDI, PCI, PICMG, SGPIO, VMEBus, ATCA, etc. interfaces, and Wi-Fi, LTE, Bluetooth, RFID, Zigbee, etc. wireless interfaces.

In the illustrated embodiment, the pluggable transceiver 10 receives communications signals, management signals, and DC power from the host interface 20 PCBA edge connector. In other embodiments, the host interface 20 can include a plurality of optical and or electrical connectors and or antenna, for communications, management, and power connectors, etc. In another example, the pluggable transceiver 10 can receive PoE power from the host interface 20. In another embodiment, the pluggable transceiver 10 can include an AC/DC power converter and receive AC power from a host interface 20. In another embodiment, the pluggable transceiver 10 can receive DC power from a battery. In other embodiments, the host interface 20 can include a standard pluggable transceiver interface.

In the illustrated embodiment, the pluggable transceiver 10 includes a controller 22, for example a microcontroller, microprocessor, etc., the controller 22 being configured to interface with the host interface 20 and the memory 24 and the optical-electrical converter 16, wherein the controller 22 can be configured to operate the pluggable transceiver 10. The memory 24 can be configured to store pluggable transceiver information, the information defining a programmed configuration. In the present embodiment, the controller 22 executes a program to operate the pluggable transceiver 10, for example a program that programs, configures, and/or manages the pluggable transceiver 10 ICs, functions, and/or interfaces. The controller 22 can execute a plurality of programs such as, for example, an initialization or boot program, operating system program, application program, etc. Preferably, the memory 24 can be non-volatile, for example an electronically erasable programmable read-only memory (EEPROM). By means of non-limiting examples, the memory 24 can be configured to store a plurality of programs and or data; for example, controller initialization/boot, operating system, application programs and programmable logic device programs, and for example standard MSA host interface 20 memory mapped data fields and values, and for example IC configuration data. In the present embodiment, the data stored in memory 24 can include host interface 20 management information data defined in an MSA, for example identification, diagnostic, control and status information data used by a host to manage the pluggable transceiver 10. In an embodiment, the information stored in memory 24 can include proprietary host interface 20 management information defined in a proprietary specification, for example Ethernet MAC or IP address information used by a host to manage the pluggable transceiver 10. In an embodiment, the information stored in memory 24 can include data used to configure the pluggable transceiver 10 ICs, for example the optical-electrical converter 16 laser driver. In an embodiment, the information stored in memory 24 can include a controller 22 program used to operate the pluggable transceiver 10. In the present embodiment, the memory 24 is communicatively connected to the host interface 20 via the controller 22. For example, when the pluggable transceiver 10 is connected to a host, the memory 24 is communicatively connected to said host, wherein a controller in the host can be configured to read and write data to the memory 24 via the host interface 20 to configure and manage the pluggable transceiver 10. The host can be configured to program the memory 24 in whole or in part with programs and or data using various, typically proprietary, methods. In an embodiment, read only memory locations or data fields in the memory 24 can be password protected, with the host writing a password to one or more host interface 20 address locations or data fields prior to writing data to the memory 24 via the host interface 20. In other embodiments, the memory 24 can be directly connected to the host interface 20.

The memory 24 can typically be programmed during the pluggable transceiver manufacturing process, wherein various, sometimes proprietary, programming methods can be used to program the memory 24 with programs and/or data. For example, such data can consist of an MSA SFP+ identification/configuration fields and values stored in memory 24 for host interface memory map locations in A0h, and diagnostic and control/status fields and values stored in memory 24 for host interface memory map locations A2h. In some embodiments, at least some of the memory 24 can be programmed via the host interface 20, for example when the pluggable transceiver 10 is installed in a host during installation, commissioning, provisioning, operational or maintenance activities, an operator using an interface on the host writes data via the host interface 20 to writeable data fields wherein said data is stored in the memory 24. For example, a host device can write diagnostic alarm and warning threshold data to the memory 24 via the host interface 20 writeable data fields in memory map locations A2h. In some embodiments, the memory 24 configured to be programmed via the host interface 20 using proprietary programming systems or programs.

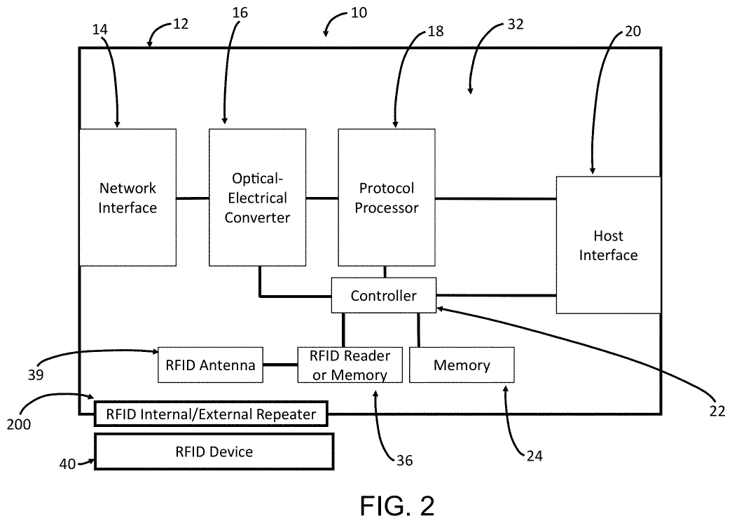

Pluggable transceivers are not limited to the configuration described, and the pluggable transceiver 10 may have other configurations and or may include additional components such as for example a packet and or digital signal processor. The block diagram shown in FIG. 2 illustrates an optical pluggable transceiver 10 according to embodiments wherein the pluggable transceiver 10 can include a protocol processor 18 configured to process communications signals and or data, for example encoded signals, data packets and/or frames or combinations thereof. The protocol processor 18 can be configured to connect to the optical-electrical converter 16 and to the host interface 20 and to the controller 22, wherein the controller 22 can be configured to execute at least one program to configure and manage the protocol processor 18, for example programs to program, configure and/or manage the protocol processor 18. The protocol processor 18 can be configured to receive signals, packets and/or frames from the optical-electrical converter 16, process the signals, packets and/or frames to provide a network function, and transmit them to the host interface 20 and vice versa. The optical-electrical converter 16 can be configured to convert the electrical communications signals received from the protocol processor 18 to one or more optical communication signals and transmit the optical communication signals to the network interface 14. In some embodiments, the memory 24 can be communicatively connected to the host interface 14 via the protocol processor 18 and the controller 22. In some embodiments, the memory 24 can be communicatively connected to the network interface 14 via the protocol processor 18 and controller 22. In some embodiments, the memory 24 can be programmed or configured by a remote management system via a network, wherein such network is connected to the host interface 20 via a host and or to the network interface 14 via a cable.

In some embodiments, the protocol processor 18 can be implemented using one or more ICs such as, for example, a microprocessor, network processor, digital signal processor (DSP), application specific integrated circuit (ASIC), field programmable gate array (FPGA), SoC, etc. IC. Programmable devices can typically be programed during the manufacturing process, and sometimes at least partially thereafter. In some embodiments, the pluggable transceiver 10 can include a plurality of different protocol processors 18, for example the pluggable transceiver 10 can provide a T1 to packet gateway network function using a plurality of different protocol processors 18 configured to receive and process the T1 signals and frames, perform T1 to pseudowire mapping and MPLS packet encapsulation, and Ethernet packet encapsulation and transmission. In an embodiment, the protocol processor 18 can be configured to provide at least one network and/or management function, for example media conversion, rate adaption, network interface, network demarcation, network security, protocol gateway, service assurance, network testing, packet OAM, policing and marking, shaping, SLA performance monitoring, statistics collection, header manipulation, classification, filtering, bridging, switching, routing, aggregation, in-band management, etc. In some embodiments, the protocol processor 18 can include memory, such as for example random access memory (RAM) configured for storing packets and/or processing information to analyze packets and or frames, etc., and non-volatile memory used to program a programmable logic device (e.g. an FPGA). In some embodiments, the protocol processor 18 can include a controller. In the present embodiment, at least one protocol processor 18 program and or data can be stored in the memory 24, and the program can be used by the controller 22 to program, configure, and/or to manage the protocol processor 18. In the present embodiment, the memory 24 can be configured to store protocol processor 18 data such as for example identification, configuration, diagnostics, control and status data and or proprietary data.

The protocol processor 18 can typically be configured to provide a plurality of network functions and interface configurations, and the memory 24 can be used by the host system to program, configure and manage the protocol processor 18 to provide said network functions and interfaces. For example, an SFP pluggable transceiver 10 with a protocol processor 18 can be configured to provide T1 packet gateway functions, and the host interface 20 can be configured to provide read/write access to identification and configuration data, wherein said data can be stored in memory 24. In an embodiment, the host interface 20 can be used to read/write the memory 24 can be a proprietary interface, for example an extension or modification of a standard MSA SFP host interface 20 memory map and data field definitions. In an embodiment, the network interface 14 management interface can be used to read/write the memory 24 is proprietary, for example a Web GUI. In an embodiment, programming the memory 24 with programs for the controller 22 and protocol processor 18 and/or with data can be typically performed during the pluggable transceiver 10 manufacturing process using proprietary programming systems. For example, such data can consist of MSA SFP+ identification fields and values stored in memory 24 for host interface 20 memory map locations starting at A0h, and diagnostic and control/status data fields and values stored in memory 24 for host interface 20 memory map locations starting at A2h, and proprietary protocol processor 18 diagnostic, control and status data fields and values stored in memory 24 for host interface 20 memory map locations starting at A0h address 0x80h. In other embodiments, the memory 24 can be programmed using other, typically, proprietary programming systems connected to the host interface 20. In other embodiments, the memory 24 can be at least partially programmed by a remote management system connected via a network to the host interface 20 and/or to the network interface 14, wherein the host interface 20 and/or network interface 14 can be configured with a communication interface, for example Ethernet and IP interfaces, and with a corresponding management interface, for example SNMP, Web GUI (e.g. HTML/HTTP), CLI, etc.

In the embodiment illustrated in FIG. 1, the pluggable transceiver 10 can be configured with an RFID memory 36 and RFID antenna 39. In an alternative embodiment, an internal RFID reader 36 may be provided in place of the RFID memory 36. In some embodiments, pluggable transceiver 10, RFID memory 36 (or internal RFID reader 36) and RFID antenna 39 can be further configured to be in RFID communication with an external RFID device. In the examples illustrated in FIGS. 1 and 2, the external RFID device is a RFID reader 40, but it will be understood that other types of RFID devices are contemplated. As described elsewhere herein, the RFID communication can be provided through an aperture 26 formed in the housing 12 of the pluggable transceiver For example, and as described elsewhere herein, the external RFID device can be a smart label 28 configured with an RFID tag (e.g. an RFID memory IC and antenna) and attached to the housing 12 and covering the aperture 26.

The controller 22 can be configured to read and write data to the RFID memory 36 (or internal RFID reader 36). In an embodiment, the RFID memory 36 can be a dual-access RFID memory configured with an RF interface and an electrical interface, for example a specially configured IC with a passive RFID memory that can be read by an external RFID reader 40 using an RF interface and that can be read by a controller 22 using an EEPROM electrical interface. Preferably, the RFID memory 36 (or internal RFID reader 36) can be configured to attach to the PCBA 32, for example the RFID memory 36 (or internal RFID reader 36) can be implemented using surface mounted ICs and associated components. In an embodiment, the RFID memory 36 (or internal RFID reader 36) or the smart label 28 RFID memory can be configured with different types of data files or data in its memory, for example: system file, capability file, and RFID Data Exchange Format (NDEF) file. For example, the system file can be a proprietary password protected file containing the RFID memory 36 (or internal RFID reader 36) or the smart label 28 RFID memory device configuration information; the capability file can be a read only file and provides information about the memory structure, size version, and the NDEF file control; the NDEF file can be defined by the RFID Forum for use in NDEF tags, the NDEF file can be password protected and used to store user writeable information and includes a messaging protocol. In some embodiments, the RFID memory 36 (or internal RFID reader 36) can be configured to be in communication with the host system via the host interface 20, said host can be configured to read or write data to the RFID memory 36 (or internal RFID reader 36).

In an embodiment illustrated in FIG. 2, the pluggable transceiver 10 can be configured with an RFID memory 36 (or internal RFID reader 36) and RFID antenna 39 in communication with the external RFID device through an internal/external RFID repeater 200, wherein controller 22 can be configured to read and write configuration data from said RFID memory 36. The internal/external RFID repeater 200 acts an interface between devices that are external to the pluggable transceiver 10 (ex: the external RFID reader device 40) with components internal to the pluggable transceiver 10. The repeater 200 is configured to repeat RFID signals in an external to internal direction, or vice versa. In the embodiment illustrated in FIG. 2, the external RFID device can include one or more discrete devices configured to enable reading and writing configuration data to RFID memory 36 (or internal RFID reader 36) through internal/external RFID repeater 200. The external RFID device can be:
an external RFID reader 40, or
an external RFID reader 40 communicating through an external RFID repeater 100, as described elsewhere herein.

In the embodiment illustrated in FIG. 2, the protocol processor 18 can be configured to interface with optical-electrical converter 16, host interface 20 and controller 22, and receive configuration data from controller 22. This configuration data can be received from RFID memory 36 (or internal RFID reader 36) and RFID antenna 39 through an internal/external RFID repeater 200, and the configuration data can be stored in memory 24. In another embodiment, the protocol processor 18 can also receive configuration data from controller 22 via the RFID memory 36 (or internal RFID reader 36) and RFID antenna 39 through aperture 26 (ex: FIG. 1).

In the illustrated embodiments, the external RFID device (ex: RFID reader 40) can include a memory having stored thereon configuration data defining a desired programmed configuration of the pluggable transceiver 10. The external RFID device is also configured to transmit said configuration data to the RFID memory 36 (or internal RFID reader 36). The external RFID device also includes a controller for controlling the operation of the external RFID device. The controller of the external RFID device is operable to write configuration data to memory 36 of the pluggable transceiver 10. In other embodiments described herein, the controller is operable to write configuration data to a smart label 28 RFID memory. An internal/external RFID repeater 200 can be used to enable RFID communications between the external RFID device and the RFID memory 36 of the pluggable transceiver 10 (ex: via the smart label 28). In an embodiment, the external RFID device can be configured to read pluggable transceiver 10 configuration data from RFID memory 36 or said smart label 28 RFID memory and store said pluggable transceiver 10 data in its memory. In an embodiment, the external RFID reader 40 can be configured to transmit and receive pluggable transceiver 10 configuration data from a remote management system, or controller, or database via a network. It should be noted that the external RFID device may be any device configured with an appropriate controller, memory and RFID interface (i.e. RFID and or NFC) for reading and or writing to an RFID device, and preferably also configured with a mobile network interface. For example, the external RFID device (ex: RFID reader 40) can be a smart phone or tablet device equipped with an appropriate RFID, NFC and communications network RF interfaces.

Typical RFID memory sizes can range up to 2K bits, with some devices providing up to 64K bits of memory. In the present embodiment, the RFID memory 36, or smart label 28 RFID memory, can be configured to store pluggable transceiver 10 data, said data defining a desired programmed configuration of the pluggable transceiver 10 This configuration data can then be read from the RFID memory 36, or said smart label 28 RFID memory, by the controller 22 and used to program the memory 24 according to the desired operating configuration of the transceiver defined by the data. In an embodiment, the programming data stored in the RFID memory 36 or said smart label 28 RFID memory can be at least partially encrypted and can only be decoded by the controller 22 or an external RFID reader configured to do so. The configuration data stored in the smart label 28 and RFID memory 36 can be password protected. In an embodiment, the programming data stored in the RFID memory 36, or said smart label 28 RFID memory, is encoded with error detecting or correcting codes that can be decoded by the controller 22 or an external RFID reader 40 configured to do so.

As can be appreciated, the programming and/or configuration data stored in the RFID memory 36, or smart label 28 RFID memory, can include at least one of the following data, among others:
host interface 20 or network interface 14 data defined in an MSA specification, for example identification, diagnostic, control and status data;
host interface 20 or network interface 14 data defined in other standard specification, for example identification, diagnostic, control and status data;
host interface 20 or network interface 14 data defined in a proprietary specification, for example protocol processor identification, MAC and IP addresses, diagnostic, configuration and status data;
data to configure the pluggable transceiver 10 ICs, for example data to configure an optical-electrical converter 16 receiver and laser driver or an Ethernet electrical transceiver or an FPGA or an DSP ASIC or a SoC;
data to configure the controller 22 and or protocol processor 18 program parameters, for example data to configure programs executing on the controller 22 or protocol processor 18;
one or more controller 22 programs used to operate the pluggable transceiver 10;
one or more protocol processor 18 programs used to operate the pluggable transceiver 10.

In the illustrated embodiments, the various RFID devices, such as the external RFID device (ex: RFID reader 40), smart label 28, the RFID memory 36 (the internal RFID reader 36), the internal/external RFID repeater 200, the external RFID repeater 100, etc., can each be configured with at least one RFID antenna providing a radio frequency interface for transmitting and receiving RF signals. The RF signals may be the high frequency (“HF”) RFID range, such as in the range of 13.56 MHz. The smart label 28 can be configured to communicate with the internal RFID reader 36 or external RFID reader 40 using an RFID/NFC communications protocol, for example ISO 15693 or ISO 14443. In the present embodiment, the RFID memory 36 (or the internal RFID reader 36) can be configured to communicate with an external RFID reader 40 using an RFID/NFC communications protocol, for example ISO 14443. In other embodiments, the smart label 28, RFID memory 36 and internal RFID reader 36 can transmit and receive RF signals in another frequency range such as for example the UHF frequency range. In other embodiments, the RFID memory or reader 36 and smart label 28 can be configured to communicate using other RF communications protocol such as for example ISO/IEC 18092, ECP global Gen2 (i.e. ISO 18000-6C), Bluetooth, etc.

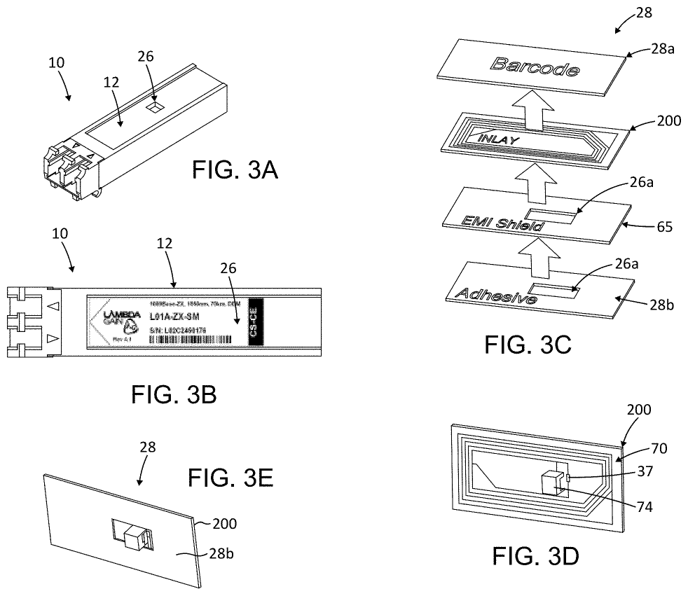

Exemplary isometric and top views of a pluggable transceiver 10 are illustrated in FIGS. 3A and 3B. In the illustrated embodiments, the pluggable transceiver 10 can be provided with a housing 12 configured with a designated area providing an RF interface. In the example transceiver illustrated in FIG. 3A, the RF interface is an aperture 26 located on a sidewall of the housing 12. As illustrated in FIG. 3B, the designated area can be used to attach the smart label 28. Alternatively, it can be used to position another RFID device, such as for example an external RFID reader 40, or external RFID repeater 100. For example, the area can be an outlined section on an exterior surface of the housing 12 indicating the RF interface, or a section on the exterior surface of the housing sized and shaped to receive the smart label 28 such as a recess, or an outlined section on the surface of the PCBA 32 indicating the RF interface, etc. In the present embodiment, the area includes at least one aperture 26 defined in the housing 12, said aperture 26 being configured to provide a dielectric RF interface to enable RFID communications therethrough, for example to allow RFID signals to travel between an RFID device such as smart label 28 and/or an external RFID reader 40 positioned on an exterior surface of the housing 12 proximate to aperture 26 and the RFID antenna 39 located inside the housing 12. As can be appreciated, in this configuration the aperture 26 provides an interface for RFID devices; smart label 28, external RFID reader 40, external RFID repeater 100, internal/external RFID repeater 200, as described herein. In some embodiments, the designated area can be located on a PCBA 32 and provides an RF interface for the smart label 28, with said area configured to enable RFID communications therefrom with the RFID antenna 39 and RFID reader 36. In some embodiments, the designated area can be located on the PCBA 32 and provides an RF interface for the external RFID reader 40, said area being configured to enable RFID communications therefrom with the RFID antenna 39 and RFID memory or reader 36. The RF interface may include at least one dielectric interface surrounded by an electromagnetically shielding material such as to create a path for RFID communications between an interior and an exterior of the housing 12. Preferably, the dielectric interface is sized and configured to attenuate and/or block unintended electro-magnetic waves passing through the interface. In the present embodiment, the dielectric interface comprises air, and is defined by aperture 26 formed in a sidewall of the housing 12. In this configuration, the shielding material surrounding the dielectric interface is the metal forming housing. As can be appreciated, aperture 26 can be sized according to the wavelength of RFID signals used for communication, for example with the external RFID reader 40, external RFID repeater 100, internal external RFID repeater 200 and smart label 28. The aperture 26 can be configured to effectively act as a filter for allowing the passage of desired RFID wavelengths of electromagnetic radiation. For example, the maximum linear dimension of the aperture 26 can be approximately 6 mm in length, and in another example the aperture 26 can be preferably sized to have a surface area less than 29 mm2. Preferably still, aperture 26 can be sized to attenuate unwanted or unintended EM signals from passing through, for example by approximately 60 dB or more at 10 GHz. It is appreciated that other dielectric interface geometries, materials and configurations are also possible. For example, the dielectric interface can comprise plastic dielectric which is bonded or attached to the housing and covers or is contained within aperture 26.

The smart label 28 can be configured and formed based on the pluggable transceiver 10 configuration, form factor, footprint and RFID programming requirements. For example pluggable transceivers 10 can be configured to provide a plurality of different network functions and housed in a plurality of different form factors and footprints and programmed using a plurality of RFID programming methods described herein, consequently there are a plurality of pluggable transceiver 10 embodiments and smart label 28 embodiments each corresponding to a desired application or applications. For example, product labels (e.g. smart label 28) are typically permitted on the top or bottom or sides of the pluggable transceiver 10 housing within specified areas and dimensions. The label can have an almost zero thickness or can be placed in a recess below external surfaces of the housing 12. The label contents and positions can be determined by module manufacturer. Furthermore, the label(s) should not interfere with the mechanical, thermal or electro-magnetic compatibility (EMC) properties of the pluggable transceiver 10.

In an exemplary embodiment illustrated in FIG. 3C, the smart label 28 can be configured with a flexible top face-stock substrate 28a made of material suitable for printing information, such as a barcode label and/or other information thereon. The barcode label and other information can be used to identify a product, finished good, etc. For example, a barcode or QR code label made of a polyester material can form a top surface of substrate 28a.

Continuing with FIG. 3C, the smart label 28 can be configured with the top surface printed barcode layer 28a, a flexible EM substrate 65 configured for EM shielding and a flexible bottom adhesive bottom layer or base substrate 28b. The smart label 28 can further be configured with the top printed barcode layer 28a, the EM substrate 65 and aperture 26a formed in the EM substrate 65 and bottom layer 28b. Furthermore, an internal/external RFID repeater 200 configured with RFID antennas 70 and 72 can provided as part of the smart label 28, according to some example embodiments. The internal/external RFID repeater 200 can be mounted on a flexible or semi-rigid substrate, such as a substrate formed of polyester, polyimide, etc. materials laminated together containing or supporting electrical circuits, for example circuits formed in copper or aluminum based conductor materials. The smart label 28 having the internal/external repeater 200 is hereinafter referred to as a “repeater smart label 28”. In an embodiment, the repeater smart label 28 can be configured with an RFID memory 37 (FIG. 3D), which may be connected to the circuit of the internal/external RFID repeater 200. In an embodiment, the repeater smart label 28 and RFID memory 37 can be configured as a tagged repeater smart label 28.

The various embodiments of the smart label 28 described herein can be configured to be installed and interface with a plurality of different pluggable transceiver 10 having different housing 12 form factors and footprints, for example MSA SFP+, QSFP and CFP2 form factors and footprints, shielded plugin circuit card form factors and footprints, etc. The smart label 28 can be sized to fit on the designated product label surface on a sidewall of the housing 12 of the pluggable transceiver (a faceplate or backplate). For example, in the present embodiments, the approximate smart label 28 dimensions for the MSA SFP+, QSFP, and CFP2 pluggable transceivers 10 are 10 mm wide×24 mm deep, 13 mm wide×32 mm deep, and 39.5 mm wide×16.5 mm deep respectively and generally located on a top or bottom sidewall. The smart label 28 can have thickness of less than 0.2 mm. in other embodiments, the thickness of the smart label 28 may be greater than 0.2 mm due to the current RFID circuit and material technologies. For example, the smart label 28 thickness may be in a range of 0.200 mm to 0.380 mm, and preferably in the range of 0.200 mm to 0.300 mm. Accordingly the housing 12 pluggable of the transceiver 10 and label recesses may be formed to accommodate the thickness of the smart label 28 expected to be affixed to the housing 12.

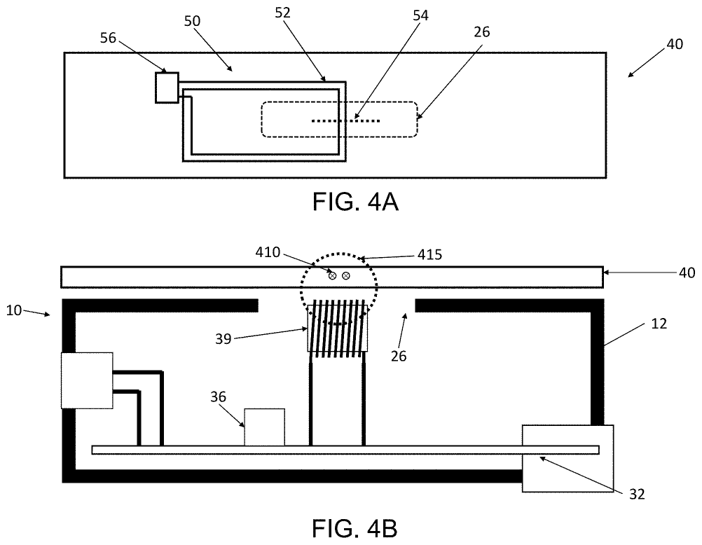

FIG. 4A illustrate a plan view of an external RFID device. An exemplary RFID reader 40 is illustrated as the external RFID device. FIG. 4B illustrates a cross-section view of the external RFID device and the pluggable transceiver 10, according to one example embodiment, in which the external RFID device is positioned to be in RFID communication with the RFID antenna 39 of pluggable transceiver 10. The RFID device 44 can be configured at least with one RFID antenna 50 which can be positioned facing the aperture 26 of the housing 12. Preferably, the circuit conductors 52 of the RFID antenna 50 and the RFID antenna 39 are aligned and proximate to each other to be within signal communication range during operation. For example, the distance between the RFID antenna 50 circuit conductors 52 and the RFID antenna 39 is preferably in a range from touching to at least 3 mm. In an embodiment, RFID memory 36 can be adapted to receive data defining a desired programmed configuration through the aperture 26, the RFID memory 36 and RFID antenna 39 configured to receive the data from an external RFID reader upon interrogation therefrom. In another embodiment, internal RFID reader 36 can be adapted to receive data defining a desired programmed configuration through via the smart label 28 upon interrogation. In the illustrated embodiment, the aperture 26 can be sized to receive the RFID antenna 39 at least partially therein, the RFID antenna 39 not protruding from the housing 12 exterior surface. In another embodiment, the aperture 26 can be sized to receive the RFID antenna 39, the RFID antenna 39 at least partially protruding from the housing 12 exterior surface. In another embodiment, the RFID antenna 39 can be detachably connected to the PCBA, the RFID antenna 39 at least partially protruding from the housing 12 exterior surface, for example the RFID antenna is mounted on a connector and the connector installed on a connector on the PCBA 32, or temporarily installed on the MSA host interface edge connector, during programming. In an embodiment, the RFID memory 36 and RFID antenna 39 are configured to transmit pluggable transceiver 10 data to an external RFID reader 40 upon interrogation therefrom. In an embodiment, the internal RFID reader 36 and RFID antenna 39 are configured to transmit pluggable transceiver 10 data to a smart label 28.

Preferably, the design, type, size, magnetic orientation and/or alignment of the RFID antenna 50 of the external RFID device and the RFID antenna 39 are selected to provide an optimal magnetic field coupling between RFID antenna 50 and the RFID antenna 39, wherein such coupling enables reliable RFID communications between the RFID device and the RFID memory or reader 36 within the read range. In the present embodiments and subsequent embodiments described herein, the RFID memory and reader 36 and antenna 39 and RFID devices such as the external RFID reader 40 and smart label 28, and the external RFID repeater 100 and the internal external RFID repeater 200 can be configured for resonant magnetic or inductive coupling, and near field communications. It should be noted that resonant inductive circuits can also be used as bandpass filters due to their relatively narrow EM signal frequency pass band around the resonant operating frequency, e.g. 13.56 MHz.

FIGS. 4A and 4B illustrate the coupling mechanism 54 between the RFID device RFID antenna 50 and RFID antenna 39 according to an embodiment. The coupling mechanism 54 can also be used in the embodiments illustrated hereinafter, wherein the RFID antenna 50 of the RFID device 44 and RFID antenna 39 of the pluggable transceiver are coupled via the magnetic field 54 generated for example by an RFID transceiver (not shown) connected to antenna feeder port 56 of the RFID antenna 400. The coupling mechanism 54 can be structured to maximize the field directly under the conductors excited by the alternating current of the antenna conductors 52 (e.g. wires or printed or deposited circuit traces), and wherein said alternating current is transmitted from RFID antenna feeder port 405. This near-field coupling approach allows the communication signals to pass through the metallic barrier (e.g. housing) via the aperture 26. The dimensions and spacing of the conductor 52 may be made thinner or wider, and or more densely packed, near the aperture 26 so as to improve the field intensity and focus. The configuration of the conductor can be adjusted by changing the conductor impedance and number of conductors that interface with the aperture 26. Elsewhere in the conductor 52, which may be in form of a planar loop, the conductive traces may be kept wider such as to reduce the resistive losses in the antenna traces of the conductor 52 in the overall loop. In addition, more loops of conductive traces may be added to RFID antenna 50 proximate the aperture 26 to increase the field intensity. Multiple variants of the resonant antenna structure are possible depending on the location and geometry of the aperture 26, the housing 12, smart label 28 materials (e.g. metal/ferrite), and/or the RF impedance and load presented at the dielectric RF interface, in addition the proposed configurations are representative illustrations of the coupling mechanism 54. In an embodiment, the RFID antennas 39, 50 include at least one passive component configured to ensure antenna resonance matching and mounted on a substrate for example on the PCBA 32 or RFID tag inlay of smart label 28, etc., and wherein said tuning is based on the RF interface and surrounding materials. In an embodiment, the passive component is constructed using the same substrate and conductive material of the antenna structures. A passive element or the use of the conductive layers separated by the substrate dielectric can be added to adjust the resonant structure of the RFID antenna. As can be appreciated, although aperture 26 is illustrated as being provided on one of the sidewalls of housing 12, the aperture can be located elsewhere, such as on a faceplate of the pluggable transceiver 10. Similarly, although RFID antenna 39 is shown as being positioned proximate to sidewalls of housing 12, it is appreciated that antenna 39 can be positioned elsewhere, such as proximate to a faceplate or MSA host connector of the pluggable transceiver 10, and/or protruding from said faceplate.

In the embodiment, illustrated in FIGS. 4A and 4B, the RFID antenna 50 can be configured as a planar coil and the RFID antenna 39 can be configured as a inductor coil mounted proximate in the aperture and not protruding from the housing 12 exterior surface, wherein the RFID antenna 39 can be electrically connected to the PCBA 32, the orientation of RFID antenna 50 magnetic axis is preferably in the Z plane, the orientation of RFID antenna's 39 magnetic axis is in the X-Y plane, and the RFID antenna 50 conductors 52 are preferably centered above or below RFID antenna 39. It should be noted that practical considerations may affect the preferred alignment and proximity of the antennae, and an external field-concentrating RFID repeater 100 can be used to facilitate proper alignment to enable reliable communications between an external RFID reader and the RFID antenna 39. In an embodiment, the RFID antenna 39 can be configured as an inductor coil having a ceramic or ferrite core material. In other embodiments, the RFID antenna 39 can be configured with other coil structures, for example spiral or loop or coil shaped structures embedded, printed or etched on a solid or flexible substrate or PCBA, or an inductor coil mounted on a cable or on extended metal leads, and connected to the PCBA 32. It should be noted that in other embodiments, the RFID device 44 RFID antenna 50 and RFID antenna 39 can have other orientations and or configurations, for example another antenna type, operating frequency and/or coupling mechanism such as a UHF RF antenna.

In an embodiment, the RFID antenna 50 can be configured as an inductor coil having a ceramic or ferrite core material. In other embodiments, the RFID antenna 50 can be configured with other coil structures, for example spiral or loop or coil shaped structures embedded, printed or etched on a solid or flexible substrate or PCBA. In other embodiments, the RFID antenna 50 and the RFID antenna 39 coil sizes and the number of conductive loops can be increased when practical to increase the read range.

In some embodiments, an electro-magnetic (EM) suppressing substrate can be attached to the housing 12 after programming the RFID memory or reader 36, preferably completely covering aperture 26, for example as shown in FIGS. 3B and 3C. The suppressing substrate can be EM substrate 65 of the smart label 28, which is positioned to cover the aperture 26 to attenuate unintended electro-magnetic emissions radiating through the aperture 26, for example to attenuate EM emissions occurring when the pluggable transceiver 10 is installed and operating in a host. The EM substrate 65 can include a conductive adhesive layer 28b provided on the bottom surface to attach the EM substrate 65 to the pluggable transceiver 10. For example, an EM suppressing substrate can be configured with electrically conductive material such as an aluminum or copper foil or tape, or magnetically permeable material such as a ferrite material sheet or tape.

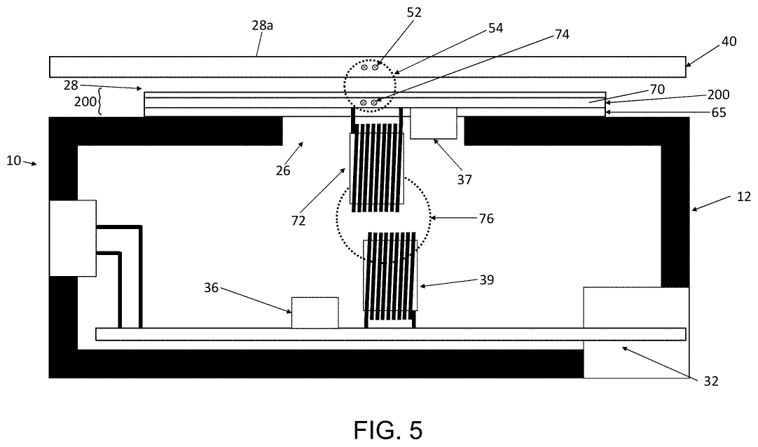

In the embodiment illustrated in FIG. 5, an internal/external RFID repeater 200 can be provided as part of a smart label 28, for example with a barcode label printable substrate 28a bonded to the top surface of internal/external RFID repeater 200. The internal/external RFID repeater can be used to passively relay RFID communication signals between an RFID device, for example an external RFID reader 40 or external RFID repeater 100, and the RFID antenna 39 of the pluggable transceiver 10. The internal/external RFID repeater 200 can be mounted to an exterior of the housing and includes: a substrate 200a configured with a first external field-concentrating RFID antenna 70; a second internal RFID repeater antenna 72 mounted to on an underside of said substrate 200a; and an electrical connection between the first and second repeater antenna 70, 72 to enable communications therebetween. The RFID antenna 50 of the RFID device 44 can be positioned proximate to the antenna 70 of the internal/external RFID repeater 200 within the read range. The repeater RFID antenna 70 can be configured as a planar coil. The repeater RFID antenna 70 can be configured as an inductor coil 74. When mated with the pluggable device 10, such as the smart label 28 being adhered to the sidewall of the pluggable device, the repeater RFID antenna 70 is aligned with the aperture 26 and the repeater RFID antenna 72 at least partially projects into the aperture 26. This projecting places the RFID antenna 72 close to the RFID antenna 39 of the pluggable transceiver 10, such that they are within the read range of one another. The planar orientation of RFID antenna coil 74 and the RFID antenna coil 70 are preferably in the X-Y plane. The orientation of the RFID antenna 50 of the RFID device 40 and the RFID antenna 70 magnetic axes are preferably in the Z plane, the orientation of the repeater RFID antenna 72 and the RFID antenna 39 magnetic axes are preferably in the X-Y plane, the RFID device RFID antenna 50 is preferably positioned above the first repeater RFID antenna 70, and the second repeater RFID antenna 72 can be positioned proximate to the RFID antenna 39. In the illustrated embodiment, the magnetic field 54 couples the RFID device antenna conductors 52 and repeater RFID antenna 70 conductors 74. The magnetic field 76 couples the second repeater RFID antenna 72 and the RFID antenna 39.

In the illustrated embodiment, the internal/external RFID repeater 200 substrate includes an external RFID antenna 70 built in a planar coil structure and can be configured with an EM substrate 65, for example a layer of ferrite material that minimizes the effects of a metallic housing 12 of the coupling fields 54 and/or 76, the EM substrate 65 being configured to improve the magnetic coupling between the RFID device, device RFID antenna 50 and the first repeater RFID antenna 70, for example by preventing eddy currents from forming on the metal housing and/or allowing the fields to couple around the conductors 74, the EM substrate 65 also attenuating unintended electro-magnetic emissions radiating from the aperture 26, the EM substrate 65 being secured to an underside of the substrate 200a having the first repeater RFID antenna 70. In an embodiment, EM substrate 65 can include a conductive adhesive provided on the bottom surface to attach the internal/external RFID repeater 200 to the pluggable transceiver 10 housing 12. In an embodiment, the internal/external RFID repeater 200 substrate can be a solid or flexible substrate such polymide or PET film configured with an electrical circuit, for example a printed or etched or deposited circuit, the first repeater RFID antenna 70 is configured with a printed coil or loop or spiral structure on said substrate, the second repeater RFID antenna 72 is configured as inductor coil having a ceramic or ferrite core material, and the external repeater RFID antenna 70 coil and the internal repeater RFID antenna 72 coil are electrically interconnected using said printed circuit substrate. It should be noted that in other embodiments, the RFID antenna 39, first repeater RFID antenna 70 and second repeater RFID antenna 72 can have other orientations and or configurations, for example another antenna type, operating frequency and/or coupling technology such as a UHF RF antenna. In other embodiments, the repeater RFID antenna 70 and repeater RFID antenna 72 and the RFID antenna 39 coil and conductor sizes and number of coil loops can be increased where practical to increase the read range. The internal external RFID repeater 200 can be configured for resonant inductive coupling, and near field communications, wherein the internal/external RFID repeater 200 includes at least one passive component configured to ensure RFID antenna 70 and RFID antenna 72 have resonant frequency matching and tuning as described herein. The passive components can be constructed using the same substrate and conductive material of the antenna structures. A passive element or the use of the conductive layers separated by the substrate dielectric can be added to adjust the resonant structure of the repeater 200. In another embodiment, tuning and or filtering passive elements, including EM substrates, can be configured to also attenuate unintended EM signals from passing through the internal external RFID repeater 200, for example the RFID repeater 200 can be configured to transmit and receive RFID signals at 13.56 MHz and provide a data bandwidth of at approximately 2 MHz and provide at least 20 dB attenuation of unintended signals at 10 GHz when mounted on metal housing 12 and covering aperture 26. In another embodiment, the internal/external RFID repeater 200 can be configured with a ferrite ring or bead through which the RFID signals conducted between the internal and external RFID antennae 70, 72 pass, said ferrite ring or bead configured to attenuate and suppress unintended EM signals from passing through the internal external RFID repeater 200 from the interior to the exterior of the housing 12 of pluggable transceiver 10. A person skilled in the art will understand that the coupled antennas are used to re-direct and realign the external magnetic fields of the RFID communications path to the internal antenna of the pluggable transceiver RFID subsystem and thus the above examples are not an exhaustive list of the possible configurations.

In an embodiment illustrated in FIG. 5, the internal external RFID repeater 200 and EM substrate 65 can be configured with a top substrate 28a providing a printable label covering the exterior surface of repeater 200 RFID antenna 70 substrate. For example repeater 200 can be configured as a smart label 28 with printable face-stock material, such as a polyester printed barcode or QR code label having a product description, and is hereafter referred as a repeater smart label 28. In an embodiment, said repeater smart label 28 can be configured to enable an external RFID reader 40 to program configuration data into RFID memory 36. In an embodiment, said repeater smart label 28 can be configured to enable an external RFID reader 40 to program configuration data into internal RFID memory 36 using an external RFID repeater 100.

In an embodiment, said repeater smart label 28 can be configured with an RFID memory 37, wherein the RFID memory 37 is connected to the internal/external RFID repeater 200 RFID antenna 70 and 72, and wherein RFID memory 37 can be configured to be programmed with configuration data using an external RFID reader 40 or internal RFID reader 36, and wherein RFID memory 37 can be configured to read by internal RFID reader 36, and is hereafter referred to as the smart label 28. It should be noted that in some embodiments, said smart label 28 RFID memory 37 is configured to be read or written to by only the internal RFID reader 36.

In an embodiment, said smart label 28 can be configured with an RFID memory 37 wherein the RFID memory 37 can be connected to a second separate RF circuit (e.g. antenna), and wherein RFID memory 37 is not connected to the internal/external RFID repeater 200 antenna 70 or 72, and wherein said smart label 28 RFID memory 37 can be configured to be programmed with configuration data using an external RFID reader 40, and wherein said smart label 28 can also be configured to enable an external RFID reader 40 to program configuration data into RFID memory 36 using the RFID repeater circuit 200.

In the present embodiments, the internal/external RFID repeater 200, smart label 28, repeater smart label 28, and tagged repeater smart label 28 RFID antennas are configured with resonant frequency (e.g. 13.56 MHz) tuning components (e.g. capacitors) to optimize the RFID antenna magnetic coupling, and as a consequence said circuits can also attenuate un-intended electromagnetic emissions radiating through the aperture 26 and to enable RFID communications signals to be transmitted therethrough as described herein.

In the present embodiment, the external RFID reader 40 can be configured with an anti-collision function to enable identifying each of a plurality of RFID devices 44 configured with an RFID memory 36 or 37 located within its field or read range, and selectively programming each of a plurality of RFID devices individually with configuration data, for example when an external RFID reader 40 interrogates pluggable transceiver 10 configured with a tagged repeater smart label 28, wherein pluggable transceiver 10 is configured with RFID memory 36 and the tagged repeater smart label 28 is configured with RFID memory 37, it will receive at least two responses one from each RFID memory 36 and 37 positioned proximate to the external RFID reader 40 and within the read range, wherein the external RFID reader 40 is configured to program each RFID memory 36 and 37 individually with configuration data.

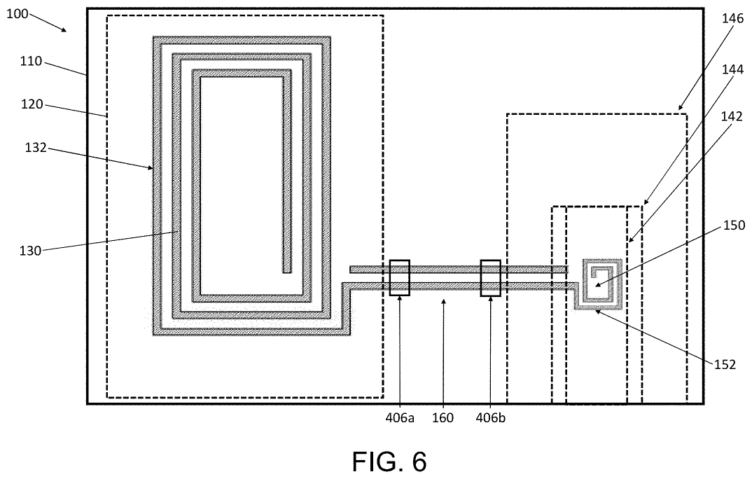

Referring now to FIG. 6, therein illustrated is a circuit diagram of a RFID repeater circuit 100 according to one example embodiment. The RFID repeater circuit 100 is operable for repeating (or relaying) an RFID signal between two RFID devices. The RFID signal is repeated over a path that is external to either of the two RFID devices. The external RFID repeater 100 can be configured to repeat an RFID signal externally between an external RFID reader 40 and a pluggable transceiver 10 placed thereon. In the present embodiment, the external RFID repeater 100 provides similar functions and operation as the internal/external RFID repeater 200 described hereinabove in that it can relay signals between two RFID devices, except that the RFID repeater 100 can be configured to operate entirely external to the housing 12 of pluggable transceiver 10 (whereas the internal/external RFID repeater 200 relays signals to a receiving antenna that is internal to the pluggable transceiver). The external RFID repeater 100 can be configured to couple RFID signals between the external RFID reader 40 placed thereon and the pluggable transceiver 10 RFID antenna 39 placed thereon, wherein RFID antenna 39 is positioned within aperture 26 formed on the pluggable transceiver 10 housing 12 sidewall. The external RFID repeater 100 can also be configured to couple RFID signals between an external RFID reader 40 placed thereon and the pluggable transceiver 10 placed thereon, wherein RFID antenna 39 is positioned proximate to aperture 26 formed on the pluggable transceiver 10 housing 12 sidewall, and wherein the aperture 26 can be covered with a repeater smart label 28, a tagged repeater smart label 28, or an internal/external RFID repeater 200 installed on said pluggable transceiver 10 housing 12 sidewall.

The external RFID repeater 100 can be configured to concentrate and couple magnetic fields and passively relay RFID signals between the external RFID reader 40 and the pluggable transceiver 10 RFID antenna 39, or between said external RFID reader 40 and the pluggable transceiver 10 RFID antenna 39 through a repeater smart label 28 or a tagged repeater smart label 28 or through an internal/external RFID repeater 200 covering aperture 26, to facilitate programming the pluggable transceiver 10 to a desired configuration. The external RFID repeater 100 can be configured to enable RFID communications between an external RFID reader 40 and smart label 28 or tagged repeater smart label 28 covering aperture 26 of pluggable transceiver 10. In another embodiment, the external RFID repeater 100 can be configured to enable RFID communications between an external RFID reader 40 and tagged repeater smart label 28 or smart label 28 placed thereon. For example, the external RFID reader 40 can be a smart phone or tablet and can be used to program an MSA SFP+ form factor pluggable transceiver 10 using a series of RFID repeaters such as the external RFID repeater 100 and a repeater smart label 28 installed on the SFP+ housing 12 covering aperture 26 formed on a sidewall. In another embodiment, the external RFID repeater 100 can be configured to enable RFID communications between an external RFID reader 40 placed thereon and a pluggable transceiver 10 RFID antenna 39 placed thereon through a repeater smart label 28 or a tagged repeater smart label 28 or internal/repeater 200 installed covering aperture 26, wherein aperture 26 can be formed on another sidewall (e.g. top or bottom or left or right sidewall) or faceplate or backplate of pluggable transceiver 10 housing 12. In another embodiment, the external RFID repeater 100 can be configured to enable RFID communications between an external RFID reader 40 placed thereon and a pluggable transceiver 10 smart label 28 placed thereon, wherein the smart label 28 can be installed covering aperture 26, and wherein the aperture 26 can be formed on a sidewall or faceplate or backplate of pluggable transceiver 10 housing 12. In another embodiment, the external RFID repeater 100 can be configured to enable RFID communications between an external RFID reader 40 placed thereon and a pluggable transceiver 10 RFID antenna 39 placed thereon, wherein the RFID antenna 39 can be detachably installed on a connector located on the pluggable transceiver 10 housing 12, for example RFID antenna can be temporarily installed on an MSA SFP+ pluggable transceiver 10 host interface connector during programming. In another embodiment, the external RFID repeater 100 can be configured to enable RFID communications between two external RFID readers 40 placed thereon.

In another present embodiment, the external RFID repeater 100 can be configured to enable RFID communication between an external RFID reader 40 and any one of a plurality of different pluggable transceiver 10 form factors and footprints, smart labels 28, and RFID repeater 200 configurations. For example, the external RFID repeater 100 can be configured to interface with any one of a plurality of MSA pluggable transceiver 10 form factors such as SFP+, QSFP, and CFP2 MSA form factors, wherein each pluggable transceiver 10 form factor can be configured with a different smart label 28 or tagged repeater smart label 28 or a repeater smart label 28 or RFID repeater 200 configuration form factor and installed on the pluggable transceiver 10 housing 12 covering aperture 26.

In another embodiment, the external RFID repeater 100 can be configured to enable RFID communications between an external RFID reader 40 and a pluggable transceiver 10 wherein the pluggable transceiver 10 can be configured as a shielded plug-in circuit card or a rack mounted electronics cabinet or shelf or case form factor. In another embodiment, the RFID repeater 100 can be configured to interface with any one of a plurality of different shielded electronics housing 12 configurations, form factors and footprints. In another embodiment, the external RFID repeater 100 can be configured to enable RFID communications between an external RFID reader 40 and a pluggable transceiver 10 wherein the pluggable transceiver 10 can be configured as shielded electronics housing 12 form factor, and wherein the RFID repeater 100 can be configured to interface with any one of a plurality of different shielded electronics housing 12 configurations, form factors and footprints, and wherein said shielded electronics housing 12 can be configured with at least aperture 26, and contains the RFID antenna 39 and the RFID reader 36, and wherein said shielded electronics housing 12 can also be preferably configured with a smart label 28 installed covering aperture 26. For example, said shielded electronics housing 12 can be configured as a computer server plug-in card or a storage server plug-in card or a communications switch, network interface or line interface plug-in card, etc., in ATCA circuit card form factor and footprint.

In another embodiment, the external RFID repeater 100 can be configured to enable RFID communications between an external RFID reader 40 and an RFID device configured as a “tap” RFID debit card or credit card or identification card or memory card placed thereon. In another embodiment, the external RFID repeater 100 can be configured to enable RFID communications between an external RFID reader 40 and an RFID device configured as an RFID tag placed thereon. In the present embodiment, the data read from said RFID card or tag can be used to program another RFID device such as an external RFID reader 40 or a pluggable transceiver 10 or a smart label 28 or tagged smart label 28, etc. For example, the RFID card or tag data can be used to perform a financial transaction and/or to verify user credentials and/or to receive configuration data, and, for example, to enable reading or receiving or downloading data and or data files from said cards, and for example to activate a license, and for example to encrypt data, and for example an RFID tag can be used to acquire GPS location data.

The external RFID repeater 100 can also be configured to allow performing a two-step programing process, wherein the external RFID repeater 100 can be configured to enable RFID communications between an external RFID reader 40 and a first RFID device. The external RFID reader 40 can be configured to receive configuration data from said first RFID device, and the external RFID repeater 100 can also be configured to enable RFID communications between the external RFID reader 40 and at least a second RFID device, and wherein the external RFID reader 40 can be configured to use said configuration data received from said first RFID device to program said second RFID device to a desired configuration. For example, said two-step process can be used to perform secure transactions or logins on a computer system, and copy configuration data or programming data or digital media data or data files or other data from one (first) RFID device to another (second) RFID device such as to transfer configuration data from one MSA SFP+ pluggable transceiver 10 to another MSA SFP+ pluggable transceiver 10.

In the example embodiment illustrated in FIG. 6, the external RFID repeater 100 includes a first or primary RFID antenna 130. For example, and as illustrated, the primary RFID antenna is configured as a field-concentrating repeater RFID antenna coil. The first RFID antenna 130 can be configured to interface with a first RFID device, such as an external RFID reader 40. The external RFID repeater 100 also includes a second or secondary RFID antenna 150. For example, and as illustrated, the secondary RFID antenna 150 is also configured as a field concentrating repeater RFID antenna coil. The second RFID antenna 150 can be configured to interface with a second RFID device such as the pluggable transceiver 10, smart label 28, tagged repeater 28, repeater smart label 28, RFID repeater 200 and other RFID devices described herein. The external RFID repeater 100 further includes an electrical path 160, which may be an electrical circuit 160, that provides an electrical connection between the first RFID antenna 130 and the second RFID antenna 150. For example, and as illustrated, the circuit 160 connects to port feeder 406a and feeder port 406b of the primary RFID antenna 130 and the secondary RFID antenna 150, respectively. This electrical circuit 160 enables relaying RFID signals and/or RFID communication between the first RFID antenna 130 and the second RFID antenna 150 therethrough. More particularly, RFID signals captured at one of the first and second RFID antennas 130, 150 (ex: from either the pluggable transceiver 10 or the external RFID reader 40) is passively transmitted over the electrical circuit 160 and repeated at the other of the first and second RFID antennas 150, 130 (ex: at either the external RFID reader 40 or pluggable transceiver 10). Accordingly, the external RFID repeater 100 can be configured to enable RFID communication between an external RFID reader 40 and a RFID device of varying types therethrough. In the present embodiments, the feeder ports 406a and 406b are used to illustrate where electrical circuit 160 interconnects with RFID antenna 130, 150, for example the feeder ports are locations where the antenna and electrical circuit connections are made using a printed conductor trace or wire. However, it will be understood that the feeder portions 406a, 406b may not appear as a specific or visibly identifiable connection point. Alternatively, one or both of the antennas 130 or 150 can be connected to the port of an RFID transceiver device (e.g. RFID memory 36 or internal RFID reader 36). In some embodiments, one or both feeder ports 406a, 406b can be configured with components, for example components used for resonant frequency tuning of RFID antenna 130 and 150, such as one or more capacitors arranged in a resonant frequency tuning circuit and connected to RFID antenna 130, 150 and electrical circuit 160. In some embodiments, one or both feeder ports 406a, 406b can also be configured with connectors or terminals to connect RFID antenna 130 and 150 to electrical circuit 160, and/or to interconnect said components.

According to various example embodiments, the external RFID repeater 100 can be used within an RFID repeater system provided in different form factors and structural configurations to provide ease of use to an operator or to a machine when programing an RFID device. Preferably the external RFID repeater 100 can be used within a system to program RFID devices having varying configurations, form factors and/or footprints, using an external RFID reader 40. In some embodiments, said RFID repeater system can be configured to provide a mechanism to house, securely and reliably operate, transport and store the external RFID repeater 100, and in some embodiments configured to attach an external RFID reader 40.

In the example illustrated in FIG. 6, the external RFID repeater 100 can be formed on a substrate 110, such as a two layer printed circuit board or a flexible printed circuit assembly. In the present embodiment, the external RFID repeater 100 RFID antenna 130 and 150 coil circuits are positioned side by side on the substrate 110, and are not overlapping one another. The RFID antennas 130 and 150 can be located on a same plane defined by the substrate 110. In the present embodiment, the external RFID repeater 100 substrate 110 can be configured as a flat planar surface supporting RFID antenna 130 and 150. One or more visible and/or tactile targets are defined on an outer top surface of a housing that houses the substrate, the targets being in aligned with the RFID antennas 130 and 150. The locations of the targets correspond to areas of a top surface of the substrate 110. The targets are used by an operator and/or a machine to position the RFID devices (ex: external RFID reader 40 and pluggable transceiver 10, or the like) on the top surface of the external RFID repeater 100, and to enable RFID communications between antenna 130 and 150. In the present embodiment, the first RFID antenna 130 coil can be located at least partially within at least one first outlined target area, for example outline target area 120 (located on a top surface of a body housing the substrate 110), and the second RFID antenna 150 coil can be located at least partially within at least one second outlined target area (also located on a top surface of a body housing the substrate 110), such as outlined target areas 142, 144, and 146. In the present embodiment, circuit coil traces 132 of the primary RFID antenna 130 can be contained within a first target area, such as area 120. In the present embodiment, the circuit traces 152 of the secondary RFID antenna 150 can be contained within the second target area, such as 142, 144 and 144. In the present embodiment, a housing of the external RFID repeater 100 (which houses the substrate 110 and antennas 130, 150) can be configured to support an external RFID reader 40 in a tablet or smart phone form factor placed on target area 120 and can be configured to support at least a portion of a pluggable transceiver 10 housing 12 footprint, for example it can support a portion of an MSA SFP+ and QSFP and CFP2 form factor footprints placed within target areas 142, 144 and 144 respectively.

In the present embodiment illustrated in FIG. 6, the RFID antenna can be physically sized to interface with the various smart label 28 embodiments described herein, wherein said smart labels 28 are installed on the pluggable transceiver 10 housing 12 as described herein. The surface area defined by the RFID antenna 150 coil traces 152 may be smaller than the surface area of the smart label 28 body installed on a pluggable transceiver 10 shielded housing 12. The RFID antenna 150 can be configured to interface with smart labels 28 having different body form factors, wherein each smart label 28 RFID antenna 74 embodiment will be configured to be compatible with the secondary RFID antenna 150. For example, the RFID antenna 150 resonant circuits are tuned to be interfaceable with smart labels 28 of different configurations, wherein each said smart label 28 RFID antennae 70, 74 is configured with a specific inductance and capacitance and loading, or at least configured within an acceptable range of inductance and capacitance and loading, and wherein the smart label 28 RFID antennas 70, 74 resonant circuits are tuned to be compatible with RFID antenna 150. The RFID coupling between the external RFID repeater 100 substrate 110 RFID antenna 150 and the smart label 28 RFID antenna 70 is increased when the smart label 28 RFID antenna 70 is positioned in proximity (ex: in a direction orthogonal to the plane defined by the substrate 110) to the RFID antenna 150 within the read range (e.g. preferably touching). The smart label 28 RFID antenna 70 is also to be positioned to at least partially overlap (or in alignment in the x-y direction) with the RFID antenna 150. This can be in a range from partially overlapping to preferably substantially overlapping the RFID antenna 150. In an embodiment, the external RFID repeater 100 can be configured to enable RFID communications between the external RFID reader 40 and the smart label 28 embodiments installed on the pluggable transceiver 10 housing 12 embodiments when the center of the smart label 28 body is positioned to be centered over the RFID antenna 150 coil area and within the read range. It should be note that the performance of the RFID antenna 150 and RFID coupling is adversely affected and influenced by the presence of metal or conductive material positioned proximate to traces 152. For example the metal shielded housing 12 of a pluggable transceiver 10 may disable the RFID communications.

In the present embodiment illustrated in FIG. 6, the second target area can be configured to enable positioning at least a portion of the pluggable transceiver 10 housing 12 footprint within said target area such that the smart label 28 installed on said pluggable transceiver 10 is properly aligned with the RFID antenna 150 to enable RFID communications as described herein. In another present embodiment, the second target area can be configured to enable positioning at least a portion of the pluggable transceiver 10 housing 12 footprint within said target area such that the aperture 26 formed on said pluggable transceiver 10 housing 12 sidewall is properly aligned with the RFID antenna 150 to enable RFID communications as described herein. For example, said second target areas can be used to position the pluggable transceiver 10 housing 12 in the correct position during operation.

In the embodiment illustrated in FIG. 6, said second target areas (ex: target areas 142, 144, 146) are overlapping and have shared areas overlapping the surface of the external repeater 100, wherein each second target area can be formed to receive a RFID device having a different form factor or footprint. The second target areas can each be formed to receive at least a portion of the pluggable transceiver 10 housing 12 form factor footprint, for example target areas 142, 144 and 146 can be formed in rectangular shapes around the RFID antenna 150, wherein each outline can start at the front edge of the top surface of the repeater 100 and extend linearly towards a back edge of the top surface of the repeater 100 to form the various target outlines each having a different size, wherein said targets can be printed or painted or etched a surface of the housing body that houses the substrate 110.

In the present embodiment, the target area 120 can be configured to target and position an external RFID reader 40, such as a tablet or smart phone, within said first target area 120, and the second target areas 142, 144, and 146 can be configured to target and position a pluggable transceiver 10, which may have different configurations, form factors and footprints, and wherein at least a designated portion of said pluggable transceivers 10 housing 12 can be positioned within said second target areas to enable RFID communications. For example, the back or rear or host interface connector mating portion of a pluggable transceiver 10 housing 12 can be placed within the second target area 142, 144, 146 to enable RFID communications with the external RFID reader 40. For example, at least a portion of an MSA SFP+ pluggable transceiver 10 form factor housing 12 footprint can be positioned on the surface within target area 142, and at least a portion of an MSA QSFP pluggable transceiver 10 form factor housing 12 footprint can be positioned on the surface within target area 144, and at least a portion of an CFP2 pluggable transceiver 10 form factor housing 12 footprint can be positioned on the surface within target area 146 to enable RFID communications with the external RFID reader 40. For example, at least a portion of a smart label 28, tagged repeater smart label 28, RFID credit, debit, identification or memory card, or RFID tag body can be positioned on the surface within target area 142 to enable RFID communications with the external RFID reader 40.

The RFID antenna 130 can be a planar coil circuit and the RFID antenna 150 can be a planar coil circuit, wherein the RFID antenna 130 and 150 and the electrical circuit 160 can be formed on the substrate 110, for example using printed, etched, or deposited circuits on a circuit board assembly or flexible printed circuit assembly. It will be understood that other implementations are possible. In another embodiment, the RFID antenna 130, 150 can be formed using insulated wire looped coils connected with electrical circuit 160 and supported by substrate 110. In the present embodiment, the magnetic axis of the planar printed coils and or looped wire coils is in the z plane (e.g. perpendicular to the substrate 110 defining the x-y plane). In a preferred embodiment, RFID antenna 150 can be formed using an inductor coil mounted on substrate 110, for example configured in a surface mounted package such as a 3 mm×3 mm chip inductor device, wherein the mounted inductor coil magnetic axis is in the x-y plane (e.g. the same plane as the PCBA 110). It should be noted that in other embodiments, the RFID antenna 130 and 150 may be formed using other circuit geometries and configurations.

In the present embodiment, the RFID antenna 130 planar coil can be sized to interface with an external RFID reader 40 RFID antenna 50, for example RFID antenna 130 is sized to interface with a smart phone RFID antenna 50 wherein the dimensions of the smart phone can be approximately 140 mm deep×70 mm wide and wherein the RFID antenna 130 surface area can be approximately 60 mm deep×40 mm wide. It should be noted that the configuration, size and location of the RFID antenna contained within the smart phone housing will vary from device to device and from manufacturer to manufacture, consequently, RFID antenna 130 may have to be configured accordingly to enable RFID communications with a plurality of different external RFID reader 40 embodiments.

The RFID antenna 150 planar coil can be sized to interface with at least one pluggable transceiver 10 and smart label 28 form factor, and preferably can be sized to interface with a plurality of pluggable transceiver 10 and smart label 28 form factors, as described herein. For example, the RFID antenna 150 width can be sized and configured to interface and mate with the various smart label 28 embodiments installed at various locations on the various pluggable transceiver 10 housing 12 footprints for example MSA SFP+, QSFP and CFP2 device footprints positioned and aligned within targets 142, 144, and 146. For example, the RFID antenna 150 coil can be positioned directly underneath said smart label 28 body, wherein the smart label 28 body can be sized to substantially overlap the RFID antenna 150 coil, and wherein the smart label RFID antenna 70 can be configured and positioned within the smart label 28 body to interface with the RFID antenna 150. For example, the smart label 28 body can be configured to cover a portion of the surface metal material forming the pluggable transceiver 10 housing 12 and surrounding aperture 26, and wherein the smart label 28 can be configured with an EM substrate 65 (FIG. 3C) to shield the RFID antenna 150 coil from the metal housing 12 and enable RFID communications.

According to the example embodiment illustrated in FIG. 6, the position and size of the RFID antenna 150 coil on substrate 110 can be configured to fit completely within target area 142 which corresponds to the outline of at least a portion of the MSA SFP+ pluggable transceiver 10 housing 12 footprint, and wherein the position of the RFID antenna 150 coil within target 142 corresponds to the location of the SFP+ product label specified in the SFP+ MSA. In another example, the RFID antenna 150 coil is positioned and sized to interface with an MSA SFP+ pluggable transceiver 10 and smart label 28, wherein the position and dimensions of the housing 12 footprint mating within a typical transceiver cage is approximately 47.5 mm deep×13.55 mm wide and the dimension of the smart label 28 body footprint installed on the SFP+ 10 is approximately 11.0 mm wide×24.0 mm deep, consequently the RFID antenna 150 coil can be sized to be approximately 10.0 mm wide×10.0 mm deep, or preferably smaller. For example, the center of the RFID antenna 150 coil can be positioned approximately 20.0 mm from the back line of target 142, wherein the back line corresponds to the location of the SFP+ housing 12 host interface connector. The RFID antenna 150 can be sized and positioned to interface with MSA SFP+ and QSFP pluggable transceiver 10 and smart label 28 form factors, wherein the dimensions of the QSFP housing 12 mating footprint is approximately 52.4 mm deep×18.35 mm wide, and wherein the QSFP smart label 28 body footprint is approximately 13 mm wide×32 mm deep and can be installed on the QSFP housing 12 as specified in the QSFP MSA, and wherein target 144 can be sized and positioned to receive at least a portion of the QSFP 10 housing 12 and to align RFID antenna 150 and said QSFP smart label 28 RFID antenna 1300 as described herein, and wherein the size of target 144 can be approximately 47.5 mm deep×18.35 mm wide. In the present embodiment, the RFID antenna 150 can be sized and positioned to interface with MSA SFP+, QSFP, and CFP2 pluggable transceiver 10 and smart label 28 form factors, wherein the dimensions of the CFP2 housing 12 mating footprint is approximately 91.5 mm deep×41.5 mm wide, and wherein the CFP2 smart label 28 body footprint is approximately 39.5 mm wide×16.5 mm deep and is installed on the CFP2 housing 12 as specified in the CFP2 MSA, and wherein target 146 can be sized and positioned to receive at least a portion of the CFP2 housing 12 and to align RFID antenna 150 and said CFP2 smart label 28 RFID antenna 70 as described herein, and wherein the size of target 146 can be approximately 65.5 mm deep×41.5 mm wide. In another embodiment, the RFID antenna 150 coil size can be approximately 10 mm wide×14 mm deep.

The external RFID repeater 100 PCBA substrate 110 can be sized to allow placement of the external RFID reader 40 and pluggable transceiver 10 side by side or adjacent to each other over a same top surface of the repeater 100. Sufficient space is provided between the target areas 120 and 140, 142 or 144 to enable placing and manipulating the external RFID reader and pluggable transceiver on the surface of the substrate 110. For example, given that an external reader 40 smart phone housing can have approximate dimensions of 140 mm deep×70 mm wide and the dimensions of the CFP2 mating footprint is approximately 65.5 mm deep×41.5 mm wide, consequently the dimensions of the external RFID repeater 100 substrate 110 can be approximately 140 mm deep and 140 mm wide.

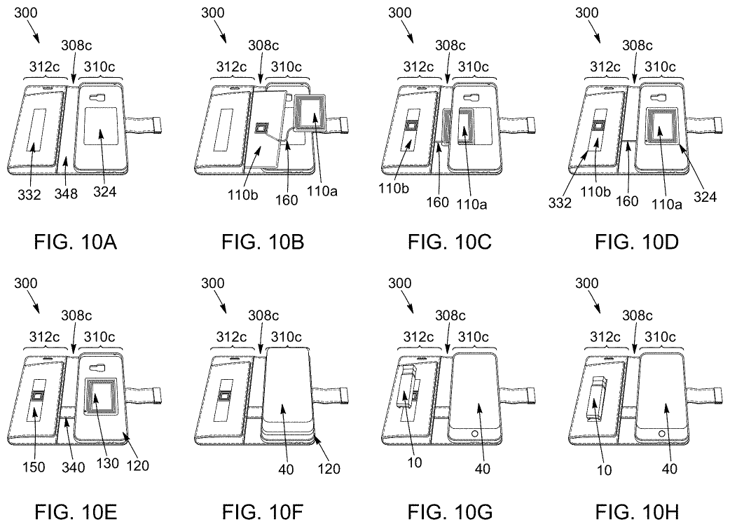

In an embodiment, the substrate 110 can be a substantially rigid assembly, such as a single layer, or multi-layer, fiber glass epoxy based PCBA that includes dielectric materials and containing and/or supporting RFID antenna electrical circuits. For example the thickness of a typical 2-layer PCB substrate can be approximately 1.6 mm. In an alternative embodiment, the substrate 110 can be a flexible assembly, for example an assembly consisting of flexible plastic film or sheet materials such as polyester (polyethylene terephthalate PET or PETE), polyimide, etc., laminated together containing and or supporting RFID antenna electrical circuits. For example, the thickness of a typical 2-layer flex substrate can be approximately in a range of 0.12 mm to 0.22 mm. In yet other embodiments, the external RFID repeater 100 can include a plurality of discrete substrates and electrical circuit connections containing or supporting RFID antenna electrical circuits. For example, the first RFID antenna 130 can be a coil formed on a first substrate 110a (ex: see FIG. 10b) and the second RFID antenna 150 can be a coil formed on a second substrate 110b (ex: see FIG. 10b) that is discrete from the first substrate 110a and the first and second RFID antennas 130, 150 can be interconnected with the electrical circuit 160 using electrical conductors, for example an electrical cable configured with at least two conductors such as insulated wires. In the present embodiment, the RFID antenna 130, 150 and electrical circuits can be covered and/or coated with an insulating material to protect said circuits against short circuits with metal objects such as the pluggable transceiver metal housing 12 positioned thereon, for example protective dielectric materials such as a solder mask or conformal coating such as a polymeric film, and or painted or printed acrylic, urethane, silicone, latex, or varnish coating.

In an embodiment, the RFID repeater 100 substrate 110 can be configured with an EM substrate, for example similar to the EM substrate 65 used in the internal external RFID repeater 200 and smart label 28. A layer of ferrite material, such as a ferrite sheet, film or tape, can be provided to minimize the effects of a metallic surfaces located proximate (e.g. directly underneath) the RFID antennae 130 and 150 and their coupling fields, and/or to minimize unintended electromagnetic signals from being transmitted or received by the external RFID repeater 100 circuits. The EM substrate is positioned to enable RFID EM signals to couple between at least the external RFID reader 40, pluggable transceiver 10 and external RFID repeater 100, and also positioned to enable an external RFID reader 40 to communicate with a wireless network such as an LTE or Wi-Fi mobile communications network to transmit and receive pluggable transceiver 10 configuration data. For example, said EM substrate is used to shield the external RFID repeater 100 substrate 110 from a metal surface upon which it may be placed. For example, the EM substrate is positioned on an exterior surface of the substrate 110 and underneath the top surface of the repeater 100 at a location in alignment with the RFID target area 120 corresponding to the primary RFID antenna 130 and target area 142, 144, 146 corresponding to RFID antenna 150 to improve the EM signal coupling. The EM substrate may be provided above and below electrical circuit 160. The EM substrate is configured to improve the magnetic coupling between the RFID antenna 50 of the external RFID reader 40 and RFID antenna 130, and between antenna 70 of the RFID pluggable transceiver 10 and RFID antenna 150 when the external RFID repeater 100 is placed on a metal surface such as a metal case, chassis, cabinet, table, platform, electro-static mat etc. This improvement can be provided by preventing eddy currents from forming on the metal housing, and allowing the EM fields to couple around the wires 132 and 152 of RFID antenna 130 and 150. In an embodiment, a EM suppressing substrate may be made of aluminum or copper material, such as a copper sheet or tape or printed circuit area, and can be used in locations that are remote of the RFID antennas 130, 150 and/or electrical circuit 160. The EM suppressing substrate is operable to suppress and attenuate unintended EM signals from being transmitted from the external RFID repeater 100 substrate 110.

In the present embodiment, the external RFID repeater 100 RFID antenna 130 and 150 on substrate 110 are configured with resonant frequency tuning components or structures to tune the resonant frequency of said RFID antennas and enable RFID communications signals to be coupled and transmitted therethrough. For example, said tuning is affected by RFID antenna near-field operating environment including the substrate 110 electromagnetic configuration, nearby materials or objects, and the presence of the underlying surface supporting the substrate 110. The tuning is also particularly affected by the RF loads of the various RFID devices (e.g. impedance based on their respective electromagnetic configurations and materials) placed on the external RFID repeater 100. For example, said RFID antenna 130, 150 tuning can be affected by the ferrite and metallic materials located proximate to said RFID antenna 130, 150, and for example the tuning can be affected by the pluggable transceiver 10 housing 12 materials and smart label 28 materials and RFID antenna 70, 74 placed thereon. For example, in an embodiment, the external RFID repeater 100 can be tuned to transmit and receive RFID communications to and from RFID antenna 39 contained within an electromagnetically shielding metal housing of a pluggable transceiver 10 through an aperture 26. For example, the external RFID repeater 100 can be tuned to transmit and receive RFID communications to and from RFID antenna 39 contained within an electromagnetically shielding metal housing 12 of a pluggable transceiver 10 through an aperture 26 and an internal/external RFID repeater 200, a tagged smart label 28, or a repeater smart label 28. For example, the external RFID repeater 100 can be tuned to transmit and receive RFID communications to and from a smart label 28 or a tagged smart label 28 installed on an electromagnetically shielding metal housing 12 of a pluggable transceiver 10. For example, the external RFID repeater 100 can be tuned to transmit and receive RFID communications to and from pluggable transceiver 10 configured in a plurality of different electromagnetically shielding metal housing 12 form factors as described herein, for example MSA SFP+, QSFP, or CFP2 metal housing form factors. In an embodiment, said RFID repeater 100 tuning can be performed to enable RFID communications signals to be coupled and transmitted therethrough to RFID devices formed with shielded metal housing materials as described herein and RFID devices formed with plastic RF transparent housing materials such as a plastic material used to house an RFID credit card or location tag.

In an embodiment, the external RFID repeater 100 can be configured with at least one RFID tag (e.g. RFID memory and an RFID antenna), wherein the tag can be located within at least a first target area, such as target area 120, whereby the RFID tag circuits can operate independently of the external RFID repeater 100 circuits. The RFID tag is configured to store the external RFID repeater 100 configuration data in its RFID memory. The external RFID repeater 100 configuration data can include product information data such as part number and serial number, and can include RFID antenna 130 and 150 and circuit 160 and substrate 110 specification and/or test and/or performance data, and can include security data such as a password data or encryption key data, and can include license or licensing or authorization data, etc. In an embodiment, the external RFID reader 40 can be configured to read said RFID tag and receive the external RFID repeater 100 configuration data. In an embodiment, the external RFID reader 40 can be configured to program RFID devices using the external RFID repeater 100 and the configuration data stored in said RFID tag RFID memory. In an embodiment, the external RFID reader 40 can be configured to not program RFID devices using the external RFID repeater 100 based on the configuration data stored in said RFID tag RFID memory. In an embodiment, the external RFID reader 40 can be configured to not program RFID devices using the external RFID repeater 100 if the external RFID reader 40 determines that its RFID interface is not compatible with the external RFID repeater 100 RFID interface based on configuration data stored in said RFID tag RFID memory. In an embodiment, the external RFID reader 40 can be configured to not program RFID devices 44 using the external RFID repeater 100 if the external RFID reader 40 determines that the external RFID repeater 100 RFID interface is not secure or does not provide a secure communications channel based on configuration data stored in said RFID tag RFID memory. It should be noted that in this external RFID reader 100 and RFID tag configuration provides a similar configuration and function as the tagged repeater smart label 28 described herein.

A radio frequency signal repeater system according to various example embodiments includes an embodiment of the external RFID repeater 100 and at least one housing body for housing the external RFID repeater 100. In some embodiments described elsewhere, an integrated RFID reader device 40b can also be housed within the housing. More particularly, the radio frequency signal repeater system housing body includes a first housing portion configured to house the first RFID antenna 130 and to mechanically support a first RFID device, for example an external RFID reader 40, such as smart phone or tablet. When appropriately supported, the external RFID reader 40 is in RFID communication with the first RFID antenna 130 housed in the first housing portion. The housing body also includes a second housing portion configured to house the second RFID antenna 150 and to mechanically support another RFID device, such as a pluggable transceiver 10, or another external RFID reader 40, etc. When appropriately supported, the pluggable transceiver 10 is in RFID communication with the second RFID antenna 150. Providing the first RFID antenna 130 and the second RFID antenna 150 within different portions of the housing body that are electrically and mechanically joined, and that further mechanically support the various external RFID reader 40 and pluggable transceiver 10 form factors and RFID device 44 form factors, allows the external RFID repeater 100 to be provided in different form factors and structural configurations, as described herein.

According to some embodiments, the first housing portion and the second housing portion can be integrally formed. In other words, the first housing portion and the second housing portion of the housing body share a unitary body.

According to some embodiments, the first housing portion and the second housing portion can be positioned to be co-planar with one another.

In other embodiments, the first housing portion and the second housing portion, each housing a respective RF antenna, can be positioned to be non-planar with one another. In other words, a plane defining the first housing portion and a plane defining the second housing portion further define a non-zero angle therebetween. The electrical circuit 160 can be curved and/or flexed to make the electrical connection between the non-planar first and second housing portions.

In some embodiments, parts of the housing body can be rigid. In a sub-embodiment, the entire housing body can be rigid. In another sub-embodiment, at least one of the first housing portion and the second housing portion, or both portions, are rigid. In another sub-embodiment, at least one of the first housing portion and the second housing portion, or both portions, are rigid and structurally reinforced for mobile applications and transportation.

In some alternative embodiments, the housing body can be formed of a substantially flexible material or materials.

In some embodiments, the first housing portion and the second housing portion, each housing a respective RFID antenna, are movable relative to one another. The first and second housing portion may be connected by a flexible intermediate member. This flexible intermediate member may provide a pivotal relative movement between the two housing portions. In other embodiments, the first and second housing portion may be connected by at least one joint member, such as a hinge mechanism, which can also provide a pivotal relative movement. In another embodiment, the first and second housing portions may be connected by a tilting and swiveling joint or hinge mechanism. For example, a portable RFID repeater 100 having a tilting and swiveling joint which allows the first housing portion cover and the first RF antenna 130 to be tilted from the second housing portion base and the second RF antenna 150 of the portable RFID repeater 100 and then swiveled about a vertical axis.

In various embodiments, the electrical circuit 160 provides a flexible electrical connection between the RFID antennas 130, 150 housed in each of the housing portions. This flexible electrical connection can provide ease of construction, such as where the housing portions are non-planar. The flexible electrical connection can also be useful where the housing portions are spaced apart from one another or where limited space is available in the repeater system to route the electrical circuit 160. The flexible electrical connection can also permit the relative movement between the first housing portion and the second housing portion. The flexible electrical connection can also be routed through the flexible intermediate member, such as a mechanical conduit, hinge or joint. The electrical circuit 160 can be provided in the form of insulated copper electrical wires, mating electrical connectors, an electrical path drawn or etched or deposited on a flexible or rigid printed circuit assembly, for example copper or aluminum traces on a PBCA or flex circuit, or any other solution known in the art.

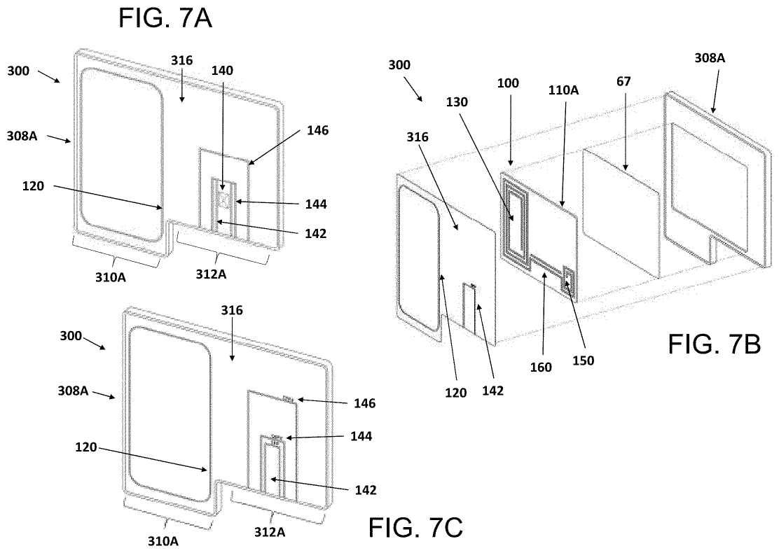

Referring now to FIG. 7A therein illustrated is an isometric view of a radio frequency signal repeater system 300, hereinafter referred to as the RFID signal repeater system 300, according to a first example embodiment. FIG. 7B illustrates an exploded view of the RFID signal repeater system 300. FIG. 7C illustrates an isometric view of the radio frequency signal repeater system according to an alternative example embedment. The RFID repeater system 300 can be configured with a housing body 308A in a slate case form factor to house an external RFID repeater 100. As illustrated, the housing body 308A can be formed in a substantially rectangular prism shape having a planar flat top surface 316. The substrate 110 of the external RFID repeater 100 is received within sidewalls of the housing body 308a and the flat top surface 316 shield the substrate 110, as well as the RFID antenna circuits 130, 150 and the electrical circuit 160.

The housing body 308A can have different configurations of top surface 316. Top surface 316 shown in FIG. 7B has one or more target areas 142, 144, and 146 formed thereon each for interfacing with a respective pluggable transceiver 10 having a specific form factor and footprint (ex: SFP, QSFP, CFP2). The target areas 142, 144, and 146 are shown as superimposed in FIG. 7B, but it will be understood that they may be individually drawn on the housing body 308A according to different configurations of the electrical circuit 160. The top surface 316 shown in FIG. 7A (e.g. similar to FIG. 6) can be configured to interface with a plurality of pluggable transceiver 10 form factors and footprints.

The first RFID antenna 130 and the second RFID antenna 150, which may be formed on a single substrate 110, such as a PCBA, are housed inside the body 308A. In the illustrated example, the first portion 310A of the housing body 308A, also referred to as the left side portion of the body, corresponds to the location of the first RFID antenna 130. In the present embodiment, at least one visual or tactile target is provided on the top surface 316, for example the target 120 may be in the form of a printed rectangle, footprint outline or other symbol, or a recessed or embossed or elevated outlined area, used to aid the positioning of an RFID device on RFID antenna 130. In the present embodiment, a first target is positioned on a first location 120 of the top surface 316A material that overlays the first RFID antenna 130 to indicate where a first RFID device, for example an external RFID reader 40 such as a smart phone or tablet, should be placed during operation.

The second portion 312A of the housing body 308A, also referred to as the right side portion of the body, corresponds to the location of the second RFID antenna 150. At least one visual or tactile target can be configured (ex: printed) on the top surface 316 material, wherein the target is shaped and sized to receive at least one RFID device having a matching form factor and footprint thereon. This RFID device can be a pluggable transceiver 10. The target can be positioned on at least one second location on the top surface 316 that overlays the second RFID antenna 150. For example the target 142 may be in the form of a printed rectangle or footprint outline or other symbol or a recessed or embossed or elevated outlined area, and wherein the target can be used to position and mate an RFID device 44 on RFID antenna 150.

In the embodiment illustrated in FIG. 7A, the top surface 316 of second portion 312A of the housing body 308A can be configured with a plurality of second targets, for example targets 142, 144, and 146, wherein each target is formed to receive at least one pluggable transceiver 10 form factor and footprint during operation. In the present embodiment, at least a portion of the pluggable transceiver 10 housing 12 mating footprint can be placed within the corresponding second target area. For example, in the present embodiment, target locations 142, 144 and 146 on surface 316 and RFID antenna 150 hidden under surface 316 can be sized and positioned to interface with a plurality of MSA SFP+, QSFP and CFP2 pluggable transceiver 10 and smart label 28 form factors and footprints, wherein at least a portion of each pluggable transceiver 10 housing 12 mating footprint can be placed within the corresponding target area as described in the previous embodiments illustrated in FIG. 6. In the present embodiment, target areas can be formed on the top surface 316 around the RFID antenna 150 traces 152 to indicate the location of RFID antenna 150, and wherein targets may be used to position other RFID device form factors and footprints or other pluggable transceiver 10 and smart label 28 form factors and footprints directly on target 140 covering RFID antenna 150. In the present embodiment, target areas 142, 144 and 146 can be provided on the top surface 316 to indicate where the various pluggable transceivers 10 form factors and footprints should be placed during operation. In an embodiment, the second portion 312A of the housing body 308A can be configured with at least one second target area, for example 142 or 144 or 146, that can be used to interface with a plurality of smart label 28 embodiments during operation. In an embodiment, the second portion 312A of the housing body 308A can be configured with a second target area, for example 146, that can be used to interface with a plurality of external RFID reader 40 embodiments. In an embodiment, the second portion 312A of the housing body 308A can be configured with at least one second target area, for example 140 or 142 or 144, that can be used to interface with a plurality of RFID card embodiments as described herein. In an embodiment, the second portion 312A of the housing body 308A can be configured with at least one second target area, for example 140 or 142 or 144, that can be used to interface with a plurality of RFID tag embodiments as described herein.

In the embodiments illustrated in FIGS. 7A, 7B and 7C the RFID repeater system 300 housing body 308A can be configured in a low-profile platform case form factor. In the present embodiment, the housing body 308A can be formed of substantially rigid material to support the shielding EM substrate 67, RFID repeater 100 substrate 110, top cover 316. The housing body 308A also provides the top surface 316 to support the RFID devices (ex: external RFID reader 40 and pluggable transceiver 10), whereby the top surface is raised above an underlying object or surface, such as tabletop or the like. In the present embodiment, at least the top surface 316 and substrate 110 of the housing body 308A can be formed with materials that permit RFID signal communications between the external RFID reader 40 and the first RFID antenna 130 and that permit communication between the pluggable transceiver 10 and the second RFID antenna 150. Furthermore, the housing body 308A can be formed of a unitary body such that the first housing portion 310A and the second housing portion 312A are integrally formed, wherein the first housing portion 310A and the second housing portion 312A are co-planar and maintain a fixed position relative to each other. In the present embodiment, housing body 308A includes the base cover having upstanding sidewalls extending from a bottom wall of said base cover to define at least one interior space and/or recess and/or channel for receiving the components of the RFID repeater system 300, for example, the repeater 100, EM substrate 67, PCBA substrate 110A. A top cover having the top surface 316 mates with the base cover to close of the interior space of the housing body 308. For example, the housing body 308A can be a single piece molded case composed of plastic material such as polycarbonate or ABS plastic material that supports the components to keep them securely encased, and wherein said components can be bonded or attached to the interior sidewall and or bottom wall surfaces of the housing body 308A base cover. For example, top surface 316 can be made of a thin sheet or film to minimize the mating distance between the RFID antennae, and wherein the surface 316 can be painted, printed or bonded or attached to the surface of substrate 110 PCBA and/or interior sidewall and or bottom wall surfaces of the housing body 308A base cover. In the present embodiment, at least a portion of the base cover of housing body 308A can be formed of a dielectric, or substantially dielectric, material that permits RF signals to be transmitted and received by the external RFID reader 40 (e.g. a mobile RFID programming device). For example, said RF signals can include Wi-Fi signals, cellular communication signals (ex: 2G, 3G, 4G, 5G, LTE, or the like), Bluetooth signals, or the like typically transmitted and received by a mobile electronic communications device.

In an embodiment illustrated in FIG. 7B, the external RFID repeater 100 substrate 110A is configured with at least one EM substrate 67, wherein a layer of ferrite material such as a ferrite sheet, film or tape is attached to the bottom surface of the PCBA 110 and is used to shield the RFID antennae 130, 150 from metal surfaces positioned proximate to the RFID antenna 130, 150 coils. The EM substrate 67 is positioned between the substrate 110A and the base cover of housing body 308A to improve coupling of EM signals between at least the external RFID reader 40 and the pluggable transceiver 10 and the external RFID repeater 100. The EM substrate 67 is also configured to enable an external RFID reader 40 to communicate with a wireless network such as an LTE or Wi-Fi or Bluetooth mobile communications network to transmit and receive pluggable transceiver 10 configuration data. In some embodiments, an EM substrate can be placed on other housing body 308A interior sidewall surface areas to attenuate unintended EM signals from radiating or being received by the from RFID repeater system 300. The EM substrate is configured to improve the magnetic coupling between the external RFID reader 40 RFID antenna and RFID antenna 130; and an RFID device RFID antenna (ex: antenna 39 of the pluggable transceiver 10) and RFID antenna 150 when said external RFID repeater 100 substrate 110A is supported by a metal surface or structure such as a metal housing body 308A or a metal case, chassis, cabinet, table, platform, electro-static mat, etc., by preventing eddy currents from forming on the metal housing, and allowing the EM fields to couple around the wires 411a and 411b of RFID antenna 130 and 150. In an embodiment, an EM suppressing substrate may be formed of aluminum or copper material, such as a copper sheet or tape or printed circuit area, and used on portions of body 308A not proximate to RFID antenna 130 and 150 to suppress and attenuate unintended EM signals from being transmitted from the RFID repeater system 300.

In the alternative embodiment illustrated in FIG. 7C, the top surface 316 (e.g. showing superimposed target areas) of second portion 312A of the housing body 308A can be configured with at least one second target, for example target 142 or 144 or 146, wherein each target can be formed to receive at least one RFID device form factor and footprint during operation. In the present embodiment, the entire pluggable transceiver 10 housing 12 mating footprint can be placed within the second target area. For example, in the present embodiment, target location 142 or 144 or 146 can be formed on surface 316A according to different configurations of the surface, and RFID antenna 150 can be located under the top surface 316 at a corresponding area using substrate 110 and can be sized and positioned to interface with an MSA SFP+ or QSFP or CFP2 pluggable transceiver 10 and smart label 28 form factors and footprints respectively, wherein each pluggable transceiver 10 housing 12 form factor mating footprint can be placed entirely within the corresponding target area 142, 144 or 146. For example, the mating footprint excludes the pluggable transceiver 10 faceplate, and the depth of the mating footprint is measured from the pluggable transceiver 10 positive stop portion to the end or rear portion of the housing 12.

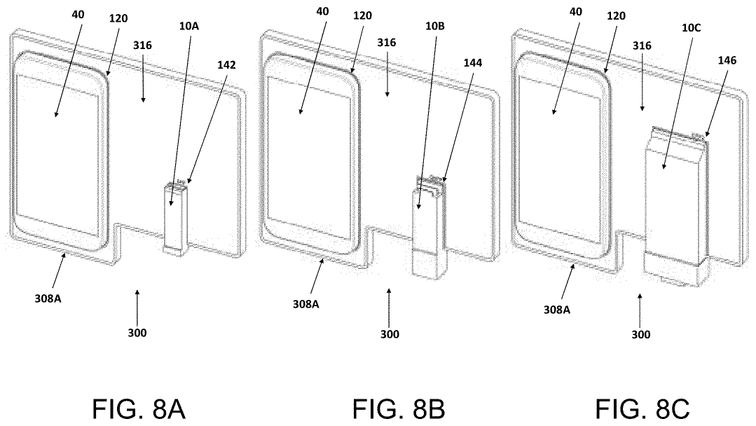

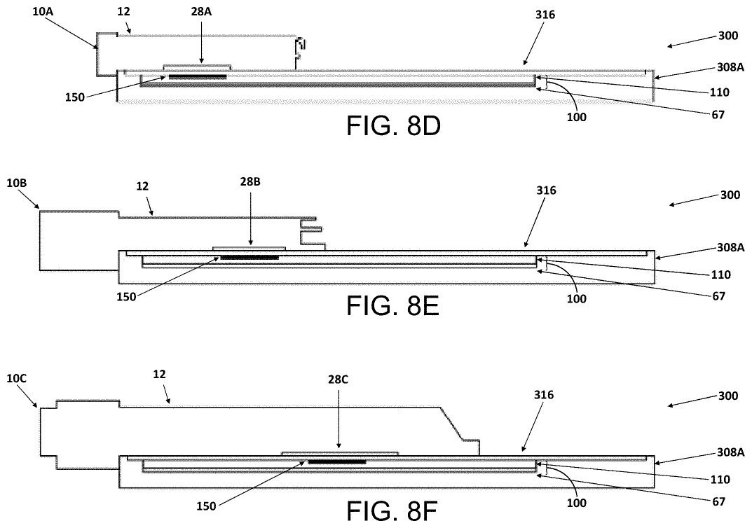

In the alternative embodiment illustrated in FIG. 7C, different configurations (i.e. different target areas 142, 144, 146) of the top surface 316A are shown in one superimposed view to illustrate the relative dimensions of the second target areas 140, 142, 144 and 146. These target areas can be formed individually on the top surface 316 according to different configurations. FIGS. 8A, 8B and 8C illustrate the RFID repeater system 300 in operation having a RFID reader device 40 and pluggable transceivers devices 10 having different form factors supported on the substrate 110.

In the embodiment illustrated in FIG. 7C and FIG. 8A, the top surface 316 of second portion 312A of the housing body 308A is configured with at least one second target 142 to receive an MSA SFP+ pluggable transceiver 10A form factor mating footprint during operation.

In the embodiment illustrated in FIG. 7C and FIG. 8B, the top surface 316 of second portion 312A of the housing body 308A can be configured with at least one second target 144 to receive an MSA QSFP pluggable transceiver 10B form factor mating footprint during operation.

In the present embodiment illustrated in FIG. 7C and FIG. 8C, the top surface 316C of second portion 312A of the housing body 308A can be configured with at least one second target 146 to receive an MSA CFP2 pluggable transceiver 10C form factor mating footprint during operation.

In an embodiment, target area 142, 144, 146 can be formed on the top surface 316 around the RFID antenna 150 traces 152 to indicate the location of RFID antenna 150, and where to position the pluggable transceiver 10 having different form factors and/or smart label 28 form factors to couple with the RFID antenna 150. In an embodiment, the second portion 312A of the housing body 308A can be configured with at least one second target area, for example 140 and 142, that can be used to interface with a plurality of smart label 28 embodiments during operation as described herein. In an embodiment, the second portion 312A of the housing body 308A can be configured with at least one second target area, that can be used to interface with a RFID card of different configurations, as described herein. In an embodiment, the second portion 312A of the housing body 308A can be configured with at least one second target area that can be used to interface with a RFID tag according to different embodiments as described herein.

FIGS. 8A, 8B and 8C illustrate isometric views of the RFID repeater system 300 and housing body 308A according to the present example embodiment in operation. In the present embodiment, the RFID repeater system 300 housing body 308A can be configured to program a plurality of pluggable transceiver 10 form factors, for example pluggable transceiver 10A or 10B or 10C form factors, using an external RFID reader 40. In the present embodiment, the external RFID reader 40 which is illustrated in the form of a smart phone can be placed within the first target area 120 on the top surface 316 of the first housing portion 310A of the housing body 308A during operation. In the embodiment illustrated in FIG. 8A, the pluggable transceiver 10A can be placed within the second target area 142 of the second housing portion 312A on the top surface 316 of the housing body 308A during operation. In the embodiment illustrated in FIG. 8B, the pluggable transceiver 10B can be placed within the second target area 144 of the second housing portion 312A on the top surface 316 of the housing body 308A during operation. In the embodiment illustrated in FIG. 8C, the pluggable transceiver 10C can be placed within the second target area 146 of the second housing portion 312A on the top surface 316 of the housing body 308A during operation. Due to the RFID signals from either the external RFID reader 40 and the pluggable transceiver 10A or 10C or 10C being repeated by the RFID repeater 100 substrate 110A or 110B or 110C housed within the housing body 308A, the external RFID reader 40 and the pluggable transceiver 10A or 10B or 10C are in RFID signal communication with one another, thereby allowing programming of the pluggable transceiver 10A or 10B or 10C to a desired configuration. In the embodiment illustrated in FIG. 8A, the external RFID reader 40 and RFID repeater system 300 and housing body 308A can be configured to program a pluggable transceiver 10A in an MSA SFP+ form factor positioned in area 142. In the embodiment illustrated in FIG. 8B, the external RFID reader 40 and RFID repeater system 300 and housing body 308A can be configured to program a pluggable transceiver 10B in an MSA QSFP form factor positioned in area 144. In the embodiment illustrated in FIG. 8C, the external RFID reader 40 and RFID repeater system 300 and housing body 308A can be configured to program a pluggable transceiver 10C in an MSA CFP2 form factor positioned in area 146. FIGS. 8A, 8B and 8C illustrate the external RFID reader 40 and RFID repeater system 300 and housing body 308A can be configured to program pluggable transceivers 10, 10A, 10B and 10C configured in plurality of form factors such as SFP+ and QSFP and CFP2 MSA form factors positioned in target areas 142 or 144 or 146.

In the present embodiment, the RFID repeater system 300, external RFID reader 40 and housing body 308A can be configured to read and write and program configuration data to a plurality of pluggable transceiver 10 form factors and footprints including SFP+ and QSFP and CFP2 MSA form factor embodiments, and a plurality of RFID card and tag form factor embodiments, and a plurality of smart label 28 form factor embodiments.

FIGS. 8D, 8E and 8F illustrate example side profile cut-away views of the RFID repeater system 300 and housing body 308A and pluggable transceivers 10 according to the present example embodiment in operation. In the present embodiment, the RFID repeater system 300 and housing body 308A can be configured to program a plurality of pluggable transceivers 10 form factors and footprints, for example pluggable transceiver 10A, 10B and 10C form factors and footprints illustrated in FIGS. 8A, 8B, 8C, 8D, 8E and 8F. In the illustrated embodiments, the external RFID reader 40 is placed within the first target area 120 of the first housing portion 310A on the top surface 316 of the housing body 308A. In the present embodiment, a pluggable transceiver 10A or 10B or 10C is placed within the second target area of the second housing portion 312A on the top surface 316A or 316B or 316C of the housing body 308A.

In the embodiment illustrated in FIGS. 8A and 8D, the external RFID reader 40 and housing body 308A can be used to program a pluggable transceiver 10A configured in an MSA SFP+ form factor positioned in target area 142.

In the embodiment illustrated in FIGS. 8B and 8E, the external RFID reader 40 and housing body 308A can be used to program a pluggable transceiver 10B configured in an MSA QSFP form factor positioned in target area 144.

In the embodiment illustrated in FIGS. 8C and 8F, the external RFID reader 40 and housing body 308A can be used to program a pluggable transceiver 10C configured in an MSA CFP2 form factor positioned in target area 146.

The RFID repeater system 300, external RFID reader 40 and housing body 308A can be configured to program, read and write RFID data to a plurality of pluggable transceiver 10 form factors and footprints such as MSA SFP+ and QSFP and CFP2 embodiments, and a plurality of RFID card or tag form factor and footprint embodiments, and a plurality of smart label 28 form factor embodiments.

In the embodiments illustrated in FIGS. 8D, 8E and 8F, an important consideration in the design of the RFID repeater system 300 and housing body 308A is the size and configuration of the RFID antenna 150 and traces 152 on substrate 110A, 110B and 110C and the position or alignment of RFID antenna 150 within the second target areas located on top surface 316 as described herein. The size, configuration and location of the RFID antenna 150 and can be formed to interface with the smart label 28A and 28B and 28C embodiments located on the pluggable transceiver 10A and 10B and 10C housing 12 embodiments to maximize the magnetic coupling as described herein. In another embodiment, the size, configuration and location of the RFID antenna 150 can be formed to interface with the smart label 28A or 28B or 28C embodiments located on the pluggable transceiver 10A or 10B or 10C housing 12 embodiments as described herein. In another embodiment, the size, configuration and location of the RFID antenna 150 can be formed to interface with the various aperture 26 and RFID antenna 39 embodiments described herein. For example, the mating surface 316 according to different configurations can be configured to be flat and planar at least within the first and second target areas. For example, the faceplate portion of pluggable transceivers 10A, 10B and 10C should not be positioned on the target areas 142, 144 or 146 and the mating footprint portion of the pluggable transceiver 10A, 10B and 10C housing 12 should be placed flat within target area 142 or 144 or 146 with the smart label 28A or 28B or 28C facing down resting on the top surface 316. For example, the pluggable transceiver 10A or 10B or 10C housing 12 can be inserted or slid onto said target areas 142 or 144 or 146 towards the back edge of the housing body 308A until a stop mechanism of the pluggable transceiver 10A, 10B and 10C housing 12 abuts against a front edge of the housing body 308A. For example, substantially all of the RFID antenna 150 traces 152 should be routed within an area on substrate 110 which is substantially smaller that the area of the smart label 28A and 28B and 28C body installed on pluggable transceiver 10A and 10B and 10C as described herein.

Where the housing body 308A has a slate form factor having a planar top surface, the RFID reader device 40 received within the first target area 120 can be resting on the top surface 316. Resting refers to the RFID reader device 40 being supported by force of gravity without other forms of mechanical retention. Similarly, the pluggable transceiver or other programmable RFID device being received within one of second target areas 142, 144, and 146 is also resting on the top surface 316 under force of gravity.

In the embodiments illustrated in FIGS. 8D, 8E and 8F, another important consideration in the design of the pluggable transceiver 10A and 10B and 10C housing 12 and smart label 28A and 28B and 28C mating surfaces and the housing body 308A mating top surface 316 at the target areas 142, 144, and 146 is the flatness and thickness of the contemplated targeting, protective and esthetic material covering the RFID antenna 150 coil circuits. The RFID repeater system 300 can be configured to maximize the RFID magnetic field coupling by minimizing positioning errors when mating an RFID device 44 on the target areas such as targets 120, 142, 144 and 146 located on top surface 316 of housing body 308A. The RFID device 44 coupling with the external RFID repeater 100 can be improved by reducing or minimizing the vertical distance or separation (positioning error in the z plane) between the RFID antenna contained within the mated RFID devices and RFID antenna 130 and 150, for example by minimizing the distance between the RFID repeater antenna 130 and the external RFID reader 40 RFID antenna 400, and between the RFID repeater antenna 150 and the various pluggable transceiver 10 aperture 26 and RFID antenna 39, and between the RFID repeater antenna 150 and the various pluggable transceiver 10 and smart label 28 RFID antenna 1300. The housing body 308A can be configured to provide a level, uniformly flat and smooth planar top surface 316 at least in the first and second target areas such as 120, 142, 144 and 146 in the horizontal plane (e.g. x-y plane). The pluggable transceiver 10, smart label 28, and external RFID reader 40 housings can also be configured with a corresponding uniformly flat and smooth planar surface area to mate with the top mating surface 316 of the housing body 308A at target areas 120, 142, 144 and/or 146. The RFID device housing can be configured to be in contact with top mating surface 316 when placed in the appropriate target area and positioned on the housing body 308A. The top surface 316 can be a thin material formed to cover the substrate 110 in at least target areas 120, 140, 142, 144 and 146 wherein the material thickness can range in thickness from 0.1 mm to 0.2 mm, and preferably less than 100 um (0.1 mm), for example the material of the top surface 316 can be a thin sheet or film of semi-rigid PVC plastic. In an embodiment, the top surface 316 in at least target areas 120, 140, 142, 144 and 146 can be a coating such as polymeric film conformal coating on PCBA 110 or a painted or printed acrylic, urethane, silicone, latex or varnish coating on PCBA 110.

In the embodiments illustrated in FIGS. 8A, 8B, 8C, 8D, 8E and 8F, the housing body 308A base and sidewalls can be configured as a low-profile platform case that raises the EM substrate 67, the external RFID repeater 100 substrate 110 supporting RFID antenna 150 and traces 411b, and top surface 316 above an underlying structure or surface supporting housing body 308A such that no portion of the pluggable transceiver 10A or 10B or 10C housing 12 touches the underlying structure or surface and interfere with the mating of the pluggable transceiver 10A or 10B or 10C housing 12 footprint on surface material 316 in target areas 142, 144 and 146. The smart label 28 of the pluggable transceiver can also be positioned and aligned above the RFID antenna 150 to maximize the magnetic coupling. For example, features that can cause poor mating of the transceiver 10 with the top surface 316 of the housing body 308 include the enlarged portion of pluggable transceiver 10 housing 12 which provides a positive stop mechanism (which normally extends outside of a host system pluggable transceiver 10 port or cage when it is installed in an operating position and can be generally in the form of a faceplate or a bulkhead) and/or at least one connector protruding from the front of housing 12. The faceplate can be used to position, retain and extract the pluggable transceiver 10 from a host device. For example, the faceplate portion can be configured to provide a network interface such as a pair of fiber optic connector receptacles. For example, the faceplate portion can be configured with a handle or an ejector. For example, the base cover 308A and top surface 316 can be configured to elevate the body of a mated pluggable transceiver 10 housing 12 at least 5 mm above the structure supporting the base cover 308A.

For example, the maximum height of the enlarged faceplate portion of the pluggable transceiver 10 housing 12 protruding from the top or bottom mating portion of the housing 12 on top surface 316 can be in the range from 2 mm for an MSA SFP+ 10A to 3.4 mm for an MSA CFP2 10C. In the present embodiment, the housing body 308A sidewall and surface material 316 in the second target areas such as 142 or 144 or 146 can be configured to enable positioning and mating the enlarged faceplate positive stop portion of the pluggable transceiver 10 housing 12 such it rests on a flat surface touching a housing body 308A sidewall in the area corresponding to the second target area such as 142 or 144 or 146. For example, pluggable transceiver 10C can be placed in a resting position on the body 308A sidewall in target area 146 in similar fashion to installing pluggable transceiver 10C in its resting operating position inside a host system pluggable transceiver interface port or cage. Accordingly, the housing body 308A of the RFID repeater system can have a thickness that is greater than the enlarged faceplate portion of the pluggable transceiver 10 housing 12.

In the embodiments illustrated in FIGS. 8A, 8B, 8C, 8D, 8E and 8F, the dimensions of the housing body 308A and surface material 316 and target areas such as 120, 142, 144 and 146 can be configured to permit receiving the external RFID reader 40 and pluggable transceiver 10 housing 12 footprint in their resting operating position on said target areas. For example, the pluggable transceiver 10 housing 12 form factor embodiments 10A or 10B or 10C can be inserted or slid on the top surface 316 into target area 142 or 144 or 146 up to the faceplate portion and or positive stop mechanism and into their resting operating position, wherein the faceplate portion and or positive stop is configured to stop the pluggable transceiver 10A and 10B and 10C from sliding off of the target area 142 and 144 and 146. The maximum dimensions of the housing body 308A section 310A and 312A can each be sized to receive the largest RFID device footprint within their corresponding target areas for the intended RFID programming application. For example, the maximum dimensions of body 308A section 310A can be sized to receive the RFID device housing footprint having the largest dimension when installed in its resting operating position on its corresponding target area. For example, the largest RFID device housing footprint that body 308A section 310A can be configured to receive for an RFID programming application is an external RFID reader 40 in a smart phone housing having approximate dimensions of 140 mm deep×70 mm wide, consequently the maximum dimensions of the body 308A section 310A receiving the smart phone should be greater than 140 mm deep×70 mm wide. For example, the maximum dimensions of body 308A section 312A can be sized to receive the pluggable transceiver 10 housing 12 footprint with the largest dimensions when installed in its resting operating position on its corresponding target area. For example, the dimensions of largest pluggable transceiver 10 housing 12 footprint excluding the faceplate that body 308A section 312A can be configured to receive can be the pluggable transceiver 10C MSA CFP2 form factor and footprint having an approximate dimension of 91.5 mm deep×41.5 mm wide, consequently the dimensions of the body 308A section 312A and target 146 receiving the pluggable transceiver 10C in area 312A should be greater than 91.5 mm deep×41.5 mm wide. For example, the pluggable transceiver 10A MSA SFP+ housing 12 footprint has approximate dimensions of 47.5 mm deep×13.55 mm wide, consequently the dimensions of the target 142 receiving the pluggable transceiver 10A in area 312A should be greater than 47.5 mm deep×13.55 mm wide. For example, the pluggable transceiver 10B MSA QSFP housing 12 footprint has approximate dimensions of 52.4 mm deep×18.35 mm wide, consequently the dimensions of the target 142 receiving the pluggable transceiver 10A in area 312A should be greater than 52.4 mm deep×18.35 mm wide.

In the embodiments illustrated in FIGS. 8D, 8E and 8F, the substrate 110 and RFID antenna 150 can be configured to interface with each smart label 28A or 28B or 28C installed on each pluggable transceiver 10A, 10B, and 10C, wherein the pluggable transceiver 10A or 10B or 10C is placed in its resting mated operating position on the surface 316 in target 142 or 144 or 146 such that its smart label 28A or 28B or 28C is properly aligned with the RFID antenna 150 coil traces 152 as described herein. For example, the area defined by RFID antenna 150 coil traces 152 can be formed such that the area of the smart label 28A and 28B and 28C body is substantially larger than the area of the RFID antenna 150 coil, and wherein the body of the smart label 28A and 28B and 28C substantially overlaps the area of the RFID antenna 150 coil. For example, the size of the various smart label 28A and 28B and 28C body or housing embodiments can range from approximately 10 mm wide×24 mm deep to 39 mm wide×16 mm deep, and the thickness of the body can range from 0.2 mm to 0.38 mm. For example, a product label, or smart label 28 in this case, can generally be installed on a designated area of the pluggable transceiver 10 housing 12, for example a recessed area specified by an MSA specification. In another example, the RFID antenna 150 coil can be sized to interface with an MSA SFP+ pluggable transceiver 10A and smart label 28A, wherein the dimensions of the smart label 28A body installed on the SFP+ 10A is approximately 11.0 mm wide×24.0 mm deep, consequently the RFID antenna 150 coil can be sized to be approximately 10.0 mm wide×10.0 mm deep. In another example, the RFID antenna 150 coil can be configured to interface with said SFP+ 10A smart label 28A using substrate 110A and said RFID antenna 150 coil configuration can also be used to interface with the QSFP 10B smart label 28B and the CFP2 10C smart label 28C using substrate 110B and 110C respectively. In another example, the RFID antenna 150 coil can be configured to interface with SFP+ 10A smart label 28A using substrate 110A or with the QSFP 10B smart label 28B using substrate 110B or with the CFP2 10C smart label 28C using substrate 110C, for example the antenna configuration can be optimized for each smart label 28 embodiment and implemented on different PCBA 110.

The RFID antenna 150 coil configuration can be formed to interface with the smart label 28A and 28B and 28C embodiments on pluggable transceiver 10A and 10B and 10C embodiments, wherein the smart label 28A and 28B and 28C RFID antenna 70, 74 can be configured to be compatible with the RFID antenna 150 coil configuration. For example, the smart label 28A and 28B and 28C RFID antenna 70, 74 coil configurations, such as their size, circuit routing, inductance and capacitance and RF signal load, can be formed to be compatible for a plurality of smart label 28 embodiments described herein, and formed to interface with a specific RFID antenna 150 coil configuration as described herein. The smart label 28A and 28B and 28C RFID antenna 70 coil can be positioned at least partially overlapping the RFID antenna 150 coil, and preferably substantially overlapping the RFID antenna 150 coil, when installed on the pluggable transceiver 10A and 10B and 10C, and wherein the pluggable transceiver 10A or 10B or 10C is mated on target 142 or 144 or 146.

In the present embodiment, the RFID repeater system 300 and housing body 308A can be used to position, support, retain and program RFID devices within the read range and to maximize the RFID magnetic field coupling between the RFID devices and the external RFID repeater 100, for example by minimizing the RFID device positioning errors with respect to the RFID antennas 130 and 150 in the x-y and z planes. For example, the vertical read range (e.g. z plane) can be from touching to 3 mm, and the horizontal read range (x-y plane) can be from 0 to 1 mm offset from the center of the target area.

In another embodiment, the exterior bottom portion (e.g. underside) of the bottom surface of the housing 308A can be configured with a non-slip material or coating mounted. This material or coating can be provided on the surface of each corner or other areas of the bottom portion, for example rubber pads attached to the bottom surface of the housing body 308A, wherein the pads are configured to permit non-slip freestanding of the housing body 308A. In other embodiments, said housing body 308A can be configured to be mounted on a stand or pedestal, for example a stand in the form of a tri-pod or the like, wherein said stand is connected to the base of housing body 308A, and wherein housing body 308A is adapted to attach to said stand. In an embodiment, the housing body 308A base is configured with a mechanical fitting used to detachably connect to said stand. A sidewall or bottom wall of the housing body 308A can be configured with a mechanical screw-on, snap, joint, or connector fitting and used to attach to said stand or pedestal configured with a mating connector fitting. In an embodiment, the body 308A base fitting can have a mechanical, tilt, or swivel joint connection to the screw-on or snap on stand portion. The stand is configured to permit freestanding operation of the RFID repeater system 300 in said housing body 308A configured in a platform form factor. Alternatively, or additionally, the stand can be configured to be attachable to a supporting structure, such as a floor, table top, vehicle dashboard or floor, etc. using various fasteners.

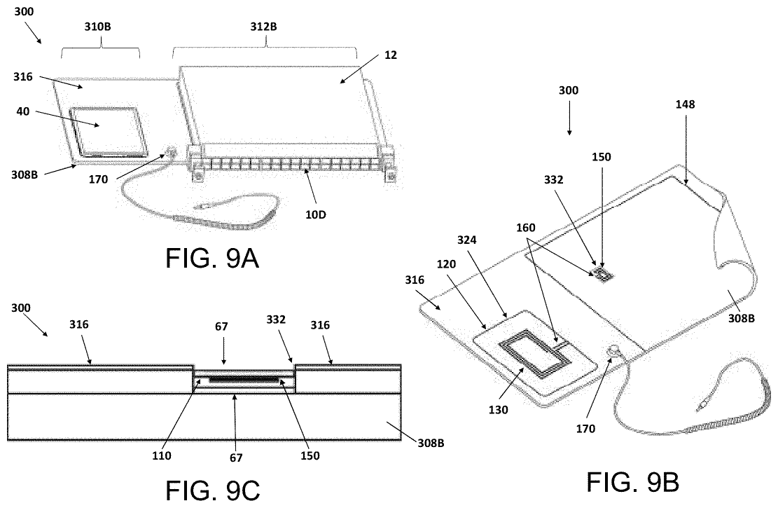

FIGS. 9A, 9B and 9C illustrate views of a RFID repeater system 300 having a flexible housing body 308B according to an example embodiment. The flexible body 308B houses the external RFID repeater 100 and its components. As illustrated, the housing body 308B has the form of a rollable mat in which a first housing portion 310B (ex: the left hand side) houses the first RFID antenna 130 and a second housing portion 312B (ex: the right hand side) houses the second RFID antenna 150, and the body 308B also housing the electrical circuit 160. The rollable housing body 308B can have a unitary body formed of at least one flexible material, or an assembly of flexible materials. The housing body 308B is formed with outer flexible walls that are configured to receive the external RFID repeater 100 components as described herein. For example, the housing body 308B is a sleeve resembling a very large mousepad preferably configured with a nonslip exterior bottom surface made of low density synthetic rubber material, such as silicone rubber or neoprene rubber or foam rubber, etc., or a plastic material such as polyester (PETE or PET), Polyvinyl Chloride (PVC), or Polytetrafluoroethylene (PTFE/Teflon), etc., and formed to receive the substrate 110, and EM substrate 67 as described herein.

As illustrated in FIGS. 9B and 9C, the external RFID repeater 100 circuits can be provided on a flexible substrate 110 bonded or laminated to inner surfaces of the housing body 308B. A bottom wall of the housing body 308 and external RFID repeater 100 can be at least partially covered with a flexible top cover surface 316 material as described herein. For example, top cover of the housing body 308 can be formed with plastic materials and/or high performance fabric materials such as polyester, polypropylene, leather, etc., or a conformal coating such as a polymeric film or a painted or printed acrylic, urethane, silicone, latex, or varnish coating materials, and bonded or laminated to at least the top surface of the external RFID repeater 100 substrate 110, and preferably also to the sidewalls of housing body 308B. The first RFID antenna 130 received within the first housing portion can be formed on a flexible substrate 110a, such as a flexible printed circuit. The second RFID antenna 150 received within the second housing portion can also be formed on a flexible substrate 110b, such as a second flexible printed circuit. The flexible substrate 110a and 110b can be discrete from one another and two antennas 130, 150 can further be connected by a flexible electrical path or circuit 160.

In another embodiment, the antennas may be formed on a single flexible substrate 110 and electrically interconnected 160 on said flexible substrate.

In the example embodiment illustrated in FIGS. 9A and 9B, the RF repeater system 300 having the rollable housing body 308B can be transported in its rolled state. In operation, the housing body 308B can be unrolled over a planar supporting or underlying surface, such as a table top, to expose an inner top surface 316. The top surface 316 can be demarcated with the first target area, such as area 120, at a position overlaying the first RFID antenna 130 and with at least one second target area, such as area 148, at a position overlaying the second RFID antenna 150. Placing the external RFID reader 40 on the top surface 316 within the first area 120 and the pluggable transceiver 10D on the top surface within the second area 148 causes the RFID reader 40 and the pluggable transceiver 10D to be in RFID communication via the external RFID repeater 100. The RFID repeater system 300 can be configured to interface and mate an external RFID reader 40 in a tablet form factor. In the present embodiment, at least target outline 148 can be printed the top surface 316 to indicate where to place the pluggable transceiver 10D during operation. The second area 148 can be configured to interface and mate with a pluggable transceiver 10D configured in a shielded plug-in circuit card housing 12 form factor, for example a network interface plug-in card (MC) in a shielded metal housing 12. In an embodiment, the second area 148 can be configured to interface with a pluggable transceiver 10D configured in a rackmount enclosure or chassis or shelf or housing form factor, for example an 10GE L2/L3 network packet switch can be configured in a 1U, 19 inch, rackmount “pizza box” enclosure. In an embodiment, the top surface 316, second target areas 142, 144, 146 and 148 and RFID antenna 150 can be configured to interface with a pluggable transceivers 10A, 10B and 10C for example configured in MSA SFP+, QSFP, and CFP2 form factors, and pluggable transceiver 10D configured in a shielded plug-in circuit card housing 12 form factor, and pluggable transceiver 10D configured in a shielded rackmount housing 12 form factor.

In another embodiment illustrated in FIGS. 9A, 9B and 9C, the RFID repeater system 300 can be configured in a rollable housing body 308B containing RFID repeater 100, wherein the RFID repeater system 300 body 308B can be configured as an Electro-Static Discharge (ESD) mat, for example a flexible synthetic rubber mat to control static electricity. For example, the ESD antistatic mat can have an anti-static top surface 316 material which is not conductive and is highly resistive to control the static charge and causing it to flow across the surface at a slow rate which neutralizes the ESD and wherein the top surface 316 can be non-conductive to prevent short circuits on the conductive electronic parts, devices and equipment placed thereon. The ESD antistatic mat can also have a static dissipative bottom surface material which enables any static charges that may appear on the top surface 316 of the ESD mat to be safely dissipated by providing a reliable path to ground, and wherein the housing body 308B material can be connected to a grounding point such as a metal table top surface or through a grounding strap or wire 170 to an earth grounding point during operation. In the present embodiment, the top surface layer 316 can be a 0.5 mm thick anti-static material such as rubber or vinyl materials that resist electrical charges, wherein the top surface layer can be bonded to at least the top surfaces of the conductive housing body 308B. In the present embodiment, the housing body 308B can be formed of one or more layers of dissipative conductive elastomer material such as synthetic rubber, wherein the base layer of housing body 308B can be formed to support and raise or elevate the external RFID repeater 100 substrate 110 and the pluggable transceiver 10D housing 12 placed thereon above the structure supporting housing body 308B, and wherein the housing body 308B can also be formed to support the top surface 316 anti-static layer materials. In the present embodiment, an EM substrate 67 is interposed between the housing body 308B dissipative layer base and the substrate 110, and wherein the EM substrate 67 can be configured to cover at least the entire bottom surface area of the substrate 110. In the present embodiment, an EM substrate 67 can be interposed between the top surface 316 layer and the substrate 110, wherein the EM substrate 67 is configured to cover at least the entire top surface area of the substrate 110, and wherein cut-out 332 can be formed in at least the EM substrate 67 and top surface 316 to expose RFID antenna 130 and 150 on substrate 110. For example, the ESD mat top surface 316 layer material is configured to provide anti-static properties defined as being at least 10E9 ohms and the housing body 308B base material is configured to provide dissipative properties defined as being less than 10E6 ohms, wherein the anti-static and dissipative material properties will vary based on the ESD mat applications, and the users static control and safety norms, regulations or standards.

In the present embodiment, the housing body 308B bottom wall and sidewalls are acts as a platform to raise the body of RFID devices 44 above the supporting structure or surface as descried herein. For example, the enlarged section of pluggable transceiver 10D housing 12 that normally extends outside of a host system include transceiver port or card cage or cabinet when it is installed in its operation position, such as the faceplate, and handles protruding from the front of housing 12 and the network interfaces, such as a pair of fiber optic connector receptacles, or pluggable transceiver 10A, 10B or 10C interface ports, or cages located on the faceplate of pluggable transceiver 10D housing 12. For example, in the present embodiment the height of housing body 308B can be configured to create a platform which raises the surface 316 at target area 148 by at least 5 mm above its supporting structure such that the faceplate on various pluggable transceiver 10D embodiments do not touch the underlying surface supporting the housing body 308B of RFID repeater system 300. The housing body 308B and surface material 316 target area 148 can be configured to enable positioning and mating the pluggable transceiver 10D housing 12 on the sidewall of the housing body 308B in the area corresponding to target 148 as described herein. For example, pluggable transceiver 10D housing 12 mating footprint can be placed in a resting operating position on the RFID repeater system 300 body 308B on section 312B within target area 148.

In the present embodiment, the dimensions of the housing body 308B sections 310B and 312B and surface material 316 and target areas 120 and 148 can be configured to receive the external RFID reader 40 and pluggable transceiver 10D housing embodiments in their resting positions on said target areas as described herein. For example, the pluggable transceiver 10D can be inserted or slid on surface material 316 into target area 148 up to the faceplate and/or positive stop mechanism and into its resting operating position, wherein the faceplate and or positive stop can be configured to stop the forward motion of the pluggable transceiver 10 from sliding off of the target area 148 as described herein. For example, the largest external RFID reader 40 footprint that housing body 308B section 310B can be configured to receive is a tablet form factor housing having approximate dimensions of 250 mm deep×180 mm wide, consequently the dimensions of the housing body 308B section 310B receiving the tablet 40 in target area 120 should be greater than 250 mm deep×180 mm wide. For example, the largest pluggable transceiver 10D housing 12 footprint, excluding the faceplate portion, can be configured to receive is the pluggable transceiver 10D plug-in circuit card or rackmount form factor and footprint having an approximate dimension of 450 mm deep×480 mm wide, consequently the dimensions of the housing body 308B section 312B receiving the pluggable transceiver 10D in target 146 should greater than 450 mm deep×480 mm wide. For example, in the present embodiment, the RFID repeater system 300 can be configured as an ESD mat wherein the overall dimensions housing body 308B can be approximately 500 mm deep×700 mm wide×5 mm high and can be configured to receive and support an external reader 40 in tablet form factor and at least the pluggable transceiver 10D form factor. In another embodiment, the RFID repeater system 300 can be configured as an ESD mat and can be configured to receive and support an external reader 40 in tablet form factor and pluggable transceiver 10D shielded circuit card and rackmount form factors and at least pluggable transceiver 10A and 10B and 10C form factors for example housed in MSA SFP+, QSFP, and CFP2 form factors.

In the present embodiment illustrated in FIGS. 9B and 9C, a cut-out 324 can be formed in the surface 316, and top EM substrate 67 to expose at least RFID antenna 130, wherein cut-out 324 can be sized to accommodate the largest external RFID reader 40 footprint represented by first target area 120. For example, cut-out 324 and first target area 120 are formed at the same location, whereby PCBA substrate 110 and RFID antenna 130 are exposed to support the external RFID reader 40 (ex: in tablet form) and to enable wireless and RFID communications to and from said external RFID reader 40. A cut-out 332 can be formed in top surface 316 exposing at least RFID antenna 150, wherein the cut-out 332 can be sized to interface with the smart label 28 embodiments installed on the pluggable transceiver 28D when it is mated in target area 148. In an embodiment, cut-outs 324 and 332 can be covered with a thin sheet or film or coating of RF transparent material that can provide practically lossless transmission through said dielectric material and can protect and insulate the RFID antenna 130 and 150 circuit traces 132 and 152 from damage and short circuits as described herein.

Where the housing body 308B provided as a rollable mat is unrolled for operation, the RFID reader device 40 received within the first target area 120 can be resting on the top surface 316. Resting refers to the RFID reader device 40 being supported by force of gravity without other forms of mechanical retention. Similarly, the pluggable transceiver or other programmable RFID device being received within one of second target areas 142, 144, and 146 is also resting on the top surface 316 under force of gravity.

Referring now to FIGS. 10A to 10H, therein illustrated is a series of schematic diagrams showing the RFID repeater system 300 according to another example embodiment. In this example embodiment illustrated in FIG. 10A, the RFID repeater system 300 has a housing body 308C configured in a portfolio case form factor. The first housing portion 310C of the housing body 308C corresponds to the back cover of the housing body 308C and the second housing portion 312C corresponds to a front cover of the housing body 308C.

Continuing with FIG. 10A, as is typical for a portfolio case, the back cover 310C can be adapted to support an electronic device. In various example embodiments, the back cover 310C can be configured to physically retain the RFID reader device. Accordingly, the back cover 310C can be adapted to support an external RFID reader 40, which may be a smart phone or tablet device. The back cover 310C can have upstanding sidewalls extending from a bottom or base wall of the back cover 310C to define a receiving space for interfacing with the external RFID reader 40. The upstanding sidewalls can be configured to provide a snap fit engagement with the external RFID reader 40. The case sidewalls provide a target area 120 placing the external RFID reader 40 in the back cover 310C, for example as illustrated in FIG. 10E, wherein target 120 provides a useful indicator for where to place the external RFID reader 40 during use. For example, the back cover 310C can be formed with one-piece case made of RF transparent materials, such as polycarbonate or ABS material that attaches to a smart phone 40 in snapping fashion together with the case to keep the smart phone 40 safely encased, and wherein the back cover snap-fit casing has cutouts on the side, top, bottom, and back for the connectors and controls, including the speaker openings and the camera lens/flash. For example, the back cover 310C can be formed with a two-piece clamshell snap on back case design with a hard shell exterior that retains and protects the smart phone 40. At least a portion of said back cover and or upstanding sidewalls can be formed of a dielectric material permitting RF signals to be transmitted and received by the mobile RFID programming device as described herein.

In the present embodiment, the first RFID antenna 130 is supported in the back cover 310C and can be configured to be in signal coupling with a RFID reader device 40 received within the back cover 310C. According to one example embodiment, and as illustrated in FIGS. 10B, 10C, 10D and 10E, the first RFID antenna 130 can be provided on a first discrete substrate 110a, such as a first PCBA 110a, and formed to be installed within the back cover 310C. The back cover 310C can further have a cut-out 324 that can be sized to match the size of the first discrete substrate 110a. As illustrated in FIG. 10A, the cut-out 324 may be formed in the bottom wall of a hard shell casing of the back cover 310C. It will be understood that the hard shell casing, which can be typically formed of a rigid plastic, can correspond to an inner layer of the back cover 310C and that the back cover 310C can further include at least one layer overlaying the bottom wall of the hard shell. At least one overlaying layer, typically the outer layer, is formed of an aesthetically and tactile pleasing material, such as leather or leather-like material, however other water and scratch resistant synthetic materials, such as polyester, vinyl (PVC) may be used. The cut-out 324 may be formed only in the bottom wall of the hard shell inner layer and the cut-out 324 can be further covered by the outer layer. Accordingly, the PCBA 110a of first RFID antenna 130 can be supported by the outer layer acting as a backing member to the antenna 130.

The first RFID antenna 150 can be supported in the second housing portion corresponding to the top or front cover 312C of the housing body 308C and can interface with the pluggable transceiver received within the second housing portion 312C. In the embodiment illustrated in FIGS. 10B, 10C, 10D and 10E, the second RFID antenna 150 can be provided on a second discrete substrate 110b, such as a second PCBA, and formed to be installed within the front cover 312C. The second RFID antenna 150 PCBA 110b can be supported on the front cover 312C of the housing body 308C. The front cover 312C can have an interior sleeve (typically used for retaining cash, credit cards, or the like) and the second RFID antenna 150 PCBA 110b can be retained within the sleeve. However, it will be understood that other methods for retaining the second RFID antenna 150 PCBA 110b are contemplated. In the embodiment illustrated in FIG. 10A, a cut-out 332 can be formed on an interior surface of the interior sleeve and the location of the cut-out 332 can be aligned with the position of the second RFID antenna 150 when appropriately retained within the second housing portion 312C. In the present embodiment, the size of the cut-out 332 corresponds to at least the dimensions (e.g. width and depth) of the entire pluggable transceiver 10 form factor footprint, including the faceplate portion. The cut-out 332 formed in the interior surface defines a recess sized to provide a target area 140 and a snug fit to the pluggable transceiver 10. The recess target 140 provides a useful indicator for where to place the pluggable transceiver 10 during use. An important consideration in the design and placement of the cut-out openings 324, 332, recesses and target area 140, and the contemplated RFID antenna 130, 150 and PCBA 110a, 110b positioning, and including the esthetic and protective covering materials, is too minimize the vertical distance or separation (positioning error in the z plane) with the RFID antennas of the mated RFID devices 44 as described herein, and to also minimize the horizontal distance or separation (positioning error in the x-y plane) of the RFID antennas of the mated RFID devices 44 as described herein.

It will be understood that other configurations of the portfolio case 308C are contemplated. For example, the second RFID antenna 150 PCBA 110b can be supported by the front cover 312C in other ways than being retained by the front cover sleeve. Furthermore, while the recess 332 providing a snug fit to the pluggable transceiver 10 is useful, in other embodiments, a planar top surface 316 having a target 140 similar to the one shown in FIG. 7A, and formed of a thin film or sheet of RF transparent plastic substrate, may be provided for supporting the pluggable transceiver 10 and marking the correct placement and positioning of the transceiver 10. The thin film or sheet also protects the RFID antenna 150 PCBA 110a conductors 411b from short circuit with the housing of an RFID device placed thereon, such as the metal housing 12 of the pluggable transceiver 10. In other embodiments, the front cover 312C can be configured with upstanding sidewalls and can be formed to provide a snap fit engagement with the pluggable transceiver 10. In another embodiment, the front cover 312C and PCBA 110b can be configured with a magnet and can provide a magnetic engagement with the pluggable transceiver 10 configured with a metal housing 12. In another embodiment, the front cover 312C can be configured with upstanding sidewalls and can provide a snap fit engagement with another RFID devices, such as another external RFID reader 40 or pluggable transceiver 10 form factor or footprint.

Continuing with FIGS. 10B to 10D, an electrical circuit 160 extends across the spine 348 of the portfolio case 308C to electrically connect the first and second RFID antennas 130 and 150 that are formed on respective discrete substrates 110a and 110b. In the illustrated example, the electrical circuit 160 can be in the form of an insulated wire pair or two conductor cable, but can also be a printed or etched or deposited circuit on a flexible plastic substrate. As illustrated in FIG. 10E, the electrical circuit 160 can be covered by a shielding member 340, or alternately it may be installed and routed in between an exterior flexible sidewall and an interior flexible sidewall forming the spine 348 of the portfolio case 308C. As illustrated, the shielding member 340 can be a layer covering the electrical circuit 160 and can be formed of the same material as the portfolio case 308C outer layer. In an embodiment, the electrical circuit 160 or the shielding member 340 can be configured with an electro-magnetic (EM) shielding material such as an aluminum or copper foil or braid to attenuate unintended electromagnetic emissions and/or interference.

It will be appreciated that the housing body 308C of the RFID signal repeater system 300 according to the embodiment illustrated in FIGS. 10A to 10H has a first housing portion 310C and a second housing portion 312C that are movable relative to one another. In this example embodiment, the first and second housing portions 310C, 312C are foldable relative to one another and have a relative pivotal movement. The relative movement is provided by the flexible spine portion 348 of the case that join the front cover and the back cover. The electrical circuit 160 extending across the spine 348 provides the flexible electrical connection. In operation, the housing body 308C will be in an open position, and both the front cover 312C and the back cover 310C will be supported on a planar underlying surface, such as a table top. At this time, the first housing portion 310C and the second housing portion 312C can be understood as being co-planar. The cover 310C can then be closed, and secured, to facilitate transportation, at which time the first housing portion 310C and the second housing portion 312C are no longer co-planar.

It will be appreciated that the housing body 308C of the RFID signal repeater system 300 according to the embodiment illustrated in FIGS. 10A to 10H has a first housing portion 310C and a second housing portion 312C that are coplanar and said operating configuration is similar to the planar RFID signal repeater 300 housing body 308A configuration shown in FIG. 7A. In another portfolio case 308C embodiment, the cut-out 332 in the second housing portion 312C of housing body 308C can be adapted to interface with another pluggable transceiver 10 form factor or different type of RFID device. For example the RFID antenna 150, substrate 110b and the cut-out 332 in the second portion 312C of housing body 308C can be configured with target 142 or 144 or 146 to receive pluggable transceiver 10A or 10B or 10C form factors similar to the embodiments shown in FIG. 8A, 8B or 8C. In another portfolio case 308C embodiment, the RFID antenna 150, substrate 110b and cut-out 332 in the second housing portion 312C of housing body 308C and RFID antenna 150 can be adapted to interface with a plurality of pluggable transceiver 10 form factors and RFID devices. For example the cut-out 332 in the second portion 312C of housing body 308C can be configured with targets 142 and 144 and 146 to receive a portion of the pluggable transceiver 10A and 10B and 10C form factor footprint shown in FIG. 7A. For example, said second portion 312C, the RFID antenna 150, substrate 110b and cut-out 332 and RFID antenna 150 of housing body 308C can be configured to interface with a plurality of pluggable transceivers 10 and RFID device form factors and footprints such as; a plurality of MSA SFP+, QSFP and CFP2 pluggable transceivers 10A, 10B and 10C, and a plurality of smart labels 28, and a plurality of RFID cards and tags, etc., embodiments using targets 142, 144, 146, etc., configured to receive said RFID devices.

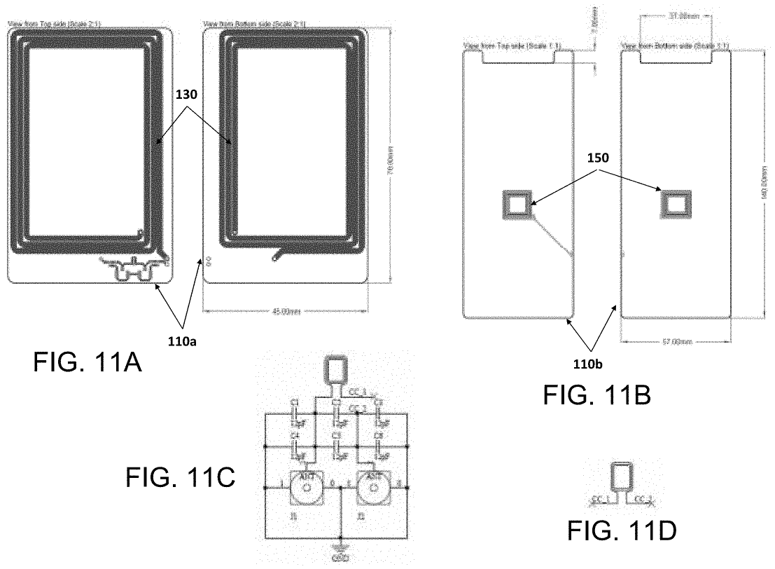

FIG. 11A illustrates plan views of a top side and of a bottom side of a substrate 110a having formed thereon the first antenna 130 for use with the RFID signal repeater system 300 having the housing body 308C illustrated in FIGS. 10A to 10H. It will be appreciated that the first RFID antenna 130 can be formed on a first discrete substrate 110a. The substrate 110 may be configured with components and terminals, for tuning and/or connecting RFID antenna 130 and 150 and electrical circuit 160. The tuning components and/or connecting components can be arranged in a circuit, as illustrated in FIG. 11C. In an embodiment, at least one bottom surface area or section of the RFID antenna 130 PCBA 110a can be covered with an electromagnetic shielding (EM) material, such as a ferrite sheet or film bonded to the surface of the PCBA, to improve RFID magnetic field coupling as described herein.

FIG. 11B illustrates plan views of a top side and of a bottom side of a PCBA substrate 110b of the second RFID antenna 150 of the external RFID repeater 100 for use with the RFID repeater system 300 having the housing body 308C illustrated in FIGS. 10B to 10H. It will be appreciated that the second RFID antenna 150 can be formed on a second discrete substrate 110b. In some embodiments, the second discrete substrate 110b may be configured with components and/or terminals arranged in a circuit for tuning and/or connecting RFID antenna 130 and 150 and electrical circuit 160. The tuning components and/or connecting components can be arranged in a circuit, as illustrated in FIG. 11D. In an embodiment, the bottom surface area of the RFID antenna 150 PCBA 110b is covered with an electromagnetic shielding material, such as a ferrite sheet bonded to the surface, to improve RFID magnetic field coupling as described herein.

In the present embodiment, a standard insulated electrical cable with two stranded copper wire conductors can be used to provide a flexible electrical circuit 160 of the external RFID repeater 100 between the first and second RFID antenna 130 and 150 PCBAs 110a and 110b.

FIGS. 11C and 11D are schematics of exemplary tuning circuits provided for use with substrates 110a and 110b for the first RFID antenna 130 and the second RFID antenna 150 respectively, wherein said circuits are used to form, tune and connect the RFID antennas 130 and 150 and electrical circuit 160, and to manufacture said RFID antenna PCBAs 110a and 110b.

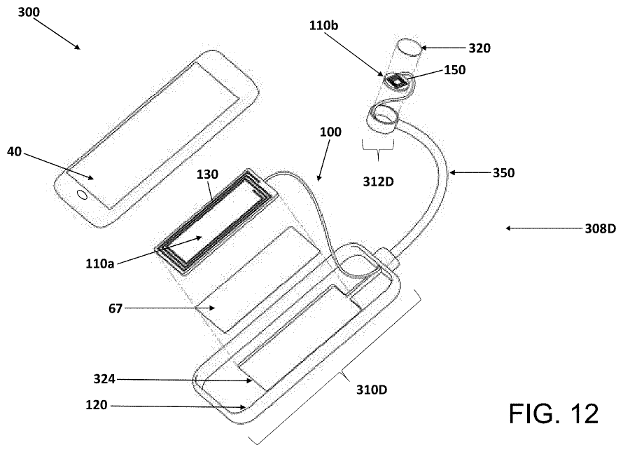

FIG. 12 illustrates an exploded view of a RFID repeater system 300 according to an example embodiment having a housing body 308D configured in a handheld scanner case form factor. The first housing portion 310D corresponds to a handheld cover section of the housing body 308D and the second housing portion 312D corresponds to the scanner (e.g. RFID antenna 150) portion of the housing body 308D. The first housing portion 310D and the second housing portion 312D are mechanically joined by a flexible wand member 350. The wand member 350 is hollow such that the electrical path/circuit 160 extends through the flexible wand member to connect the first antenna 130 housed in the first housing portion 310D with the second antenna 150 housed in the second housing portion 312D.

As is typical for a handheld case, the cover 310D can be configured to support an electronic device, and accordingly, the handheld cover 310D can be configured to support an external RFID reader 40, such as a smart phone or tablet mobile device. The handheld cover 310D can have upstanding sidewalls extending from a bottom wall of the handheld cover 310D to define a receiving space for interfacing with the external RFID reader 40. The upstanding sidewalls can be configured to provide a snap fit engagement with the external RFID reader 40. For example, a two-piece case made of polycarbonate or ABS plastic material that attaches to a smart phone in clamshell fashion and snapping together to keep the smart phone external RFID reader 40 safely encased. The case can have cutouts on the side, top, bottom, and handheld for all the connectors and controls, including the speaker openings and the camera lens/flash. For example, a one piece snap on handheld case design with a hard shell plastic exterior that retains and protects the smart phone external RFID reader 40 can be used. At least a portion of the handheld cover and upstanding sidewalls can be formed of a dielectric material permitting RF signals to be transmitted and received by the mobile RFID programming device 40 as described herein.

As illustrated in FIG. 12, the first RFID antenna 130 can be supported in the handheld cover 310D. In the present embodiment, the first RFID antenna 130 is configured as a planar coil provided on a first discrete substrate 110a, such as a first PCBA 110a. In the present embodiment, the handheld cover 310D can further have a cut-out 324 formed to receive the first discrete substrate 110a. As illustrated, the cut-out recess 324 may be formed in the bottom wall of the hard shell casing of the handheld cover 310D. It will be understood that the hard shell casing, which is typically formed of a rigid plastic, can correspond to an inner layer of the handheld cover 310D, and that the handheld cover 310D can further include at least one layer overlaying the bottom wall of the hard shell.

In an embodiment, the handheld cover 310D outer layer is formed of a tactile pleasing and preferably nonslip material, such as formed of a soft flexible plastic material or rigid textured plastic material. In another embodiment, the cut-out 324 can be a recess formed only in the bottom wall of the hard shell inner layer. The recess can be sized to receive the RFID antenna 130 PCBA, wherein the cut-out 324 is molded into the bottom wall and does not create an opening in the bottom wall of cover 310D, and wherein the bottom wall retains the substrate 110a in position within cover 310D.

In another embodiment, the cut-out 324 creates an opening in the bottom wall of cover 310D, wherein cover 310D can be covered with an outer layer, and wherein the outer layer retains the substrate 110a in position within cover 310D. Accordingly, the first RFID antenna 130 can be supported by the handheld cover base wall itself or by an outer layer acting as a backing member to the RFID antenna 130 PCBA 110a.

The case 310D can also be configured with a cut-out in a bottom wall or sidewall wherein the cut-out provides an aperture or conduit to pass and route the electrical circuit 160 from the exterior of case 310D to the interior of case 310D therethrough. The bottom wall of case 310D can be configured with an interior space or channel 324 to enable routing and connecting the electrical circuit 160 conductors to RFID antenna 130 or substrate 110a PCBA. The sidewall or base wall of case 310D can be configured to provide a mechanism to mate and fasten case 310D to the wand connector 350.

In an embodiment, an electromagnetic shielding material covers the bottom surface area of the substrate 110a supporting RFID antenna 130 wherein the EM material is in sheet or film form, such as a thin ferrite sheet, and bonded to said surface area, and wherein the EM material is configured to improve RFID antenna 130 magnetic field coupling with an external RFID reader 40 as described herein.

Continuing with FIG. 12, the second RFID antenna 150 can be supported in the second housing portion 312D corresponding to the scanner cover of housing body 308D. According to the illustrated example, RFID antenna 150 can be configured as a planar coil provided on a second discrete substrate 110b (e.g. PCBA 110b). In an embodiment, RFID antenna 150 can be configured as a surface mounted inductor coil device and attached to a second discrete substrate 110b (e.g. soldered or attached to a PCBA 110b). In an embodiment, the second RFID antenna 150 can be configured as an inductor or planar wire coil with terminal leads. The RFID antenna 150 substrate 110b can be configured to be connected to electrical circuit 160. For example, the RFID antenna coil 150 terminals on the PCBA 110b or coil 150 leads are connected to circuit 160 which is for example a pair of insulated stranded copper wires. As further illustrated, the second RFID antenna 150 PCBA 110b can be supported by the scanner cover case 312D of housing body 308D. In the present embodiment, the scanner cover case 312D can have upstanding sidewalls extending from a bottom wall of the case 312D formed to receive the RFID antenna 150 substrate 110b PCBA coil or inductor coil or planar coil. The case 312D base wall and upstanding sidewalls can be configured to support and retain the RFID antenna 150 substrate 110b PCBA within case 312D and formed to receive the protective top cover member 320. For example, in an embodiment, the case 312D base and sidewalls can be formed using a two-piece molded case made of polycarbonate material configured with an interior space to mount the PCBA 110b in clamshell fashion and snapping together to keep the substrate 110b safely encased with in the base and top cover 316. For example, in the present embodiment, the case 312D base and sidewalls is formed using a one-piece molded case made of polycarbonate material configured with an interior space to mount the PCBA 110b wherein the top cover member 320 is installed on or within the cover 312D sidewalls. In an embodiment, the case 312D can have a cut-out formed in the top cover member 320 to expose the RFID antenna 150.

The scanner case 312D can be configured with an opening in a sidewall or base wall wherein the opening provides an aperture or conduit to pass and route the electrical circuit 160 from the exterior of case 312D to the interior of case 312F therethrough. In the present embodiment, the base wall and sidewalls of case 312D can be configured with an interior space or channel to enable routing and connecting the electrical circuit 160 conductors to RFID antenna 150 or substrate 110b PCBA. In an embodiment, said case 312D sidewall or base wall and aperture can be configured to provide a mechanism to mate and fasten scanner cover case 312D to the wand connector 350. For example, the scanner cover case 312F can be fastened to the wand connector 350 using a mechanical fastener or a snap fit connector or welding glue or other means known in the art, and wherein said fastener does not interfere with routing electrical circuit 160 received from the wand connector 350 into said interior space within case 312F and connecting to RFID antenna 150 PCBA 110b.

In an embodiment, RFID antenna 150 can be configured with an inductor coil antenna positioned on substrate 110b to at least partially protrude from the top of case 312D, wherein the top cover member 320 is a flexible material and formed to cover said inductor coil antenna 150.

In another embodiment, RFID antenna 150 is configured with an inductor coil or a planar coil or a PCBA coil antenna and said coil antenna 150 is positioned within case 312D and not protruding from case 312D, wherein said RFID antenna 150 is not covered with surface material 316.

In yet another embodiment, RFID antenna 150 and/or substrate 110b is covered with a protective coating, such as a solder mask and or a conformal coating, for example the coating material is an insulating material formed to prevent short circuits and enable RF communications therethrough.

According to various example embodiments, at least a portion of the case 312D bottom wall and upstanding sidewalls and top cover member 320 can be formed of a dielectric material permitting RF signals to be transmitted and received by the RFID antenna 150.

The top cover member 320 of cover 312D is a useful indicator for where to position the cover 312D and, thereby the second antenna 150 to couple the antenna 150 with the antenna of a RFID device. For example, the top cover member 320 should be aligned with the pluggable transceiver 10 aperture 26 or smart label 28 or other RFID devices during operation. Accordingly, the second antenna 150 is in signal mating with a programmable RFID device, such as pluggable transceiver when supported or pressed against the aperture 26 or smart label of that device.

An important consideration in the design of the contemplated RFID antenna esthetic and protective covering material and the scanner cover 312D is to minimize the mated vertical and horizontal distance or separation (positioning error in the x, y and z planes) between the second antenna 150 housed in the cover 312D and the internal antenna of the RFID device (ex: pluggable transceiver).

In the present embodiment, the operator can use the housing body 308D to program RFID devices wherein the operator will hold the handheld cover portion 310D of the housing body 308D and use the wand 350 and scanner cover portion 312D of the housing body 308D to position the RFID antenna 150 proximate to the RFID device, such as a pluggable transceiver or smart label 28, to be programmed or read.

It will be understood that other configurations of the handheld case 308D are contemplated. For example, the length of the connector wand 350 can range from 1 to 20 cm. Furthermore, while the top cover member 320 can be planer to provide a flat planar physical interface to the pluggable transceiver 10 aperture 26 or smart label 28 embodiments is useful, in other embodiments, the scanner cover 312D can be configured in the form of a pointer, for example a pointer with domed or rounded point, to interface with the pluggable transceiver 10 aperture 26 and smart label 28 and other RFID devices 44. For example, such a pointer shaped scanner cover 312D can be used to house RFID antenna 150 inductor coil and facilitate manually placing or positioning the RFID antenna 150 in an optimal position on the various pluggable transceiver 10 and or smart label 28 or other RFID devices.

Continuing with FIG. 12, an electrical circuit 160 extends through the handheld case 308D to electrically connect the first and second RFID antennas 130 and 150 that are formed on respective discrete substrates 110a, 110b. In the illustrated example, the electrical circuit 160 is in the form of an insulated wires or cable, but can also be a printed or etched or deposited circuit on a flexible plastic substrate. In the present embodiment, the electrical circuit 160 can be supported and covered by a shielding member 350 sized to receive the electrical circuit 160 conductors therethrough. As illustrated in the, the shielding member or wand connector 350 can be formed from a rigid, semi-rigid or flexible material and formed to receive, cover and protect the electrical circuit 160. The wand connector 350 can be made of plastic and/or metal materials wherein circuit 160 may be routed and installed through connector 350 formed in the shape of an electrical conduit or tubing or armored cable shield or pipe or shaft. For example, in an embodiment, wand connector 350 is configured as a flexible adjustable electrical conduit capable of maintaining its positioning, for example a gooseneck conduit or tubing. In an embodiment, the electrical circuit 160 or the wand connector 350 can be configured with an electro-magnetic shielding material such as flexible aluminum or copper foil or braid or conduit to attenuate unintended electromagnetic emissions and/or interference. The electrical circuit 160 and wand connector 350 can provide a flexible and adjustable electrical connection between the RFID antennas 130 and 150 housed in each of the housing portions, for example such as to position the housing portions in different planes and not proximate to one another. In the present embodiment, the flexible electrical connection 160 and wand connector 350 can also permit the relative movement between the first housing portion 310D and the second housing portion 312D, wherein the flexible electrical circuit 160 can be routed through a flexible mechanical member in the form of an electrical conduit to permit the relative movement between the first housing portion 310D and the second housing portion 312D. The electrical circuit 160 can be provided in the form of insulated copper electrical wires, an electrical path drawn or etched or deposited on a flexible printed circuit assembly, or any other solution known in the art.

It will be appreciated that the housing body 308D of the RFID signal repeater system 300 according to the embodiment illustrated in FIG. 12 has a first housing portion 310D and a second housing portion 312D that are movable relative to one another. In an example embodiment, the first and second housing portions 310D, 312D are foldable relative to one another, and have at least one relative pivotal movement point, and permit folding at least 90 degrees, in any direction (e.g. 360 degrees). The relative movement is provided by the flexible wand 350 of the case 308D that joins the scanner cover 310D and the handheld cover 310D. In operation, the housing body 308D sections 310F and 312F can be in planar fully extended position, or alternately, formed in a plurality of positions and shapes, and wherein the wand connector 350 is configured to maintain its shape or form within a 3-dimensional space. In the present embodiment, the hand-held cover 310D can be supported within the palm of the operator's hand or on a planar underlying surface, such as a table top, and the scanner cover 312D will be supported by the wand connector 350 attached to the handheld case 310F. At this time, the first housing portion 310D and the second housing portion 312D can be understood as being co-planar when in a resting unfolded or extended position, and can be folded to facilitate transportation.

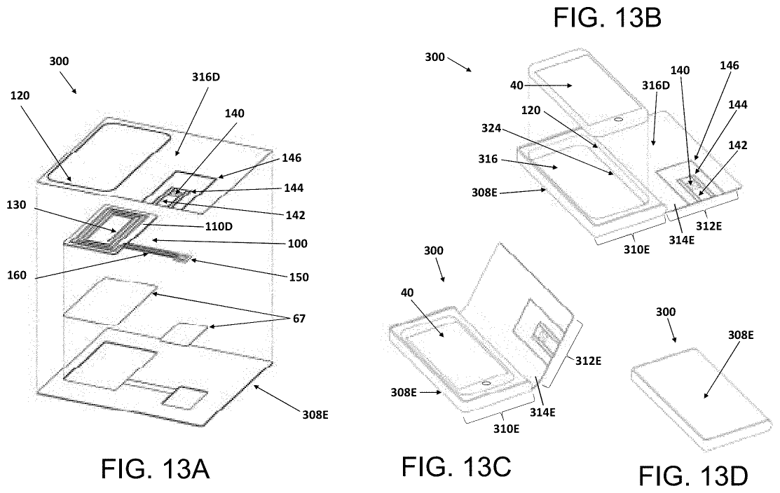

Referring now to FIGS. 13A, 13B, 13C and 13D therein illustrated is an embodiment of another RFID repeater system 300. In the present embodiment, the RFID repeater system 300 has a housing body 308E configured in a foldable case form factor housing the external RFID repeater 100. This foldable case form factor can be similar to the portfolio case embodiments illustrate in FIG. 10A to 10H. A first housing portion 310E (ex: the right hand side) houses the first RFID antenna 130 and a second housing portion 312E (ex: the left hand side) houses the second RFID antenna 150, and body 308E houses the electrical circuit 160 routed between sections 310E and 312E. The first and second housing portions 310E, 312E can be further joined by a central housing portion 314E.

In the embodiment illustrated in FIG. 13A, the foldable housing body 308E can be formed with one or more materials wherein the housing body 308E can be configured with a foldable base material, for example a base formed with a thin semi-rigid or flexible substrate and preferably assembled using one or more layers or sheets of plastic material such as polyester (PETE or PET), Polyvinyl Chloride (PVC), or Polytetrafluoroethylene (PTFE/Teflon), or other similar RF transparent dielectric flexible material.

The base layer material of 308E can be formed and/or assembled to provide an interior space configured to receive the external RFID repeater 100 circuits on a substrate 110, for example substrate 110 can be bonded or laminated within an interior space defined by the housing body 308E, as shown in FIG. 13A. In the present embodiment, the base 308E and external RFID repeater 100 substrate 110 can be at least partially covered with a top surface 316D formed at least partially of a flexible material. The top surface 316D can be used to provide RFID device positioning and protective and esthetic features. In an embodiment, the top surface 316D is made of a thin sheet or film or coating of flexible RF transparent dielectric material, as described herein. In an embodiment, the exterior bottom wall of body 308E can be configured with a nonslip surface material.

In an embodiment, the RFID antenna 130 and 150 circuits can be formed on a single flexible substrate 110 and electrically interconnected with circuit 160 also formed on said flexible substrate 110.

In another embodiment, the first RFID antenna 130 received within the first housing portion 310E can be formed on a flexible substrate 110a, and the second RFID antenna 150 received within the second housing portion 312E can be formed on a flexible substrate 110b, and wherein RFID antenna 130 and 150 are interconnected through a flexible electrical circuit 160. In another embodiment, the RFID antenna 130 and 150 may be formed on two discrete substrates 110a and 110b and interconnected by a flexible electrical circuit 160 such as a cable.

In an embodiment illustrated in FIG. 13B, the housing body 308E is unfolded during operation over a planar supporting surface to expose an inner top surface 316D and first and second targets such as 120, 140, 142, 144 and 146 provided on the top surface 316D. An external RFID reader 40 and pluggable transceivers 10A, 10B and 10C and other RFID deices can be positioned within the target areas as described herein. The top surface 316D can be demarcated with the first area 120 at a position overlaying the first RFID antenna 130 and with the second target areas such as 140, 142, 144 and 146 at a position overlaying the second RFID antenna 150. Placing the external RFID reader 40 on the top surface 316D within the first area 120 and the pluggable transceiver 10 on the top surface in alignment with the second area 140 causes the RFID reader 40 and the pluggable transceiver 10 to be in RFID communication via the external RFID repeater 100. The RFID repeater system 300 can be configured to interface and mate an external RFID reader 40 in a smart phone or tablet form factor. The second target areas 142 and 144 and 146 can be configured to interface with at least pluggable transceivers 10A and 10B and 10C according to embodiments as described herein.

As illustrated in FIGS. 13C and 13D, the RF repeater system 300 having the foldable housing body 308E can be transported in a folded state or position. In the present embodiment, a sidewall of the case 310E is formed to enable folding the body 308E around an arc and to maintain at least a minimum bend radius for the electrical circuit 160 and or flexible substrate 110 in a folded state, for example to prevent stressing the flex circuit assembly when folded which could lead to failure if not controlled. For example, the central portion 314E of the can be configured to allow folding of the first housing portion 310E relative to the second housing portion 312E while managing the stress on the flex circuit assembly.

In the example embodiment illustrated in FIGS. 13A, 13B, 13C, and 13D, the RFID repeater system 300 includes the flexible body 308E formed to house RFID repeater 100. First housing portion 310E can be formed with a rigid plastic electronics case as described herein, for example similar to the case embodiments described in FIG. 10.

The top surface layer 316D can be a thin protective RF transmissive material as described herein. In the present embodiment, the housing body 308E can be formed of one or more layers of RF transparent plastic material such as a sheet of 0.5 mm flexible vinyl material, and wherein the housing body 308E materials can be formed to support EM substrate 67, substrate 110 and top surface 316 as described herein. In the present embodiment, the housing body 308E case, base and sidewalls are configured as a foldable case form factor that encase the substrate 110 supporting RFID antenna 130 and 150 circuits and circuit 160, EM substrate 67, and surface 316 substrate above a supporting structure.

The first housing portion 310E of the housing body 308E corresponds to the bottom cover of the housing body 308E and the second housing portion 312E corresponds to a front cover of the housing body 308E. As illustrated in FIG. 13B, the bottom cover 310E can be adapted to support a mobile electronic device such as a smart phone or tablet 40. The bottom cover 310E case can be configured with interior upstanding sidewalls extending from the top surface 316 of the bottom cover 310E to define a receiving space 120 for interfacing with the external RFID reader 40. The upstanding sidewalls can be configured to provide a snap fit engagement with the external RFID reader 40. For example, a one-piece plastic case made of RF transparent materials as described herein can be used to provide this engagement. In the present embodiment, the back cover 310E casing can be formed with cutouts on the side, top, bottom, and back for the smart phone or tablet 40, connectors and controls, including the speaker openings and the camera lens/flash. At least a portion of said back cover and or upstanding sidewalls can be formed of a dielectric material permitting RF signals to be transmitted and received by the mobile RFID programming device 40 as described herein. The interior upstanding sidewall of bottom cover 310E of the body 308E can be formed to control the bend radius of the external RFID repeater 100 substrate 110, and the base 308E and top surface 316 when folded.

According to one example embodiment, at least one overlaying layer, typically the outer base surface layer or body 308A, can be formed of an aesthetically and tactile pleasing material, such as leather or leather-like material, however other thermal, water and scratch resistant synthetic materials may be used. As illustrated in FIG. 13B, a cut-out 324 can be formed in the bottom wall of the hard shell casing of bottom cover 310E to expose the top surface 316 and to minimize the mating distance as described herein.

In the present embodiment, the operator can use the body 308E as a platform to operate the RFID repeater system 300 such that, during operation, no portion of the housing 12 of a pluggable transceiver 10 touches the underlying surface or structure on which the RFID repeater system 300 is placed. Accordingly, reducing or eliminating this touching reduces interference with the mating of the antennas of the pluggable transceiver 10 with the second antenna 150 when the transceiver 10 is placed on the top surface 316D and positioned in target areas 140, 142, 144 or 146. The housing body 308E can be configured to receive an external RFID reader 40 in a tablet form factor with approximate dimensions of 250 mm deep×180 mm wide and 10 mm high, consequently the dimensions of the housing body 308E receiving the tablet in section 310E target 120 should be at least 250 mm deep×180 mm wide and 10 mm high. For example, the targets 142 and 144 and 146 can be configured to receive at least a portion of the pluggable transceiver 10A and 10B and 10C housing 12 mating footprint as described herein. For example, in the present embodiment, the dimensions of the RFID repeater system 300 housing body 308E in an unfolded state are approximately 300 mm deep×250 mm wide×10 mm high, wherein body 308E is configured to support an external reader 40 in tablet form factor and plurality of pluggable transceivers 10A and 10B and 10C configured in MSA SFP+, QSFP, and CFP2 form factors.

Continuing with FIGS. 13A and 13B, an electrical circuit 160 extends across the central portion 314E of the body 308E in the form of a foldable case to electrically connect the first and second RFID antennas 130 and 150 that are formed on substrate 110. For example the central portion 314E is a spine located between sections 310E and 312E. In the illustrated example, the electrical circuit 160 is in the form of a two conductor printed flex circuit on substrate 110.

It will be appreciated that the housing body 308E of the RFID signal repeater system 300 according to the embodiment illustrated in FIGS. 13A to 13D has a first housing portion 310E and a second housing portion 312E that are movable relative to one another. In this example embodiment, the first and second housing portions 310E, 312E are foldable relative to one another and have a relative pivotal movement. The relative movement is provided by the flexible central portion 314E of the case 308E that joins the top cover 312E and the bottom cover 310E. The electrical circuit 160 extending across the flexible central portion provides the flexible electrical connection. In operation, the housing body 308E will be in an open position shown in FIG. 13B, and both the top cover 312E and the bottom cover 310E will be supported on a planar surface. At this time, the first housing portion 310E and the second housing portion 312E can be understood as being co-planar. The cover 310E can then be closed, and secured, to facilitate transportation, at which time the first housing portion 310E and the second housing portion 312E are no longer co-planar as shown in FIG. 13D. It will be appreciated that the housing body 308E of the RFID signal repeater system 300 according to the embodiment illustrated in FIGS. 13A to 13D has a first housing portion 310E and a second housing portion 312E that are coplanar and said operating configuration is similar to the planar configuration of RFID signal repeater 300 having portfolio case housing body 308C configuration illustrated in FIGS. 10A to 10H.

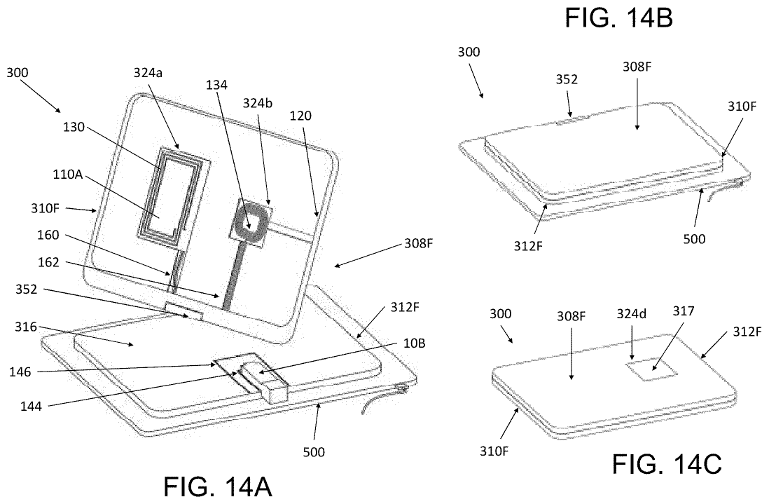

Referring now to FIGS. 14A, 14B and 14C, therein illustrated is the RFID signal repeater system 300 according to another example embodiment having a housing body 308F. In this example embodiment, the housing body 308F is also in the form of a case for an electronic device wherein a first housing section 310F corresponds to a top cover and a second housing section 312F corresponds to a base cover and wherein both sections 310F, 312F are interconnected with a joint member 352. Accordingly, the housing body 308F can be configured as a low profile clam shell case form factor. For example, the housing body 308F can resemble a laptop computer case, having a substantially rigid outer shell, wherein the housing body 308F can be configured as an assembly having two sections 310F and 312F interconnected with the hinge 352. As illustrated, the housing body 308F and sections 310F, 312F have a substantially rectangular prism shape housing the RFID repeater 100 within the housing portions 310F, 312F and the hinge 352. In the illustrated example, the first portion 310F of the housing body 308F can be a top cover section that houses the first RFID antenna 130 and can be formed to receive and interface with an external RFID reader 40 during operation. The second section 312F of the housing body 308F can be a base cover of the housing body 308F that houses the second RFID antenna 150 and can be formed to receive RFID devices, such as pluggable transceiver 12. The base section 312F can be configured to receive and interface with an RFID device that can have a variety of form factors and footprints as described herein (see e.g. FIGS. 8A, 8B and 8C). The base section 312F can be configured to receive and interface with a plurality of RFID device form factors and footprints as described herein (e.g. FIGS. 6 and 7A). For example, the base section 312F can be configured to receive and interface with any one of MSA SFP+, QSFP and CFP2 pluggable transceiver 10A, 10B and 10C footprints, and a plurality of smart label 28 footprints, and a plurality of RFID card and tag footprints on the top surface 316D. In the present embodiment, top surface 316F of the bottom section 312F can be configured with target areas 140, 142, 144, and 146 to indicate where the various RFID devices to be programmed or read are to be positioned during operation. It will be appreciated that in this present embodiment, wherein the housing body 308F is provided in two separate sections 310F and 312F, the envelope of each section 310F and 312F and body 308F in a closed position are in the form of rectangular or prism shapes, but that other body shapes can be formed. In the present embodiment, the first RFID antenna 130 and the second RFID antenna 150 may be provided on two separate substrates 110A and 110B which can each be a rigid, semi-rigid or flexible planar substrate as described herein.

In the present embodiment, the housing body 308F and its first and second sections 310F and 312F can each be a discrete body, such that the first housing section 310F and the second housing portion 312F are separately formed and wherein section 310F and 312F are interconnected with the joint member 352. The top cover 310F of housing body 308F can be configured to support electronic devices, such as the external RFID reader 40 smart phone or tablet, and the base cover 312F can be configured to support the pluggable transceivers 10, smart labels 28, RFID cards, etc., RFID devices as described herein. The first and second housing sections 310F and 312F can each be configured with upstanding sidewalls extending from a base wall to define at least one interior space for receiving the components of the RFID repeater system 300 assembly, and wherein the base wall and sidewalls can be configured to provide mechanical, electrical and RF interfaces and shielding for the electrical and electronic components housed therein, such as the external RFID reader 40, EM substrate 67, RFID antenna substrates 110A and 110B, and electrical circuit 160.

The housing sections 310F, 312F can be generally formed with molded plastic materials and assembled together to form a clam shell structure, wherein said clam shell body 308F is configured to house the external RFID repeater 100, and wherein the external RFID repeater 100 can be adapted to be installed and mounted within the interior spaces created by the sidewalls and base walls forming the housing body 308F as described herein. The first RFID antenna 130 and substrate 110A can be housing in the base wall of top cover 310F and the second RFID antenna 150 substrate 110B can be supported within the base wall of base cover 312F underneath the top surface 316. In the present example embodiment, the housing body 308F top and base covers 310F, 312F can be formed and configured to be electrically and mechanically connected using a tilt and swivel joint or hinge 352, to permit relative pivotal and tilting movement of the two housing portions 310F, 312F about at least two axes. In other embodiments, the top and base covers 310F, 312F are formed and configured electrically and mechanically connected using two tilting hinges 352, for example two hinges typically used in laptop computers to flexibly join the display and keyboard sections of the laptop case. In other embodiments, the top and base covers 310F, 312F can be formed and configured electrically and mechanically connected by one tilting hinge 352. In the present embodiment, the electrical circuit 160 is configured to extend through said hinge 352, or at least one of said hinges 352, according to various techniques known in the art. For example circuit 160 is implemented using flexible insulated wires or cable or printed circuit, etc., to pass the circuit 160 through a conduit formed within the joint member 352 and to connect to the substrates 110A, 110B and RFID antennas 130 and 150 of the RFID repeater 100 contained within sections 310F, 312F.

The RFID antenna 150 (e.g. hidden under surface 316) can be appropriately placed and oriented on an interior surface within base cover second section 312F so that a pluggable transceivers (10A, 10B or 10C) can be placed on the top surface 316 of the base cover second portion 312F to be in RFID communication with the second RFID antenna 150. In one embodiment, the top surface 316F of base cover 312F of the housing body 308F can be configured with one or more second target areas such as 140, 142, 144 and 146 to interface and mate with at least a portion of one or more RFID device form factors and footprints as described herein, for example the targets are configured to interface and mate with at least a portion of the pluggable transceiver (10A, 10B or 10C) form factor footprints. The RFID antenna 150 and substrate 110B positioned under the target areas can be appropriately formed, positioned and oriented on an interior surface within base cover section 312F so that a pluggable transceivers 10A or 10B or 10C can be placed on the top surface 316F of the base cover section 312F to be in RFID communication with the second RFID antenna 150 as described herein (see e.g. FIGS. 8A, 8B and 8C). More particularly, placement of the pluggable transceiver, or similar programmable RFID device, in alignment with the target area causes RFID signal mating between the pluggable transceiver and the second RFID antenna 150. The top surface 316 of the base cover section 312F can be configured with at least one second target areas such as 142 or 144 or 146 to interface and mate with the entire mating footprint of at least pluggable transceiver 10A or 10B or 10C as described herein (see e.g. FIGS. 8A, 8B and 8C). In another embodiment, at least one second target, such as target 140 can be formed on surface 316F to indicate the location of the RFID antenna 150 as described herein (e.g. FIG. 7A). In an embodiment, the top surface 316 of the body 308F base cover 312F configured with a second target area can be used to program a plurality of smart label 28 embodiments, for example using target 140 or 142. The top surface 316 of the base cover section 312F configured with a second target area can be used to program an external RFID reader 40 of different types, for example using target 140 or 146. In another embodiment, the top surface 316 of the base cover section 312F can be configured to read or program of an RFID card and tag of different types, for example using target 140 or 144.

The housing body 308F, top cover 310F, base cover 312F, RFID antennas 130 and 150 and substrate 110A and 110B, top surface 316, interior spaces, cut-outs 324a and 324b, openings and recesses, first and second target areas 120, 140, 142, 144 and 146 can be configured to enabling positioning, supporting and retaining the external RFID reader 40 and at least the pluggable transceiver 10A and 10B and 10C form factor footprints in an operating position and to minimize the mated vertical and horizontal distance or separation or error between the RFID antennas 130 and 150 and the RFID antenna of with the various mated RFID devices (ex: RFID reader 40 and pluggable transceiver 10) as described herein (see e.g. FIGS. 7 and 8).

In an embodiment, the bottom surface of the RFID antenna 130 PCBA 110A can be covered with an electromagnetic shielding material as described elsewhere herein. In an embodiment, the bottom surface the RFID antenna 150 PCBA 110B can be covered with an electromagnetic shielding material as described herein.

In the embodiment illustrated in FIGS. 14A and 14B, the housing body 308F and sections 310F, 312F and joint 352 of the RFID repeater system 300 are provided in a clam shell form factor and are movable relative to one another. When not operating, as illustrated in FIGS. 14B and 14C, the housing body 308F and sections 310F, 312F and hinge 352 of the RFID repeater system 300 are in a folded closed position. For example, the case 308F and joint 352 can be in a closed position wherein the top surface 316F on base cover section 312F and the external RFID reader 40 and target 120 on section 310F are positioned in parallel planes facing each other. The movement of sections 312F and 310F can include at least a pivotal movement in which the orientation of the top cover 310F can be pivoted with respect to the base cover 312F. For example, a portable RFID repeater system 300 and housing body 308F having a swivel hinge assembly 352 which allows the first housing section cover 310F and the first RFID antenna 130 to be tilted about a horizontal axis defined by the joint 352 from the second housing section base 312F to open the case of the portable housing body 308F for operation, and then cover 310F can be swiveled about a vertical axis away from the normal facing operating position. The swivel hinge assembly 352 is attached on a sidewall and base wall at the rear edge of cover 312F and 310F of the housing body 308F, wherein the cover 310F can both open and close and tilt and swivel above cover 312F in an example embodiment. The hinge assembly 352 can be configured to include stops which limit the amount of tilt and swivel and the angular position of the top cover 310F with respect to the base cover 312F. The cover 312F of the body 308F may be tilted backwards from a closed position to at least 120°, and in some embodiments swiveled at least 180° away from a straight-forward or facing or normal position. For example, a normal position wherein the plane of the top cover 310F and target 120 can be perpendicular to the plane of the base cover 312F and top surface 316, and generally in an open position where the top cover 310F and external RFID reader 40 user interface is facing a user or operator during operation. In an embodiment, the base cover 312F is configured with a counter-balance weight mounted to an interior sidewall or base wall within the base cover 312F of the housing 308F, wherein the counter-balance is configured to balance the top cover 310F when in an open position over the base cover 312F, and wherein the base cover 312F is firmly supported on a underlying surface such as a table or counter top, for example, so that the housing 308F does not tip over when the top cover 310F is tilted open at an angle ranging from of 100° to 180°. The counter-balance can weigh at least the weight of the external RFID reader 40 tablet or smart phone. In operation, the housing body 308F will be in an open position and in a range as described above, and at least the base cover 312F will be supported on the underlying surface, such as the table top. The top cover 310F can be closed, and secured, to facilitate transportation as shown in FIGS. 14 B and 14C, at which time the first housing section 310F and the second housing section 312E are facing each other.

The top cover 310F can be formed of substantially rigid materials and structurally constructed to provide support and physical protection for the external RFID reader 40 that is placed therein. For example, as described herein, a tablet 40 can be retained in the top cover 310F formed with a plastic snap fit retaining mechanism integrated in a reinforced hollow cover shell body. The base cover 312F can be formed in a rigid hollow shell body and configured to electrically and mechanically connect and support the hinge 352 and to structurally support the top cover 310F. For example, said rigid top and base covers 310F, 312F can be formed of RF transmissive materials as described herein (e.g. FIGS. 7 and 8), and assembled together with a hinge 352 to form a rigid body 308F having a low profile clam shell construction.

In the example embodiment illustrated in FIG. 14A, the housing body 308F provides a platform that raises the substrate 110A supporting RFID antenna 150, EM substrate 67, and surface 316F substrate above the underlying surface (ex: table top) supporting housing body 308F such that no portion of a pluggable transceiver 10A or 10B or 10C received on the surface 316F touches the underlying surface. This can serve to reduce interference with the mating of the pluggable transceiver 10A or 10B or 10C with secondary RFID antenna (e.g. FIGS. 7 and 8). For example, in the present embodiment the height of housing body 308F section 312F is configured to create a platform which raises the surface 316D at target areas 142, 144, and 146 by a minimum of 5 mm above its underlying surface.

In the present embodiment illustrated in FIGS. 14A, 14B and 14C, the dimensions of the sections 312F and 310F can be sized to receive, support and interface with the RFID devices of various types (see e.g. FIGS. 7, 8 and 13). For example, the body 308F can be configured to receive the external RFID reader 40 in a tablet form factor having approximate dimensions of 250 mm wide×180 mm deep and 10 mm high, consequently the dimensions of the housing body 308F receiving the tablet in section 310F can be greater than 250 mm wide×180 mm deep×10 mm high. For example, the section 310F can be configured to support a pluggable transceiver 10C having an MSA CFP2 form factor and footprint and having approximate dimensions of 91.5 mm deep×41.5 mm wide and 12.4 mm high, consequently the minimum depth and width of the top cover section 312F should be greater than 91.5 mm deep and 41.5 mm wide. For example, where the top cover section 310F is sized to receive the tablet 40, the base cover section 312F can be sized to receive the pluggable transceiver 10C, the envelope of body 308F can be greater than 250 mm wide×180 mm deep×20 mm high. For example, where the top cover section 310F is sized to receive a smart phone 40, the base cover section 312F can be sized to receive the pluggable transceiver 10C and should have dimensions greater than 150 mm wide×115 mm deep×15 mm high.

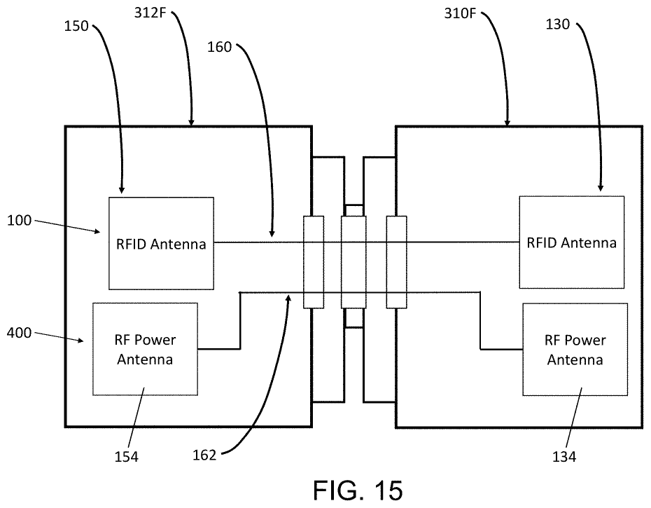

According to an alternative example the RFID signal repeater system 300 is configured to also provide a wireless charging to one or more RFID devices. FIG. 15 illustrates a schematic diagram of the principal components of a wireless charger repeater 400 (hereinafter “RF power repeater 400”) according to one example embodiment for use within the RFID signal repeater system 300. The wireless charger repeater 400 can be provided in the RFID signal repeater system 300 in combination with the RFID repeater 100.

Returning to FIGS. 14A, 14B and 14C, the RFID signal repeater system 300 illustrated therein includes the RF power repeater 400. The housing body 308F includes the first housing section 310F having the form of a top cover and a second housing section 312F having the form of a base cover and wherein both sections 310F, 312F are interconnected with a flexible joint 352 and wherein the RF power repeater 400 is embedded in the housing body 308F. During operation, the housing body 308F base section 312F of the RFID repeater system 300 can be positioned atop wireless charger device 500, such as a wireless charger station configured in mat form factor as known in the art. The wireless charger 500 can have a housing having a flat planar surface for receiving and supporting various types of mobile electronics. The wireless charger also provides an RF power interface and a power supply connector to connect to an external AC or DC power source as known in the art. In operation, the wireless charger 500 provides RF power through an RF power interface located on a top surface of the housing. As illustrated, a bottom wall of the base cover 312F can be configured with a corresponding RF power interface to receive RF power from the power interface of the wireless charger 500 when positioned atop the flat planar surface of the housing of the wireless charger 500. The external RFID reader 40 can also be configured with a wireless charging RF interface as known in the art, for example the external RFID reader 40 can be a tablet or smart phone can be configured with an integrated wireless charging RF power interface, wherein the external RFID reader 40 RF power interface can be configured to operate with the RF power interface of the charger 500. In another embodiment, the external RFID reader 40 tablet or smart phone can be adapted with an external wireless charging RF power interface, and wherein the external RF charging interface can be connected to the external RFID reader 40 power connector using a cable connector as known in the art.

In the embodiments illustrated in FIGS. 14A and 15, the first section 310F of the housing body 308F can be configured as a top cover that corresponds to the location of the first RFID antenna 130 and also a first RF power antenna 134, wherein top cover 310F can be configured to receive, support and interface with an external RFID reader 40 in target 120 during operation. The housing body 308F second section 312F can be configured as a base cover that corresponds to the location of the second RFID antenna 150 (e.g. hidden under surface 316) wherein the base cover 312F can be configured to receive, support and interface with at least one of RFID device 44 of different types on the top surface 316 during operation as described herein. Base cover section 312F also includes a second RF power antenna configured to interface with RF power interface of the wireless charger 500. The second power antenna is located to interface with the RF power interface of the wireless charger 500 via a bottom surface of the base cover section 312F. The second RF power antenna can be aligned with cut-out 324d as illustrated in FIG. 14C.

As illustrated in FIG. 14A, a cut-out recess 324b is formed on a bottom surface of the top cover section 310F and the first RF power antenna 134 is located in the top cover section 310F in alignment with the cut-out recess 324b.

As illustrated in FIG. 14C, a cut-out recess 324d is formed on a bottom surface of the base cover section 312F and the second RF power antenna is located in the bottom cover section 312F in alignment with cut-out recess 324d. A base surface member 317 can be provided to cover the second RF power antenna 154.

As illustrated in FIG. 15, the housing body 308F can be provided in two separate sections 310F, 312F and connected together using hinge 352, wherein external RFID repeater 100 and the RF power repeater 400 components are housed within these sections of the housing body 308F. The RF power repeater 400 can be configured with the first RF power antenna 134 and the second RF power antenna 154 provided on discrete substrates, wherein the substrates can be formed of rigid or semi-rigid or flexible materials, and wherein the first RF power antenna 134 and second RF power antenna 154 can be interconnected with an additional electrical circuit 162. The external RFID repeater 100 and the RF power repeater 400 can be provided using separate independent and isolated electrical circuits. Furthermore, the electrical circuits 160 and 162 can also be separate circuits.

Internal mechanical interfaces can be provided to mount and attach the hinge 352, EM substrate 67, RFID antennas 130 and 150, electrical circuit 160, and RF power antennas 134 and 154, electrical circuit 162, and base cover surface 317 covering the RF power antenna 154 and substrate 113b. As described hereinabove, cut-outs or recesses 324a and 324b can be formed in the interior bottom wall of top cover 310F to receive RFID antenna 130 and RF power antenna 132 and route electrical circuits 160, 162. As illustrated in FIG. 14C, recess opening 324d can be formed in the bottom wall of base cover 312F to receive the second RF power antenna 154 and to route electrical circuit 162. The base surface member 317 can be positioned to cover the cut-out 324d.

The housing body 308F top and base covers 310F, 312F and hinge 352 can be configured with apertures, openings, channels, conduits, etc. formed in a sidewall and or bottom wall to pass and route the electrical circuits 160 and 162 between said covers and via at least one hinge 352 and to interconnect the RFID antennas 130, 150 and the first and second RF power antennas 134, 154. The electrical circuits 160 and 162 can be configured to be routed through hinge 352 or two hinges 352, according to various techniques known in the art, wherein the circuits 160 and 162 can be configured to pass through a conduit formed within the hinge 352, and wherein electrical circuits 160, 162 can be configured to connect to the external RFID repeater 100 circuits and RF power repeater 400 circuits contained within sections 310F and 312F.

As illustrated in FIG. 14C, the second RFID antenna and its substrate can be positioned and oriented in a recess 324d on base cover 312F and covered with the base surface member 317, which may be an RF transparent material, to protect the second RF power antenna 154 from external hazards. The second RF power antenna 154 can configured as planar wire coil in the base cover 312F and can be positioned in a plane (e.g. x-y plane) facing the RF charging interface of the wireless charger. The RF charging interface is also positioned in the same plane (e.g. x-y plane) during operation as shown FIGS. 14A and 14B, wherein the magnetic axis of the second power antenna is in the z-plane (e.g. pointing into the mat 500 RF interface), and wherein the magnetic axis of RF power interface of the charger mat 500 is in the z-plane (e.g. pointing into the RF interface of the base section 312F). In the present embodiment, the RF power repeater 400 is said to be in RF power communication with the RF charger mat 500 when the RF power antenna 154 located in the base cover 312F surface 317 is positioned in alignment and facing the RF interface of the charger mat 500 during operation.

As illustrated in FIG. 14A, the first RFID antenna 134 and its substrate can be appropriately positioned and oriented in recess 324b within top cover 310F. In an embodiment, first RF power antenna 134 can be covered with an RF transparent material to protect the first RF power antenna 134 from external hazards. The first RF power antenna 134 can be configured as a planar wire coil and is positioned to face RF charging interface of the external RFID reader 40 positioned within target 120 defined on the surface of top cover 310F. The RF power repeater 400 can be said to be in RF power communication with the external RFID reader 40 when the latter is placed on target area 120 during operation. The external RFID reader 40 can be said to be in RF power communication with the wireless charger 500 when the second RF power antenna 154 of the RFID repeater system 300 located under surface member 317 on base cover 312F is positioned to be resting or sitting above RF power interface of the wireless charger 500 during operation. The top cover 310F and hinge 352 can be placed in any position relative to base cover 312F during a charging operation. For example, the top cover 310F can be placed in a range from fully open to fully closed or from facing an operator to facing away from an operator during operation.

An important consideration in the design of the RF power antennas 134, 154, the locations of cut-outs 324b and 324d, and structural materials and protective surface materials is the maximizing of the RF coupling, wherein the mated vertical and horizontal distance or separation or error between the RF power antennas 134, 154 and RF power interfaces should be minimized, and wherein the first and second RF power antenna 134, 154 of the RF power repeater 400 are shielded from metal surfaces during operation.

It will be appreciated that the first RF power antenna 134 and the second RF power antenna 154 can be formed on or supported by respective discrete substrates that are interconnected by the flexible electrical circuit 162. In an embodiment, the substrate supporting the RF power antenna 134 can include an electromagnetic shielding material, such as a ferrite sheet attached to the back of RF power antenna 134, to improve magnetic field coupling as described herein. The substrate supporting the second RF power antenna 154 can also include electromagnetic shielding material, such as a ferrite sheet attached to the back of RF power antenna 154. For example, the EM substrate on the back of second RF power antenna 154 is facing top surface 316F and the front of second RF power antenna 154 is facing back surface member 317 and the RF power interface of the wireless charger 500.

In the embodiments illustrated in FIG. 14 and FIG. 15, the RF power repeater 400 can be configured for repeating an RF power signal between the RF charger device 500 RF power interface and the external RFID reader 40 RF power interface, for example providing similar RF repeating functions and operation to the external RFID repeater 100 described in FIG. 6. It should be noted that the coils of the RF power repeater 400 RF power antennas and wire conductors of the electrical circuit 162 can be sized to receive and transmit the higher current levels received from the charger mat 500 RF power interface (e.g. relative to RFID signal levels) and used to power the external RFID reader 40. The RF power repeater 400 operates independently to external RFID repeater 100. The RF power repeater 400 can be configured to concentrate and couple magnetic fields and passively relay RF power signals between an external RFID reader 40 RF power interface and the RF charging device 500 power interface.

The RF power repeater 400 shown in FIG. 15 includes a first or primary RF power antenna 134 that can be configured as a field-concentrating RF repeater antenna planar coil, such as an insulated copper wire coil. The first RF power antenna 134 can be configured to interface with an external RFID reader such as a tablet or smart phone configured with an RF power interface. The RF power repeater 400 also includes a second or secondary RF power antenna 154, which can also be a field concentrating repeater RF antenna planar coil, such as an insulated copper wire coil. The second RF power antenna 154 can be configured to interface with the charger mat 500 RF power interface. The RF power repeater 400 further includes the electrical circuit 162 that provides an electrical connection between the first RF power antenna 164 and the second RF power antenna 154. This electrical circuit 162 enables power communication between the first RF power antenna 134 and the second RF power antenna 154 therethrough. More particularly, RF power signals captured at one of the first and second RF power antennas 134, 154 is passively transmitted over the electrical circuit 162 and repeated at the other of the first and second RF power antennas 134, 154. Accordingly, the external RF power repeater 400 enables RF power communication between an external RFID reader 40 and the charger mat 500 therethrough. One or both RF power antenna 134, 154 can be configured with resonant frequency tuning components, such as one or more capacitors arranged in a tuning circuit and connected to RF power antenna 134, 154 and electrical circuit 162 and may be support by or connected to substrates on which the RF power antennas 134, 154 are formed. In some embodiments, one or both RF power antenna 134, 154 and/or substrates can also configured with connectors or terminals to interconnect RF power antenna 134, 154, and electrical circuit 162, and in some embodiments the tuning components.

In other embodiments, the RF power repeater 400 can be used within an RFID repeater system provided in different form factors and structural configurations to provide ease of use to an operator or to a machine when configuring a variety of pluggable transceiver 10 form factors and footprints and other RFID devices using an external RFID reader 40.

In other embodiments, the RF power repeater 400 RF having power antennas 134 and 154 and the external RFID repeater 100 having RFID antennas 130 and 150 can be both formed on the same substrate, and wherein an EM substrate can be attached to the back of the substrate. In other embodiments, the RF power repeater 400 RF power antenna 134 and external RFID repeater 100 RFID antenna 130 can be both formed on the same first substrate, and wherein an EM substrate is attached to the back of the substrate, and the RF power repeater 400 RF power antenna 154 and external RFID repeater 100 RFID antenna 150 can be both formed on the same second substrate, and wherein an EM substrate can be attached to the back of the second substrate.

The RF power antenna 134 coil can be sized to interface with an external RFID reader 40 RF power interface, for example RFID antenna 134 is sized to interface with a tablet 40 or smart phone 40, for example the dimensions of the tablet are approximately 250 mm wide×180 mm deep×20 mm high and the RF power antenna 132 dimensions including its substrate are approximately at least 40 mm deep×40 mm wide×1.2 mm high. In the present embodiment, RF power antenna 154 coil is sized to interface with the RF charger mat 500 RF interface, for example the dimensions of the RF power antenna 154 including its substrate are approximately at least 40 mm deep×40 mm wide×1.2 mm high.

The RFID antenna 130 and RF power antenna 134 can positioned within the top cover 310F to interface with an external RFID reader 40 wherein the two said antenna 130 and 134, together with their substrate(s), can be positioned side by side and not overlapping each other. In the present embodiment, RFID antenna 150 and RF power antenna 154 can be positioned within the base cover 312F to interface with pluggable transceivers 10 and an RF charging mat 500, wherein the two said antenna 150 and 152 together with their substrate(s) and EM substrates 67 are positioned facing in opposite directions, for example the antenna may be positioned wherein RF power antenna 154 and base surface 317 are positioned facing the mat 500 and RFID antenna 150 can be positioned facing the top surface 316 supporting pluggable transceiver 10, and wherein at least one EM substrate 67 is interposed between RFID antenna 150 and RF power antenna 154 and they may overlap each other within the base cover 312F.

According to the illustrated example, RFID repeater system 300 includes the housing body 308F, the RF charger 500, the external RFID repeater 100 and the RF power repeater 400, wherein the RF power repeater 400 and RF power interfaces are configured for near-field resonant magnetic or inductive charging. For example, said charging method can also be called wireless charging or cordless charging, etc. and operated based on the principle of generating an alternating electromagnetic field to transfer energy between two preferably planar coils, wherein the transmitter coil and the receiver coil can be contained within two separate electronic devices, wherein resonant induction can be used to transmit energy in a magnetic field from a charger device and coupled to charging device that is configured to receive said magnetic field and energy, and wherein said received energy can be used to charge batteries or operate the charging device such as a smart phone or tablet 40. For example, said wireless charging technology can be used to enable smart phone 40 and tablet 40 wireless charging as known in the art. For example, the Qi standard has been developed by the Wireless Power Consortium and is applicable for electrical power transfer over distances of up to 40 mm, and for example other proprietary and standard specifications are currently being proposed for wireless power transfer between electronic devices. The resonant frequency and associated tuning of the RF power repeater 400 can be configured for a specific charger mat 500 operating frequency and RF power interface, for example the frequency used for Qi chargers is located in a range between about 110 and 205 kHz for the low power Qi chargers up to 5 watts and in the range of 80-300 kHz for the medium power Qi chargers, and wherein the external RFID reader 40 RF power interface can be configured for a specific mat operating frequency and RF power interface. The RFID repeater system 300, RF charger 500, external RFID reader 40, pluggable transceivers 10 and smart labels 28, external RFID reader 100 and an RF power repeater 400 can be configured to operate using at least two different RF frequencies wherein a first RF frequency such as 13.56 MHz can be used for data communications and programming RFID devices, such as a pluggable transceiver 10, and a second RF frequency such as 140 KHz can be used for RF power distribution and inductive charging of the external RFID reader 40. The RF power repeater 400 RF power antenna 134 and 154 can be configured using resonant frequency tuning components or structures to enable RF power signals to be coupled and transmitted therethrough, as described herein.

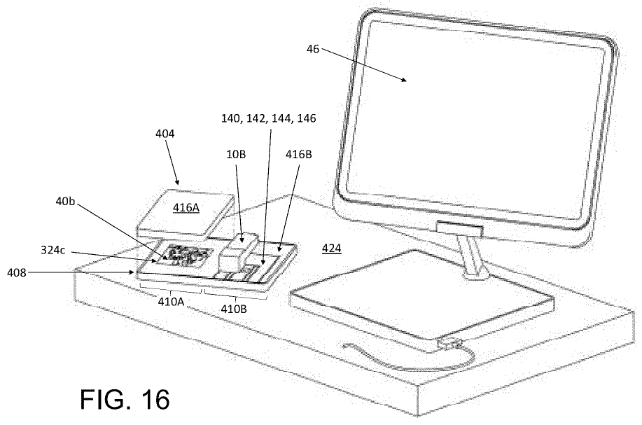

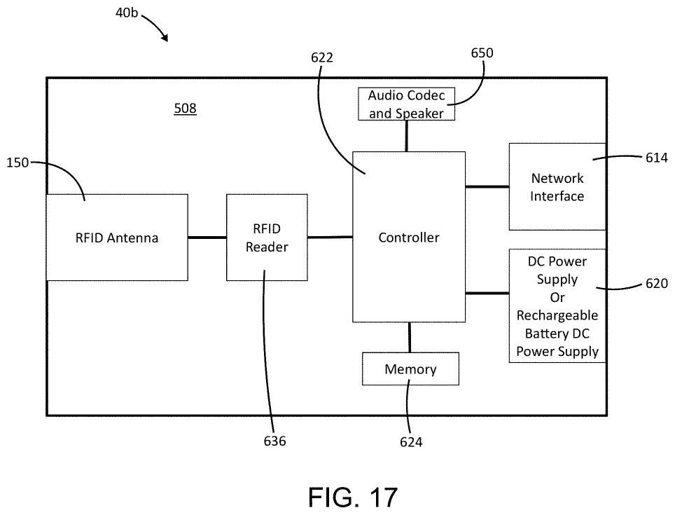

FIG. 16 illustrates an isometric view of a RFID programming system 404 configured as remotely controllable RFID programming system and in operation according to an example embodiment. FIG. 17 illustrates a schematic diagram of the components of the RFID programming system 404 enabling the remote control. Accordingly, the RFID programming system 404 includes a housing body 408 which houses components of the RFID programming system 404. In particular, an integrated RFID reader 40b is housed within the housing body 408. For example, the remote RFID programmer body 308Gb can be formed in an electronics case form factor to house the integrated RFID reader 40b. The integrated RFID reader 40b is operable to communicate wireless with an external computing device 46.

The external computing device 46 can be remotely located of the housing body 408 and does not need to be physically connected to the RFID programming system 404 to communicated with the integrated RFID reader 40b. In the example illustrated in FIG. 16, the housing body 408 of the RFID programming system 404 has a slate form factor that is similar to the housing body of the RFID repeater system illustrated in FIGS. 7A to 8F, except that the RFID reader 40b is also housed in the housing body 408. The RFID reader 40b can have similar programming functionality as the external RFID reader 40, namely to program another RFID device, such as the pluggable transceiver 10 and/or smart label 28. As illustrated in FIG. 16, the housing body 408 can have a substantially rectangular prism shape with a first flat top surface portion 416A and a second top surface portion 416B. It will be understood that other form factors the housing body 408 are also contemplated.

The circuit and/or electronic components of the RFID programming system 400 can be formed and supported on a substrate 508, which may be housed within sidewalls and bottom wall of the housing body 408 and further covered by top surfaces 416A and 416B. In the illustrated example, the top surface portion 416A is positioned to protect the integrated RFID reader 40b and a portion of the substrate 508.

FIG. 17 illustrates a schematic of the circuit and/or components of the RFID programming system 400 according to an example embodiment. In the present embodiment, the components include the integrated RFID reader 40b and the RFID antenna 150, wherein the integrated RFID reader 40b can be configured to program RFID devices of different types, such as pluggable transceivers 10, with configuration data. In the present embodiment, the integrated RFID reader 40b and RFID antenna 150 can be formed on a single substrate 508, such as a PCBA housed inside the body 408.

In the present embodiment illustrated in FIG. 16, a first portion 410A of the body 408 is the left portion that corresponds to the general location of the integrated RFID reader 40b integrated circuits, passive components, and network and power interface connectors. The second portion 410B of the body 408 is the right portion that corresponds to the location of the RFID antenna 150, wherein a plurality of targets can be configured on the second top surface portion 416B, similar to one or more target areas. A plurality of target areas 140, 142, 144 and 146 can be defined together on the top surface portion 416B, similar to the embodiment shown and described herein with reference to FIG. 7A. Alternatively, a single target area (which may be one of different sizes 142,144,146) can be defined, similar to the embodiment shown and described herein with reference to FIG. 7C for use with pluggable transceivers 10A, 10B, 10C, smart labels 28 of different sizes, and/or RFID cards or tags.

At least the top surface 416B can be configured to permit RFID signal communications between a RFID device received thereon (ex: pluggable transceiver 10) and the RFID antenna 150.

The housing body 408 can be formed of a unitary body such that the first housing portion 410A and the second housing portion 410B are integrally formed. In this form factor, the first top surface 416A and the second top surface 416B are co-planar and maintain a fixed position relative to each other. The housing body 408 can also be rigid. The housing body 408 can be a one-piece electronics casing made of polycarbonate material that supports the substrate 508 to keep it securely encased, At least a portion of the housing body 408, top surfaces 416A and 416B and substrate 508 can be formed of a dielectric, or substantially dielectric, materials permitting RF signals to be transmitted and received by the integrated RFID reader 40b and to RFID signals emitted by the RFID antenna 150.

In the present embodiment, the housing body 408 of the RFID programming system 404 can be configured as a platform wherein the housing body 408 raise the substrates 508 supporting RFID antenna 150 and top surface 416A, 416B above an underlying and supporting surface 424 such that no portion of a mated pluggable transceiver 10 touches the underlying surface 424 and interfere with its mating as described herein. For example, the housing body 408, as shown in FIG. 16, is operable to raise the body of an MSA QSFP pluggable transceiver 10B housing at least 5 mm above the table top surface. In the present embodiment, sidewalls of the housing body 408 can be formed such that the pluggable transceiver 10 housing embodiments 10A, 10B, 10C can be inserted or slid on top surface 416B into target area 140, 142, 144 or 146.

In the present embodiment, the RFID antenna 150 can be appropriately configured, placed and oriented within housing body 408 so that at least one pluggable transceiver 10 form factor, for example MSA QSFP pluggable transceiver 10B, can be placed on the top surface portion 416B in a second target area such as target 144, to be in RFID communication with the RFID antenna 150 as described herein.

It will be appreciated that the integrated circuit embedding integrated RFID reader 40b and the RFID antenna 150 can be formed on respective discrete substrates, for example PCBAs, that are interconnected by a flexible electrical circuit. In an embodiment, at least a portion of the bottom surface of directly underneath and supporting the RFID antenna 150 is covered with an electromagnetic shielding material 67, such as a ferrite sheet bonded to the surface, to improve RFID magnetic field coupling as described herein.

The dimensions of the housing body 408, top surfaces 416A, 416B and target areas 140, 142, 144 and 146 can be sized to house the integrated RFID reader 40b and support RFID devices of different shapes and sizes. For example, the size of the housing body 408 can be approximately 92 mm deep×90 mm wide to support programming MSA SFP+, QSFP and CFP2 pluggable transceiver 10A, 10B and 10C form factors. For example, the size of the housing body 408 can be approximately 140 mm deep×120 mm wide to support programming an external RFID reader 40 in a smart phone form factor.

Referring to FIG. 17, the integrated RFID reader 40b includes at least one communications module, in the form of network interface 614, connected to a controller 622. The network interface 614 can include an antenna to wirelessly connect to an external device, such as a preferably a Bluetooth network or a Wi-Fi network, to receive and transmit pluggable transceiver 10 configuration data and other data and commands used to program a pluggable transceiver 10 and other RFID devices as described herein. Alternatively, or additionally, a network interface 614 can include a wired connector for making a wired connection, such as an RJ45 style connector to detachably connect to an Ethernet cable network, such as a 10/100/1000Base-T Ethernet cable network, to receive and transmit pluggable transceiver 10 configuration data and other data and commands used to program a pluggable transceiver 10, or like programmable RFID device. In another embodiment, a network interface 614 can be configured with a connector mounted on the substrate 508, such as an USB or microUSB style connector, to detachably connect to an USB cable network, to receive and transmit pluggable transceiver 10 configuration data and other data and commands used to program a pluggable transceiver 10 and other RFID devices as described herein. For example, said USB port can be used to connect to a barcode scanner device. In an embodiment, the integrated RFID reader 40b can be configured to provide a management interface where the management interface can be provide using an Ethernet, and IP, communications interface, wherein said interfaces can be used to remotely configure and manage the operation of the integrated RFID reader 40b through a network.

In the present embodiment, the integrated RFID reader 40b can be configured to receive and transmit said pluggable transceiver 10 programming and configuration data and command instruction data, etc., from an external RFID reader 40, such as a tablet or smart phone, via the network interface 614. In another embodiment, the integrated RFID reader 40b can be configured to receive and transmit said data from a database and or web server connected to a network. In another embodiment, the integrated RFID reader 40b can be configured to receive and transmit said data from an automated RFID programming controller device or machine or system connected to said network.

The circuit components of the RFID programming system 404 can further include with a power supply 620, which may be a DC power supply or a rechargeable battery, for providing DC power and operate the components of the RFID programming system. The power supply 620 can include a power connector, such as a USB or microUSB power connector. In an embodiment, during normal operation, the power supply 620 can be connected to a DC power source using a power cable. In an embodiment, the rechargeable battery 620 can provide power without being connected to a DC power source. In another embodiment, power supply 620 can include a wireless charging RF interface to receive power wirelessly.

Continuing with FIG. 17, the integrated RFID reader 40b includes a controller 622, for example a microcontroller, microprocessor, etc., being configured to interface with at least one network interface 614 and the memory 624. The controller 622 can be configured to operate the integrated RFID reader 40b and the memory 624 can be configured to store the controller 622 programs and data. The memory 624 can also be configured to store programming data, configuration data and command instruction data for programming the pluggable transceiver 10. The controller 622 can execute a program to operate the integrated RFID reader 40b, for example a program that programs, configures, and/or manages the integrated RFID reader 40b ICs, functions and interfaces. The controller 622 can execute a plurality of programs such as, for example, an initialization or boot program, operating system program, application program, etc. to operate the integrated RFID reader 40b. Preferably, the memory 624 can be non-volatile, for example an electronically erasable programmable read-only memory (EEPROM). By means of non-limiting examples, the memory 624 can be configured to store a plurality of programs and or data; for example, controller initialization/boot, operating system, application programs and programmable logic device programs, and pluggable transceiver 10 configuration data and data files, diagnostic data, and IC configuration data, remote programming command and instruction data, etc. The data stored in memory 624 includes at least pluggable transceiver 10 data defined in an MSA, for example identification, diagnostic, control and status memory mapped configuration data fields and values, wherein said data can be used to program the pluggable transceiver 10. The data stored in memory 624 can include proprietary pluggable transceiver 10 configuration data defined in a proprietary specification and used to program the pluggable transceiver 10. The configuration data stored in memory 624 can include data used to configure the pluggable transceiver 10 ICs. In an embodiment, the data stored in memory 624 can include a controller 622 program used to operate the integrated RFID reader 40b. The memory 624 is typically programmed during the integrated RFID reader 40b manufacturing process or it can be programmed afterwards using data received over the network interface 614. In the present embodiment, the controller 622 can be configured to receive said programming, configuration and command data from at least one external RFID reader 40 to control the RFID programming process through a network. In another embodiment, the controller 622 is configured to receive said programming, configuration and command data from an automated controller to control the RFID programming process through a network. The integrated RFID reader 40b can further be configured with an audio codec 650, wherein the codec 650 can be connected to a loudspeaker device or a buzzer device, wherein the controller can be configured to generate audible alarms and notifications and tones as known in the art. In an embodiment, the controller 622 can be configured with a time of day clock, preferably with battery backup, to maintain the time of day and date, and wherein the controller can update the time of day clock using data received from a network interface 614, for example the controller can be configured to receive the Network Time Protocol (NTP) which provides accurate and synchronized time from the Internet. In an embodiment, the controller 622 can be configured to receive pluggable transceiver configuration data from a barcode scanner connected to a network interface 614. In an embodiment, the controller 622 can be configured to receive global location data, for example GPS data, from a network interface 614.

In the present embodiment illustrated in FIG. 17, the integrated RFID reader 40b can be configured with an internal RFID reader 636, for example an RFID reader IC, and a RFID antenna 150. The RFID reader 636 and RFID antenna 150 can be configured to be in RFID communication with a RFID device to be programmed, such as the pluggable transceiver 10 or smart label 28. The controller 622 can be configured to read and write configuration data to and from the pluggable transceiver 10 or smart label 28 using the RFID reader 636 via RFID signals sent by the RFID antenna 150.

The controller 622 can be configured to be in communication with at least one external computing device 46 through the network interface 614 and a data communications network, wherein the controller 622 can be controlled remotely from at least one external RFID reader 40. For example, the integrated RFID reader 40b is configured to program pluggable transceivers 10 using RFID antenna 150 in a similar fashion as how the external RFID reader 40 and external RFID repeater 100 programs pluggable transceivers 10, described herein with reference to FIGS. 7A and 8F. More particularly, the integrated RFID reader transmits appropriate RFID signals containing configuration data for a programmable RFID device and the RFID antenna 150 is further operable to emit wireless RFID signals based on the RFID signals transmitted from the integrated RFID reader, whereby the wireless RFID signals are received by the programmable RFID device (ex: pluggable transceiver 10) in RFID signal mating with RFID antenna 150. In the present embodiment, the integrated RFID reader 40b can be configured to perform diagnostics, store diagnostic and RFID programming results in memory 624, and to report the success or failure of the diagnostics and the pluggable transceiver 10 programming to at least one external RFID reader 40b.

Returning back to FIG. 16, which is a representative example, an operator can use an user interface presented on external computing device 46 to operate the remote RFID programming system 400 and to remotely program a pluggable transceiver 10 placed on the top surface 416B (such as within 140 or 142 or 144 or 146, as appropriate).

In another embodiment, an automated controller can be configured to operate the integrated RFID reader 40 of the RFID programming system 400 and to remotely program pluggable transceiver 10 placed on the top surface 416B via the antenna 150.

In various example embodiments, the external computing device 46 and/or the integrated RFID reader 40b can be configured to generate at least one audible alarm or tone or ring tone, etc. to notify the operator when the external computing device 46 and the integrated RFID reader 40b are in RFID communication with one another and with the RFID device to be programmed (ex: pluggable transceiver 10). In another embodiment, the external computing device 46 and the integrated RFID reader 40b can be configured to generate different audible alarms or tones or ring tones, etc. to notify the operator of different operating states. This can include a first tone for achieving signal mating with the RFID device to be programmed and additional tones for reading, writing, programming, error and unmating, etc. In an embodiment, the external computing device 46 and the integrated RFID reader 40b can be configured to notify the operator of the RFID relative signal strength when mating with the to-be-programmed RFID device, for example by reading, estimating, comparing and displaying the approximate RFID RF signal strength received from the RFID device.

In an embodiment, the second top surface portion 416B can be configured with at least one fiducial marker for indicating in a visible location on the surface of said top surface 416B. The fiducial marker can be used as a target placed in the field of view of an imaging system to act as point of reference. This point of reference can be used by robotic systems to determine where to place components during PCBA manufacturing systems. The fiducial may also be applied or printed onto an exposed surface of the RFID antenna 150 substrate. For example, fiducial marks, or circuit pattern recognition marks, are used in PCB manufacturing to allow automated SMT placement equipment to accurately locate and place parts on PCBA, wherein these devices locate the circuit pattern by providing common measurable points.

In another example embodiment, the housing body 408 of the RFID programming system 404 can be configured as an assembly having two sections 410A and 410B interconnected with a hinge, similar to the form factor of the RFID repeater system 300 described herein with reference to FIGS. 14A to 14C. However, it will be understood that the RFID programming system 404 need not have the external repeater 100 or power repeater 400.

Continuing with FIG. 16, the external computing device 46 is illustrated as a computer terminal, such as a point of sales computer. For example, the external computing device 46 can be configured to process credit and debit card sales transactions and or customer orders and/or workorders and manage inventory. The external computing device 46 can be connected to an external network to receive, process, and transmit credit and debit data and other financial transaction data, order data, work order data or inventory data. For example, the point of sales device 46 can be used to perform financial transactions to purchases of pluggable transceiver 10 and RFID device configuration data or programming data or digital media data or data files, etc. or used to sell, support and maintain said pluggable transceivers 10 and RFID devices. The point of sales computer can further include an external printer, wherein the external computing device 46 and integrated RFID reader 40b and said printer can be connected to a network and configured to print programming data and reports as known in the art. For example, the printer can be used to print at least pluggable transceiver 10 and RFID device programming reports and data, RFID programming workorders and instructions, user and maintenance technical manuals, RFID data files and file download reports, orders, invoices, sales receipts, financial/banking transactions, summaries and reports, inventory data and reports, etc. used to sell, support and or maintain said pluggable transceivers 10 or like programmable RFID devices. The point of sale system 46 can further include a change drawer device used to process cash sales transactions as known in the art. For example, cash sales of at least pluggable transceivers 10 and like programmable RFID device, or RFID configuration data or programming data or digital media data and data files, etc. used to sell, support and or maintain said RFID devices.

In operation, a user operates the external computing device 46 to establish a connection with the RFID programming system 404 via the network interface 614. As described elsewhere herein, the connection can be a wireless connection or a wired connection. As illustrated, the RFID device that is to be programmed, such as a pluggable transceiver 10, is placed on surface portion 416B to establish a signal mating of the device with RFID antenna 150 of the external programming device 40. The user then interacts with a user interface presented on the external programming device 40a to select the configuration and programming data to be used for the to-be-programmed RFID device. This data is transmitted to the memory 624 of RFID programming system 404. Alternatively, this data may already be stored within memory 624 and the user can select the appropriate data. The controller 622 then operates the internal RFID reader 636 so that this configuration data and/or programming data is transmitted as RFID signals. The RFID antenna 150 then transmits wireless RFID signals based on the RFID signals from the integrated RFID reader so that they can be received by the to-be-programmed RFID device via the antenna 150.

It will be appreciated that while FIG. 16 illustrates an external computing device 46 in the form of a point-of-sales computing device, any other general computing device can be used to in conjunction with the RFID programming system 404, such as smartphone, tablet, laptop, desktop PC, game console, or the like.

In an alternative embodiment, the RFID programming device 404 described herein can be operated with an automated RFID programming system. The external programming device can be programmed to automatically program a plurality of to-be-programmed RFID device (ex: pluggable transceivers) without little to no user intervention. In operation, the automatic external programming device and the RFID programming device 404 are initially connected to be in data communication. As described elsewhere, the second top surface portion 416B can define at least one fiducial marker to indicate to an automated vision system (ex: a robotic system) where to place a to-be-programmed pluggable transceiver. An automated pick and place robotics system can place the to-be-programmed pluggable devices (ex: pluggable transceivers 10) at the appropriate location on the second top surface portion 416B so that the device is in signal mating with antenna 150. Upon this mating being established, the automated RFID programming system can operate the controller 622 and internal RFID reader 636 of the RFID programming device 400 to transmit the configuration data and/or programming data to the to-be-programmed device. This can be repeated for successive to-be-programmed pluggable devices in an automated manner. Different devices can be automatically programmed in this manner, such as pluggable transceivers, smart labels, RFID cards and/or RFID tags.

While specific embodiments have been described and illustrated, it is understood that many changes, modifications, variations and combinations thereof could be made without departing from the scope of the invention.

1. A radio frequency (RFID) signal repeater system comprising:
a RFID repeater circuit having:
a first RFID antenna;
a second RFID antenna;
an electrical path providing an electrical connection between the first RFID antenna and the second RFID antenna, a RFID signal captured at one of the first and second RFID antennas being repeated at the other of the first and second RFID antennas;
a housing body having:
a first housing portion configured to house the first RFID antenna and to support a RFID reader device, whereby the RFID reader device is in RFID communication with the first RFID antenna when supported by the first housing portion;
a second housing portion mechanically connected to the first housing portion and configured to support the second RFID antenna and to support a programmable RFID device, whereby the programmable RFID device is in RFID communication with the second RFID antenna when supported by the second housing portion.

2. (canceled)

3. The RFID signal repeater system of claim 1, wherein the programmable RFID device and the RFID reader device are in RFID communication with one another when the programmable RFID device is supported by the second housing portion and the RFID reader device is supported by the first housing portion.

4. (canceled)

5. (canceled)

6. (canceled)

7. (canceled)

8. (canceled)

9. The RFID repeater system of claim 1, wherein the first housing portion and the second housing portion are substantially flexible; and wherein the first RFID antenna, the second RFID antenna and the electrical path are substantially flexible.

10. The RFID signal repeater system of claim 1, wherein the electrical path providing the electrical connection between the first and second antennas is one of a flexible wire and a flexible printed circuit board.

11. (canceled)

12. The RFID signal repeater system of claim 1, wherein at least the first housing portion is at least partially formed of a dielectric material to permit RFID data communication signals to be transmitted and received by the RFID reader device.

13. (canceled)

14. The RFID signal repeater system of claim 1, wherein the housing body is in the form of a foldable case; and
wherein at least a central portion of the housing body is substantially flexible to permit folding of the first housing portion relative to the second housing portion.

15. (canceled)

16. (canceled)

17. (canceled)

18. The RFID signal repeater system of claim 1, wherein a top surface of the housing portion has formed thereon at least one target area, whereby placement of the programmable RFID device in alignment with the at least one target area causes RFID signal mating of the programmable RFID device with the second RFID antenna.

19. The RFID signal repeater system of claim 1, wherein the first antenna is formed on a first substrate housed in the first housing portion; wherein the second antenna is formed on a second substrate housed in the second housing portion, the second substrate being discrete from the first substrate; wherein a first EM shielding substrate is positioned below the first antenna and a second EM shielding substrate is positioned below the second antenna, the first and second EM shielding substrates being operable to protect the first and second antennas from signal interference from an external source.

20. (canceled)

21. (canceled)

22. (canceled)

23. (canceled)

24. (canceled)

25. (canceled)

26. The RFID signal repeater system of claim 1, wherein the second housing portion comprises a recess being aligned with the first RFID antenna, the recess being sized to receive the programmable RFID device.

27. (canceled)

28. (canceled)

29. (canceled)

30. (canceled)

31. The RFID signal repeater system of claim 1, wherein the housing body has a slate form factor, the first housing portion corresponding to a first side portion of the form factor and the second housing portion corresponding to a second side portion of the form factor, further wherein the first antenna and the second antenna are formed on a single substrate.

32. (canceled)

33. The RFID signal repeater system of claim 31,
wherein a first target area is defined on a top surface of the first housing portion, whereby placement of the RFID reader device in alignment with the first target area causes RFID signal mating of the RFID reader device with the first RFID antenna; and
wherein at least one second target area is defined on a top surface of the second housing portion, whereby placement of the programmable RFID device in alignment with the second target area causes RFID signal mating of the programmable RFID device with the second RFID antenna.

34. (canceled)

35. (canceled)

36. (canceled)

37. (canceled)

38. (canceled)

39. (canceled)

40. (canceled)

41. The RFID signal repeater system of claim 1, wherein the first housing portion is a handheld case form factor operable to house the RFID reader device;
wherein the second housing portion has a scanner form factor; and
wherein the housing body further includes a flexible wand member mechanically joining the first and second housing portions.

42. The RFID signal repeater system of claim 41, wherein the second RFID antenna is housed within the second housing portion, the second antenna being in signal mating with the programmable RFID device when supported against the programmable RFID device.

43. (canceled)

44. The RFID signal repeater system of claim 1, wherein the first housing portion and the second housing portion are mechanically connected via a joint member providing movement of the first housing portion relative to the second housing portion.

45. The RFID signal repeater system of claim 44, wherein the joint member is a tilt and swivel joint permitting relative movement of the first housing portion and the second housing portion in two axes.

46. The RFID signal repeater system of claim 44,
wherein the first antenna is formed on a first substrate housed in the first housing portion;
wherein the second antenna is formed on a second substrate housed in the second housing portion, the second substrate being discrete from the first substrate; and
wherein the electrical path is flexible and extends through the joint member to connect the first antenna and the second antenna.

47. (canceled)

48. (canceled)

49. (canceled)

50. The RFID signal repeater system of claim 1, further comprising a power repeater circuit having:
a first power antenna operable to wirelessly receive power transmitted from an external power source;
a second power antenna operable to wireless transmit power to the RFID reader device; and
an additional electrical circuit providing an electrical connection between the first power antenna and the second power antenna to relay power received at the first power antenna to the second power antenna.

51. (canceled)

52. (canceled)

53. (canceled)

54. A radio frequency (RFID) programming system comprising:
a housing body;
an integrated RFID reader housed within the housing body and configured to transmit RFID signals containing configuration data; and
a RFID antenna housed within the housing body and operable to emit wireless RFID signals based on the RFID signals transmitted from the integrated RFID reader.

55. The RFID programming system of claim 54, wherein the wireless RFID signals containing the configuration data are receivable by a programmable RFID device when the programmable RFID device is supported on a surface of the housing body.

56. (canceled)

57. The RFID programming system of claim 54, further comprising a communications module operable for data communication with an external computing device, and a memory storing the configuration data; and
wherein the integrated RFID reader transmits RFID signals containing the configuration data in response to a command received from the external computing device via the communications module.

58. (canceled)

59. (canceled)
